(19) United States
(12) Patent Application Publication
(10) Pub. No.: US 2026/0097372 A1
(43) Pub. Date: Apr. 9, 2026

(54) DUAL-AXIS CENTRIFUGAL MIXING ASSEMBLY AND METHODS OF USE THEREOF

(71) Applicant: FLACKTEK SPEEDMIXER, INC., LANDRUM, SC (US)

(72) Inventors: Matthew Lee Gross, Boulder, CO (US); James Emanuel Earle, III, Longmont, CO (US); Michael Garrison Drew Schlabach, Broomfield, CO (US); Travis Rian Andrews, Wheatridge, CO (US); Maxiliaan Gulden, Boulder, CO (US); Daniel Joseph Bodenstein, Boulder, CO (US); Ryan Michael Welsh Snow, Boulder, CO (US); Mikaela Marie Leeyi Juzswik, Boulder, CO (US); Sean William Connelly, Boulder, CO (US); Zachary Speer, Boulder, CO (US); Remington Stanley Bullis, Boulder, CO (US)

(21) Appl. No.: 19/331,998

(22) Filed: Sep. 17, 2025

Related U.S. Application Data
(60) Provisional application No. 63/695,576, filed on Sep. 17, 2024.

(51) Int. Cl. B01F 29/15; B01F 29/10; B01F 35/21; B01F 35/222

(52) U.S. Cl. CPC B01F 29/15; B01F 29/10; B01F 35/21; B01F 35/222

(57) ABSTRACT

A centrifugal mixing assembly is configured to mix large quantities of flowable material positioned within a container that is rotated about a primary axis and a secondary axis of rotation. The mixing assembly may be further configured to rotate the container at a tilt angle with respect to a line positioned perpendicular to the primary axis. The invention further includes sub-combinations of the mixing assembly in which each have separate utility with respect to mixing material. A method of the invention includes providing the mixing assembly and conducting mixing according to predetermined mixing parameters selected by a user. A computer readable medium of the invention includes computer executable instructions to control the operation of the mixing assembly. The computer executable instructions can be incorporated within a controller including a PLC that is capable of executing a plurality of pre-programmed instructions to achieve dual axis centrifugal mixing of the material.

### CROSS REFERENCE TO RELATED APPLICATIONS

This application claims the benefit of and priority to U.S. Provisional Application No. 63/695,576, filed Sep. 17, 2024. The entire specification and figures of the above-referenced application are hereby incorporated, in their entirety by reference.

### FIELD OF THE INVENTION

The present invention is directed to a mixing system, and in particular a dual-axis centrifugal mixing assembly configured to mix large, industrial-scale quantities of materials and methods of use thereof.

### BACKGROUND OF THE INVENTION

Flowable materials are often a mixture of several components. It can be desirable to mechanically mix the different components thoroughly and completely at high speeds to provide homogeneity of the resultant mixture. The mixing process can be particularly important for materials which are challenging to handle such as fine or highly viscous materials. Asymmetric centrifugal rotation in a mechanical mixer can provide the appropriate environment and forces for the desired mixing results of a variety of materials. Specifically, dual-axis centrifugal mixing applies an initial centrifugal force on the material to be mixed by rotating a container about a first axis. This initial rotational movement causes the material to flow towards the outside of the container. As this first rotational motion is occurring, there is a simultaneous rotation of the container about an offset secondary axis which changes the trajectory of the material flow and applies an additional centrifugal force. This dual-axis mixing movement causes the material to move in a turbulent manner thereby increasing the particle/material interactions causing efficient mixing of the material.

However, conventional asymmetric rotation mixers can present challenges to scaled process operations. For example, conventional asymmetric rotation mixers are limited in the amount of material that can be mixed in a single cycle. For example, traditional mixing systems cannot generally mix more than 20 kg in a single cycle, thereby requiring multiple cycles to generate industrial-scale mixtures. As such, there exists a long-felt need for a dual-axis centrifugal mixing device that is capable of efficiently mixing large, industrial-scale quantities of materials.

### SUMMARY OF THE INVENTION

As set forth herein, in one embodiment of the invention, it includes a dual-axis centrifugal mixing assembly configured to mix large quantities of material within a container. Specifically, the centrifugal mixing assembly comprises a pedestal assembly configured to house a primary bearing assembly; at least one load cell assembly secured to the pedestal assembly for measuring loads applied to the pedestal assembly; a primary axis drive assembly operatively coupled to the pedestal assembly; a primary spindle rotated by said primary axis drive assembly about a primary axis; a primary axis motor for driving a primary drive shaft; a primary gear box mechanically coupled to the primary drive shaft; a secondary drive shaft mechanically coupled to the primary gear box; a primary bearing assembly including a primary spindle positioned within a bearing body of the pedestal assembly; a rotatable gantry assembly operably coupled with the primary spindle and the rotatable gantry assembly being aligned with the primary axis to enable the rotation of the primary spindle to synchronize rotation of the gantry assembly about the primary axis; a secondary axis drive assembly configured to rotate an operably linked basket about a secondary axis; a gondola assembly configured to hold a chamber assembly, the gondola assembly being operable for rotation such that it can be selectively tilted at an angle to align the chamber assembly with the secondary axis; the chamber assembly having a static mixing chamber that houses the basket and wherein the container is placed with the basket; and a control assembly coupled to the gantry assembly and wherein the control assembly is configured to facilitate the execution of the dual-axis centrifugal mixing by first signals sent by the controller to selected components of the centrifugal mixing assembly.

In connection with this first embodiment of the invention, a number of optional features or aspects of the invention may include further structural components of the centrifugal mixing assembly, further functional aspects of the operation of the centrifugal mixing assembly, or both. These optional features or aspects of the invention may include any one or more of the following: (a) the control assembly is further configured to facilitate execution of secondary outputs by second signals sent by the controller to the selected components of the centrifugal mixing assembly; (b) wherein the rotatable gantry assembly further includes a pair of secondary axis drive assemblies, each secondary axis drive assemblies having a secondary axis motor that drives a corresponding gantry drive shaft; (c) each gantry drive shaft is separated into two segments that are coupled with a shaft coupler configured to transmit power and rotational motion, and to permit parallel, axial, or angular misalignment between the shaft segments; (d) each secondary axis motor includes a programming module having a processor configured to execute machine executable instructions that are programed to control the operation of their corresponding secondary axis motor; (f) at least one rotational sensor positioned adjacent to the primary spindle for detection and transmission of signals to the controller reflective of a rotational speed of the primary spindle; (g) wherein each secondary axis motor drives a first belt drive, the first belt drive being operatively coupled to the gantry drive shaft enabling selective forward or reverse rotation; (h) the first belt drive further includes a first pulley, a central pulley and a first belt operably linking the first pulley and central pulley wherein rotation of the gantry drive shaft by a corresponding secondary axis motor causes the first belt drive to travel forward or backward causing the corresponding rotation of the first pulley and central pulley; (i) wherein the control assembly further includes: (1) a pneumatic controller having pneumatic components necessary to receive and transmit compressed air to drive one or more pneumatically operable components of the dual-axis centrifugal mixing assembly; and (2) a power controller having power components necessary to receive and transmit power to drive one or more electrically operable components of the dual-axis centrifugal mixing assembly; (j) an upper portion of the controller assembly is secured to a static surface of the dual-axis centrifugal mixing assembly so the controller assembly remains stationary to facilitate the connection and transmission of electrical and pneumatic inputs through corresponding cables or tubes that cannot be rotated, while a lower portion of the controller assembly is secured to the gantry assembly and rotates around the primary axis during operation of the dual-axis centrifugal mixing assembly; (k) a rotatable slip ring assembly operably coupling the upper and lower portions of the controller assembly; (l) wherein the gondola assembly includes a sled adapted to secure the chamber assembly and to tilt the chamber assembly, so the container is positioned along the secondary axis of rotation or tilted outward at an outward angle to align the chamber assembly in an approximately vertical position to facilitate the loading and unloading of the container between mixing cycles; (m) wherein the gondola assembly further includes at least one of (1) a vibration sensor positioned on the sled and configured to detect vibration of the gondola assembly and to subsequently transmit at least one of a stop or speed reduction signal to the controller if vibration of the sled or other responsively coupled components exceeds a pre-determined vibration threshold; (2) an output shaft speed sensor positioned adjacent to a secondary spindle coupled to the rotatable basket and configured to measure the rotational speed of the secondary spindle during operation; and (3) an input shaft speed sensor positioned adjacent to a drive shaft of the gondola assembly to measure the rotational speed of the shaft during operation; (m) wherein the container includes a liner secured within the container to provide a barrier between the material and an interior surface of the container, the liner having a plurality of channel positions on an end portion of the liner; (n) wherein the container has a plurality of extensions positioned on a base plate of the container so that when the liner is inserted into the container, the channel positions on the liner mate with corresponding extensions thereby providing a secure attachment between the liner and the container.

According to another embodiment of the invention, it may be considered A dual-axis centrifugal mixing assembly configured to mix large quantities of material within a container, said centrifugal mixing assembly comprising: a pedestal configured to house a primary bearing assembly; a primary axis drive operatively coupled to the pedestal; a primary spindle rotated by said primary axis drive about a primary axis; a primary axis motor for driving a primary drive shaft; a primary gear box mechanically coupled to the primary drive shaft; a secondary drive shaft mechanically coupled to the primary gear box; a rotatable gantry operably coupled with a primary spindle and the rotatable gantry being aligned with the primary axis to enable the rotation of the primary spindle to synchronize rotation of the gantry about the primary axis; a secondary axis drive configured to rotate an operably linked basket about a secondary axis; a gondola configured to hold a chamber, the gondola being operable for rotation such that it can be selectively tilted at an angle to align the chamber with the secondary axis, wherein the chamber has a static mixing chamber that houses the basket and wherein the container is placed with the basket; and a controller coupled to the gantry wherein the controller is configured to facilitate the execution of the dual-axis centrifugal mixing by first signals sent by the controller to selected components of the centrifugal mixing assembly.

According to the immediately aforementioned embodiment of the invention, it may optionally include at least one load cell assembly secured to the pedestal for measuring loads applied to the pedestal.

According to yet another aspect of the invention in another embodiment, it may be considered a dual-axis centrifugal mixing assembly provided in sub-combination, the sub-combination comprising: a pedestal configured to house a primary bearing assembly; at least one load cell assembly secured to the pedestal assembly for measuring loads applied to the pedestal assembly; a primary axis drive operatively coupled to the pedestal; a primary spindle rotated by said primary axis drive about a primary axis; a rotatable gantry operably coupled with the primary spindle wherein the rotatable gantry is aligned with the primary axis to enable the rotation of the primary spindle to synchronize rotation of the gantry about the primary axis; a secondary axis drive configured to rotate an operably linked basket housed within a chamber about a secondary axis; a gondola configured to hold the chamber, the gondola being operable for rotation such that it can be selectively tilted at an angle to align the chamber with the secondary axis; and a controller element coupled to the gantry wherein the controller element is configured to facilitate the execution of the dual-axis centrifugal mixing by first signals sent by the controller element to selected components of the dual-axis centrifugal mixing assembly.

According to the immediately aforementioned sub-combination, the controller element may optionally further include a pneumatic controller having pneumatic components necessary to receive and transmit compressed air to drive one or more pneumatically operable components of the dual-axis centrifugal mixing assembly; and a power controller having power components necessary to receive and transmit power to drive one or more electrically operable components of the dual-axis centrifugal mixing assembly.

According to yet another embodiment of the invention, it may be considered a method for conducting dual-axis centrifugal mixing by a mixing device especially adapted for mixing large quantities of material within a container, the method comprising: (1) providing a mixing device comprising: (a) a primary axis drive (b) a primary spindle rotated by said primary axis drive about a primary axis; (c) a rotatable gantry operably coupled with the primary spindle and the rotatable gantry being aligned with the primary axis to enable the rotation of the primary spindle to synchronize rotation of the gantry about the primary axis; (d) a secondary axis drive configured to rotate an operably linked container about a secondary axis; (e) a gondola configured to hold the container, the gondola being operable for rotation such that it can be selectively tilted at an angle to align the container with the secondary axis; (f) a controller coupled to the gantry and wherein the controller is configured to facilitate execution of the dual-axis centrifugal mixing by first signals sent by the controller to selected components of the centrifugal mixing assembly; (2) determining a first speed of rotation for mixing the container about the primary axis; (3) determining a second speed of rotation for mixing the container about the secondary axis of rotation; (4) determining respective time durations of rotation for about the primary and secondary axes; and (5) conducting the dual-axis centrifugal mixing by energizing the mixing device to operate to rotate the container at the determined first and second speeds of rotation and to rotate the basket for the respective time durations.

According to the immediately aforementioned method, it may optionally include any one of the following steps: (1) determining a tilt angle in relation to a horizontally positioned centerline and positioned perpendicular to the primary axis; and (2) conducting the dual-axis centrifugal mixing of the container at the determined tilt angle: or (1) providing at least one rotational sensor that is operatively coupled to the primary spindle to detect rotation of the primary spindle; (2) transmitting a first signal from the sensor to the controller reflective of the detected rotation; and (3) transmitting a second signal from the controller to the primary axis drive to modify the rotation of the primary spindle if the detected speed of rotation is not within an allowable range of speed of rotation; or (1) providing at least one temperature sensor operatively coupled to an upper spindle bearing and lower spindle bearing of the primary spindle to monitor respective temperatures of the upper and lower spindle bearings during operation of the mixing device; and (2) transmitting a temperature signal from the at least one temperature sensor to the controller if a sensed temperature of either bearing exceeds a pre-determined threshold temperature.

According to yet a further embodiment of the invention, it may be considered a non-transitory computer-readable medium containing computer executable instructions, wherein, when executed by a computer processor, the instructions cause the computer processor to execute a method to conduct dual-axis centrifugal mixing configured to mix material within a container, comprising: instructions to operate a dual-axis centrifugal mixing device including instructions to rotate the container about a primary axis and a secondary axis; and instructions to optimize mixing of the material within the container including instructions to rotate the container about the primary axis and a secondary axis for respective optimal rotational speeds and respective optimal rotational time durations.

According to the immediately aforementioned embodiment, it may optionally include providing instructions to generate user interfaces for viewing by a user on a user screen that enables the user to select predetermined parameters for the optimal rotational speeds and optimal rotational time durations.

According to yet another aspect of the invention, it may be considered a non-transitory computer-readable medium containing computer executable instructions, wherein, when executed by a computer processor, the instructions cause the computer processor to execute a method to conduct dual-axis centrifugal mixing configured to mix material within a container, comprising: instructions to operate a dual-axis centrifugal mixing device including instructions to rotate the container about a primary axis and a secondary axis; instructions to optimize mixing of the material within the container including instructions to rotate the container about the primary axis and a secondary axis for respective optimal rotational speeds and respective optimal rotational time durations; instructions to generate user interfaces provided to a user on a user screen that enables the user to select predetermined parameters for the optimal rotational speeds and optimal rotational time durations; wherein said user interfaces include at least one user interface displaying at least one recipe for selection by the user and for subsequent execution of the method, the at least one user interface showing parameters of the at least one recipe include a duration, a gantry rotational speed, a gondola rotational speed, and at least one of an acceleration or deacceleration, and a pedestal to gondola ratio.

According to the immediate foregoing aspect of the invention, this may further include several optional features wherein the user interfaces may further include any one or all of: (i) displaying a vacuum status associated with a gondola; (ii) functions displayed that show at least one of a load gondola function, an unload gondola function, a move to position A function, a move to position B function, and an enable servos function; (iii) a real-time display of information reflecting the current status of the system in operation, the real-time display of information including at least one of: a display of a selected recipe, a display of monitored conditions of the system including at least one of pressure, temperature, elapsed time, and rotational speeds.

According to yet another aspect of the invention, it may be considered a dual-axis centrifugal mixing assembly configured to mix quantities of material within a container, said centrifugal mixing assembly comprising: a pedestal assembly configured to house a primary bearing assembly; at least one load cell assembly secured to the pedestal assembly for measuring loads applied to the pedestal assembly; a primary axis drive assembly operatively coupled to the pedestal assembly; a primary spindle rotated by said primary axis drive assembly about a primary axis; a primary axis motor for driving a primary drive shaft; a primary gear box mechanically coupled to the primary drive shaft; a secondary drive shaft mechanically coupled to the primary gear box; a primary bearing assembly including a primary spindle positioned within a bearing body of the pedestal assembly; a rotatable gantry assembly operably coupled with the primary spindle and the rotatable gantry assembly being aligned with the primary axis to enable the rotation of the primary spindle to synchronize rotation of the gantry assembly about the primary axis; a secondary axis drive assembly configured to rotate an operably linked basket about a secondary axis; a gondola assembly configured to hold a chamber assembly, the gondola assembly being operable for rotation such that it can be selectively tilted at an angle to align the chamber assembly with the secondary axis, wherein the secondary axis is variable in relation to the primary axis; the chamber assembly having a static mixing chamber that houses the basket and wherein the container is placed with the basket; and a control assembly operatively coupled to the centrifugal mixing assembly wherein the control assembly is configured to facilitate the execution of a mixing recipe resulting in mixing along the primary axis and the secondary axis, the control assembly comprising a programmable logic controller (PLC) for controlling the dual-axis centrifugal mixing, wherein the PLC has programmed instructions to facilitate execution of a mixing recipe wherein the programmed instructions reside on a non-transitory computer-readable medium, said mixing recipe including: instructions to optimize mixing of the material within the container including instructions to rotate the container about the primary axis and a secondary axis for respective optimal rotational speeds and respective optimal rotational time durations; instructions to generate user interfaces provided to a user on a user screen that enables the user to select predetermined parameters for the optimal rotational speeds and optimal rotational time durations; wherein said user interfaces include at least one user interface displaying at least one recipe for selection by the user and for subsequent execution of the method, the at least one user interface showing parameters of the at least one recipe include a duration, a gantry rotational speed, a gondola rotational speed, and at least one of an acceleration or deacceleration, and a pedestal to gondola ratio.

According to the immediate foregoing aspect of the invention, this may further include several optional features wherein the user interfaces further include: a real-time display of information reflecting the current status of the system in operation, the real-time display of information including at least one of: a display of a selected recipe, a display of monitored conditions of the system including at least one of pressure, temperature, elapsed time, and rotational speeds.

According to yet another aspect of the invention, it may be considered a method for conducting dual-axis centrifugal mixing by a mixing device especially adapted for mixing large quantities of material within a container, said method comprising: providing a mixing device comprising: (a) a primary axis drive (b) a primary spindle rotated by said primary axis drive about a primary axis; (c) a rotatable gantry operably coupled with the primary spindle and the rotatable gantry being aligned with the primary axis to enable the rotation of the primary spindle to synchronize rotation of the gantry about the primary axis; (d) a secondary axis drive configured to rotate an operably linked container about a secondary axis; (e) a gondola configured to hold the container, the gondola being operable for rotation such that it can be selectively tilted at an angle to align the container with the secondary axis; (f) a controller coupled to the gantry and wherein the controller is configured to facilitate execution of the dual-axis centrifugal mixing by signals sent by the controller to selected components of the centrifugal mixing assembly; determining a first speed of rotation for mixing the container about the primary axis; determining a second speed of rotation for mixing the container about the secondary axis of rotation; determining respective time durations of rotation for about the primary and secondary axes; and conducting the dual-axis centrifugal mixing by energizing the mixing device to operate to rotate the container at the determined first and second speeds of rotation and to rotate the basket for the respective time durations.

According to the immediate foregoing aspect of the invention, this may further include wherein the controller includes a non-transitory computer-readable medium that provides instructions to components of the mixing device to optimize mixing of the material within the container including instructions to rotate the container about the primary axis and a secondary axis for respective optimal rotational speeds and respective optimal rotational time durations; instructions to generate user interfaces provided to a user on a user screen that enables the user to select predetermined parameters for the optimal rotational speeds and optimal rotational time durations; and wherein said user interfaces include at least one user interface displaying at least one recipe for selection by the user and for subsequent execution of the method, the at least one user interface showing parameters of the at least one recipe include a duration, a gantry rotational speed, a gondola rotational speed, and at least one of an acceleration or deacceleration, and a pedestal to gondola ratio.

While the invention has been described in this summary, it shall be understood that the invention is not strictly limited to this summary, and the scope of the invention should be considered as also covering the entirety of the detailed description and claims that follow.

### BRIEF DESCRIPTION OF THE DRAWINGS

FIG. 1: shows a front perspective view of a dual-axis centrifugal mixing assembly positioned within a safety enclosure and adjacent to a responsive controller in one embodiment thereof;

FIG. 2: shows a front perspective view of a dual-axis centrifugal mixing assembly securing a gondola assembly on each end of a rotating gantry assembly, with one gondola assembly positioned in a vertical loading/unloading first position and a second opposing gondola assembly in a second position for mixing aligned with the secondary axis (B) of rotation in one embodiment thereof;

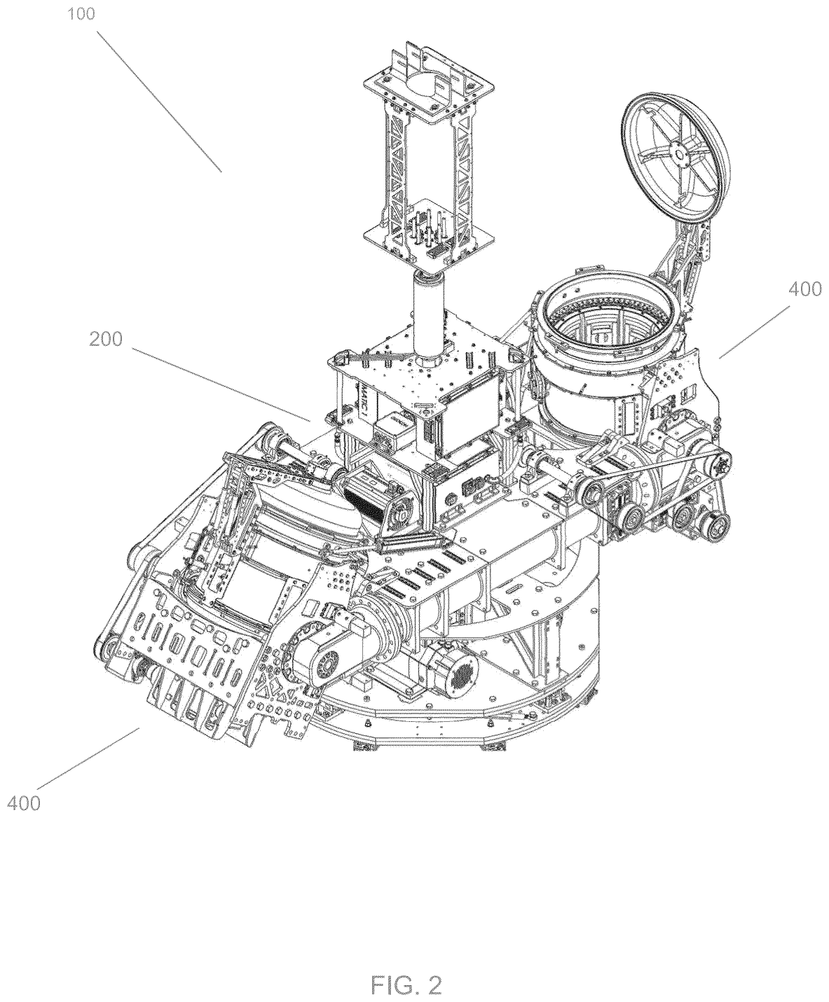

FIG. 3: shows a first side view of a dual-axis centrifugal mixing assembly in relation to a primary axis (A) of rotation and a secondary axis (B) of rotation, as well as a tilt angle (C) in relation to a horizontally positioned centerline (D) and positioned perpendicular to primary axis (A) in one embodiment thereof;

FIG. 4: shows a first side view of a dual-axis centrifugal mixing assembly having first and second belt drive assemblies responsive to a secondary axis motor in one embodiment thereof;

FIG. 5: shows an isolated view of the first and second supports of a pedestal assembly secured by load cell assemblies in one embodiment thereof;

FIG. 6: shows a side view of a pedestal assembly securing a primary bearing assembly in one embodiment thereof;

FIG. 7: shows a top view of a pedestal assembly supporting a primary spindle and a primary belt tensioner assembly in one embodiment thereof;

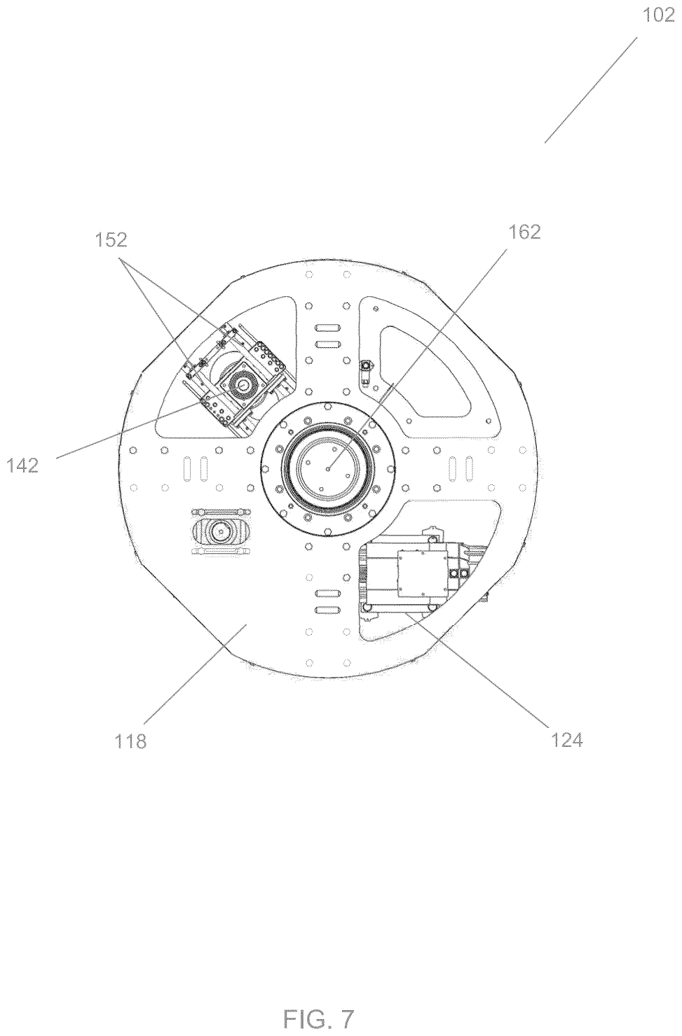

FIG. 8: shows a bottom view of a pedestal assembly securing a primary axis drive assembly configured to rotate the primary spindle via a belt drive having a first and a second drive pulley responsive to a primary axis motor in one embodiment thereof;

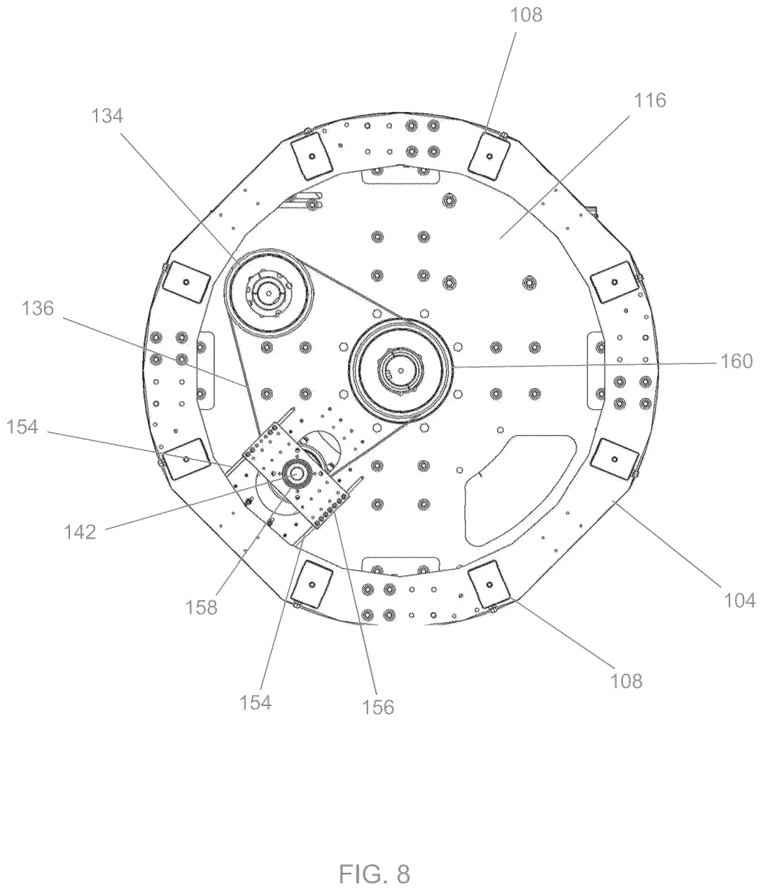

FIG. 9: shows a bottom perspective view of a pedestal assembly configured to rotate a primary spindle via a belt drive having a first and second drive pulley responsive to a primary axis motor, where the primary belt is further responsive to a primary belt tensioner assembly in one embodiment thereof;

FIG. 10: shows a top perspective view of a pedestal assembly supporting a primary spindle and having a primary axis motor mounted to a lower base plate in one embodiment thereof;

FIG. 11: shows an isolated primary belt tensioner assembly in one embodiment thereof;

FIG. 12: shows an isolated primary bearing assembly in one embodiment thereof;

FIG. 13: shows a first perspective view of a gantry assembly having a control assembly mounted to the gantry surface in one embodiment thereof;

FIG. 14: shows a second perspective view of a gantry assembly in one embodiment thereof;

FIG. 15: shows a side view of a gantry assembly with a pair of secondary axis motors mounted to the gantry surface, each configured to rotate a gantry drive shaft in one embodiment thereof;

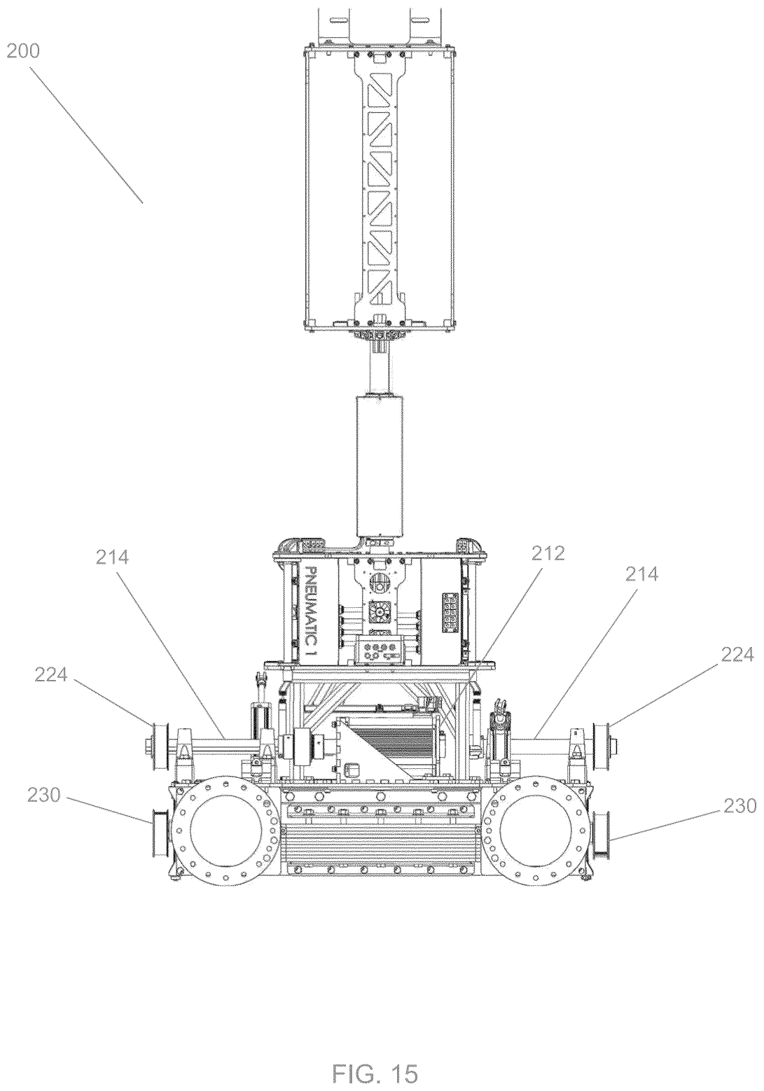

FIG. 16: shows a side view of a gantry assembly having a frame body supporting a pair of secondary axis motors mounted to the gantry surface, each configured to rotate a gantry drive shaft in one embodiment thereof;

FIG. 17: shows a bottom view of a gantry assembly having a spindle coupler positioned within a spindle block secured to the body of the gantry along the primary axis of rotation in one embodiment thereof;

FIG. 18: shows a top view of a gantry assembly securing a centrally positioned control assembly and securing one or more modular weighted masses in one embodiment thereof;

FIG. 19: shows a side view of a gantry assembly securing a pair of actuators configured to tilt a corresponding gondola assembly into a first or second positions in one embodiment thereof;

FIG. 20: shows an isolated first belt tensioner assembly that is incorporated into a first belt drive in one embodiment thereof;

FIG. 21: shows an isolated control assembly having a slip ring assembly configured to transit one or more inputs to, or from the mixing assembly such as electrical power, hydraulics, air (pressurized or vacuum), or purged material in one embodiment thereof;

FIG. 22: shows an isolated portion of a control assembly having a manifold securing a plurality of input assemblies in communication with an upper coupler shaft in one embodiment thereof;

FIG. 23: shows a slip ring assembly electrically response to a plurality of power cables directed to a conduit configured to be responsive to one or more electrical devices on the mixing assembly in one embodiment thereof;

FIG. 24: shows an isolated portion of the control assembly housing a pneumatic distribution system responsive to a slip ring assembly in one embodiment thereof;

FIG. 25: shows a pneumatic control housing secured to the control assembly and responsive to A pneumatic distribution system in one embodiment thereof;

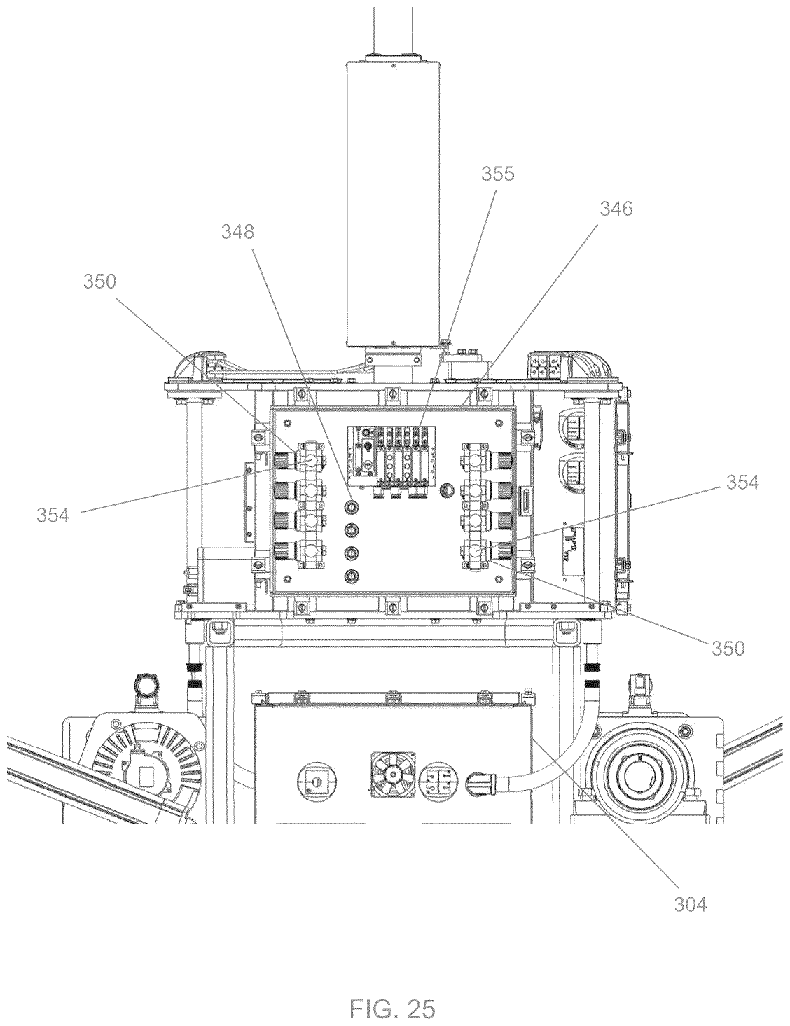

FIG. 26: shows a perspective view of an isolated sled assembly rotatably secured to a pair of opposing shaft housings and further securing a second belt drive assembly including a central pulley, a second belt, a second pulley, and a second belt tensioner assembly in one embodiment thereof;

FIG. 27: shows a perspective view of an isolated sled assembly having a centrally positioned sled aperture to accommodate a secondary spindle and pair of pivot bearings positioned on the side walls of the sled and configured to secure a pivot shaft in one embodiment thereof;

FIG. 28: shows a front perspective view of an isolated gondola assembly securing a container assembly and further configured to be rotated about the stationary shaft housings about angle (C) in relation to the secondary axis (B) of rotation and securable in a first and second position in one embodiment thereof;

FIG. 29: shows a detailed view of a second drive assembly having a central pulley in one embodiment thereof;

FIG. 30: shows a front perspective view of an isolated gondola assembly securing a container assembly with a container lid in the open position in one embodiment thereof;

FIG. 31: shows a detailed view of the internal compartment of a ring bearing assembly responsive to a rotatable basket positioned within a mixing chamber in one embodiment thereof;

FIG. 32: shows a detailed view of the internal compartment of a mixing chamber securing a ring bearing assembly having a plurality of roller bearings in one embodiment thereof;

FIG. 33: shows a detailed view of the internal compartment of a mixing chamber securing a ring bearing assembly having a plurality of roller bearings positioned adjacent, and responsive to a rotatable basket in one embodiment thereof;

FIG. 34: shows a front view of an isolated gondola assembly securing a container assembly rotatably secured to opposing shaft housings with a container lid in the open position in one embodiment thereof;

FIG. 35: shows a rear view of an isolated gondola assembly securing a container assembly rotatably secured to opposing shaft housings with a container lid in the open position in one embodiment thereof;

FIG. 36: shows an isolated sled assembly securing a gearbox responsive to a gondola drive shaft in one embodiment thereof;

FIG. 37: shows a bottom view of an isolated gondola assembly securing a gearbox responsive to a gondola drive shaft operably connected with a second drive assembly in one embodiment thereof;

FIG. 38: shows a front perspective view of an isolated chamber assembly with a container lid in the closed position in one embodiment thereof;

FIG. 39: shows a rear perspective view of an isolated chamber assembly with a container lid in the closed position in one embodiment thereof;

FIG. 40A-B: (A) shows a front view of an isolated chamber assembly with a container lid in the closed position in one embodiment thereof; (B) shows a partial cross-sectional front view of an isolated chamber assembly having a thermal imager secured within an imager housing positioned in the container lid, and a secondary spindle supported by upper and lower spindle bearings in one embodiment thereof;

FIG. 41: shows a top view of a gondola assembly securing a container assembly having a locking clutch positioned on the bottom portion of a rotatable basket configured to be mated with a catch assembly positioned on the bottom surface of a container in one embodiment thereof;

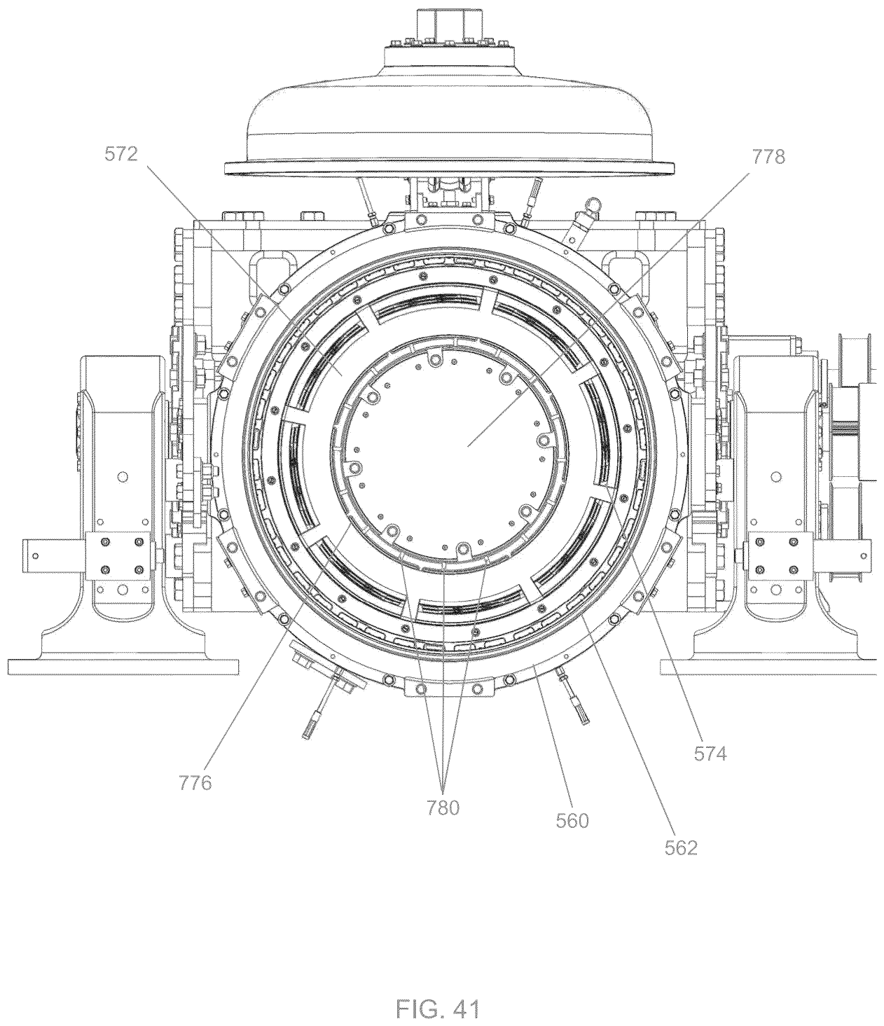

FIG. 42: shows an isolated container having a lid in one embodiment thereof;

FIG. 43: shows an isolated container having a catch assembly positioned on its bottom surface in one embodiment thereof;

FIG. 44: shows the internal compartment of a container having a plurality of extensions secured to a base plate in one embodiment thereof;

FIG. 45: shows an isolated view of a liner in one embodiment thereof;

FIG. 46 shows a user interface screen or display that allows an operator to modify and control the dual-axis centrifugal mixing assembly and methods of the invention. More specifically shows, this figure that a number of recipes may be executed, new recipes can be created, and the recipes can be modified as desired;

FIG. 47 shows another user interface screen or display that allows the operator to view and modify a selected recipe, as well as illustrating a step in a recipe that has been created;

FIG. 48 shows another user interface screen or display that shows the basic parameters Of a recipe that can be modified;

FIG. 49 shows another user interface screen or display with the basic parameters that can be modified along with further advanced settings that can be modified to provide yet further control of an executed recipe;

FIG. 50 shows another user interface screen or display, as also shown in FIG. 49, specifically pointing out the controllable links, namely, the pedestal to gondola link, the gondola speed link, and the gondola vacuum link;

FIG. 51 shows another user interface screen or display, as also shown in FIGS. 49-51, specifically pointing out a pause function that allows a user to pause a mixing cycle;

FIG. 52 shows another user interface screen or display enabling a user to view a selected recipe to be executed;

FIG. 53 shows another user interface screen or display for a selected recipe to be executed and specifically pointing out an upload button;

FIG. 54 shows another user interface screen or display in which a recipe is uploaded, no errors are noted in the system, and the user can select the start button to run the selected recipe;

FIG. 55 shows another user interface screen or display in which recipe settings can be selected which includes ranges of setting selectins, maximum values, and default values;

FIG. 56 shows another user interface screen or display illustrating a homing function in which the system is “zeroed” meaning the system settings are returned to preselected home positions that are used as references for all other positions;

FIG. 57 shows another user interface screen or display relating to system settings, and more particularly, to maintenance information on the system components;

FIG. 58 shows another user interface screen or display relating to different types of users that may be selected to run the system, along with their respective authorities to modify recipes and conduct other functions on the system;

FIG. 59 shows another user interface screen or display that enables a user to monitor various sensors installed on the system as well as to view the currently executed mixing step and thermal cameras. The executed mixing step is also shown in a real-time graphical format in which selected operational parameters can be viewed. As shown, these parameters may include rotational speed and pressure plotted against time;

FIG. 60 shows another user interface screen or display in which the user has selected to change the scale of the illustrated graph; and

FIG. 61 shows another user interface screen or display enabling a user to view all of the stored mixing recipes to include previously executed recipes; this user interface also shows that a user can additionally view and select recorded parameters from the selected recipe as recorded by system sensors.

### DETAILED DESCRIPTION OF THE INVENTION

The following detailed description is provided to aid those skilled in the art practicing the various embodiments of the present disclosure, including all the methods, uses, compositions, etc., described herein. Even so, the following detailed description should not be construed to unduly limit the present disclosure, as modifications and variations in the embodiments herein discussed may be made by those of ordinary skill in the art without departing from the spirit or scope of the present discoveries. The present disclosure is explained in greater detail below. This disclosure is not intended to be a detailed catalog of all the different ways in which embodiments of this disclosure can be implemented, or all the features that can be added to the instant embodiments. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art in light of the instant disclosure, which variations and additions do not depart from the scope of the instant disclosure. Hence, the following specification is intended to illustrate some particular embodiments of the disclosure, and not to exhaustively specify all permutations, combinations, and variations thereof.

The present disclosure describes a dual-axis centrifugal mixing assembly (100), sometimes also referred to hereinafter as the mixing device, or the mixing assembly, which is preferably configured to mix large quantities of material. In particular, the dual-axis centrifugal mixing assembly (100) of the disclosure is configured to simultaneously mix one or more quantities of material about a primary axis (A) of rotation and about an offset secondary axis (B) of rotation. As detailed below, rotation of the material about a primary axis (A) generates a first centrifugal force causing the material to flow towards the outside of a container (902), while rotation about the secondary axis (B), which can include simultaneous clockwise, or preferably counterclockwise rotation, generates a second centrifugal force causing changes to the trajectory of the material flow resulting in a mixing action characterized by turbulent particle/material interactions.

In alternative examples, the dual-axis centrifugal mixing assembly (100) of the invention is configured to independently or alternatively mix one or more quantities of material about a primary axis (A) or a secondary axis (B) of rotation. Notably, while the secondary axis (B) is generally shown as a fixed position, the secondary axis (B) of rotation can be variable and can include any pre-defined angle that is parallel with or preferably offset in relation to the primary axis (A) of rotation.

Material that can be mixed by the dual-axis centrifugal mixing assembly (100) can include, but is not limited to, materials such as fluids, semi-fluids, gels, particles, powders, and other flowable material. In one preferred example, the material to be mixed can include a combustible material, and more preferably solid-state propellant for solid rocket motors (SRMs).

The dual-axis centrifugal mixing assembly can be described with respect to various assemblies that perform separate functions. However, it shall be understood that the invention does not require each and every assembly described herein as there are various sub-combinations of mixing assembly components that have separate utility. Therefore, the invention has many aspects that do not require a complete set of the assemblies described herein. It shall also be understood that the invention may be described with respect to various functions achieved by the assemblies however, these functions can be achieved without requiring each and every component of the respective assemblies described in this detailed description.

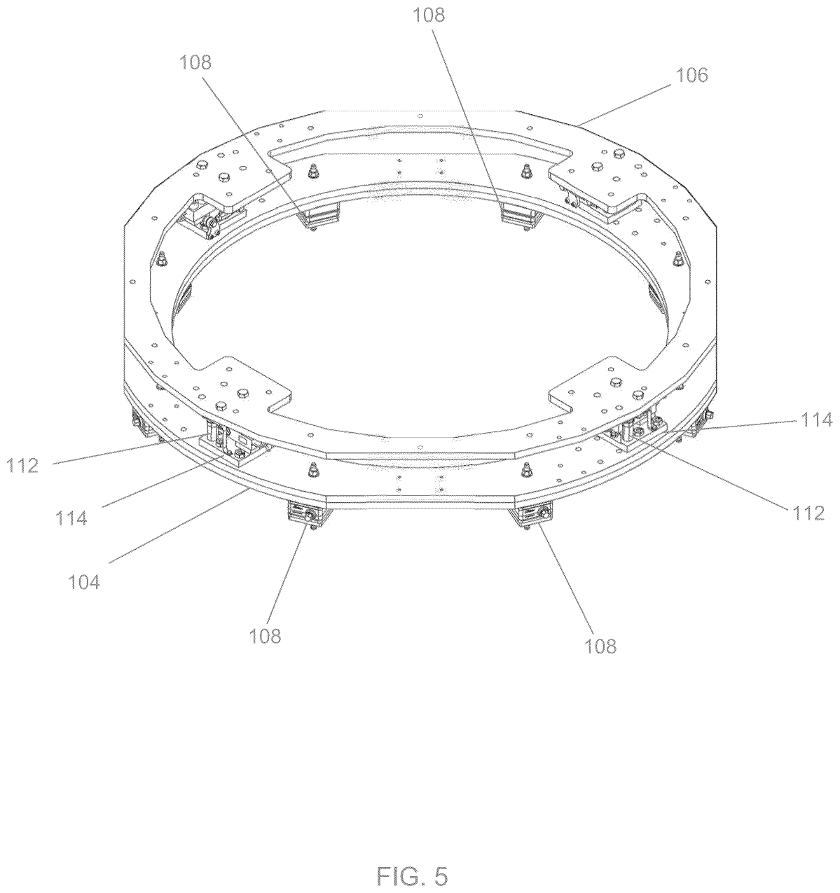

The dual-axis centrifugal mixing assembly (100) includes a pedestal assembly (102) configured to house a primary bearing assembly (174). In one preferred embodiment shown in FIG. 5, the pedestal assembly (102) includes a first support (104) coupled with a second support (106) via a plurality of stabilizing bars (110) configured to prevent unwanted torsional movement within the pedestal assembly (102) while still allowing force to be transmitted to one or more load cell assemblies (112) configured to detect the load applied to the pedestal assembly (102).

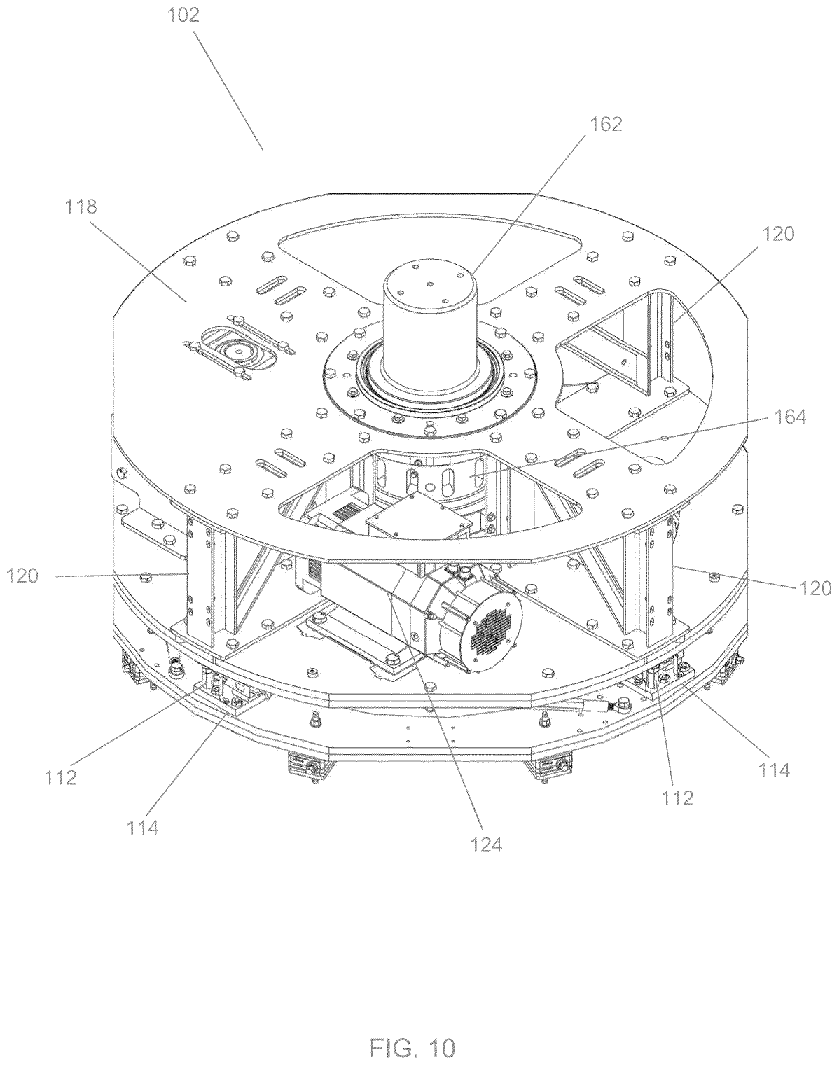

The pedestal assembly (102) further includes a lower base plate (116) secured to the top portion of the second support (106). An upper base plate (118) is positioned above the lower base plate (116) and secured via a plurality of static supports, which in a preferred embodiment include a plurality of support columns (120) coupled with cross support (122) beams. In the preferred embodiment shown in FIG. 10, at least four static supports, comprising two support columns (120) are placed at equidistant positions along the inner and outer portions of the pedestal body and secured by a cross support (122) beam.

The pedestal assembly (102) can include a plurality of load cell assemblies (112). In the preferred embodiment shown in FIGS. 5 and 10, a load cell assembly (112) is secured to a support mount (114) on the top surface of a first support (104), and further mechanically responsive to the bottom surface of a second support (106). In a preferred configuration, a load cell assembly (112) is positioned below each of the outer support columns (120) described above. In this configuration, the load applied to the pedestal assembly (102) can be measured via the load cell assembly (112) and transmitted via wired, or wireless signal to a system controller (801). The system controller (801) may include a programmable logic controller (PLC). Each load cell assembly (112) can be configured to generate a warning indication (not shown), such as an audible or visual signal when the load placed on the pedestal assembly (102) exceeds a pre-determined threshold, or if a load differential is detected among one or more of the load cell assemblies (112) indicating and unbalanced load.

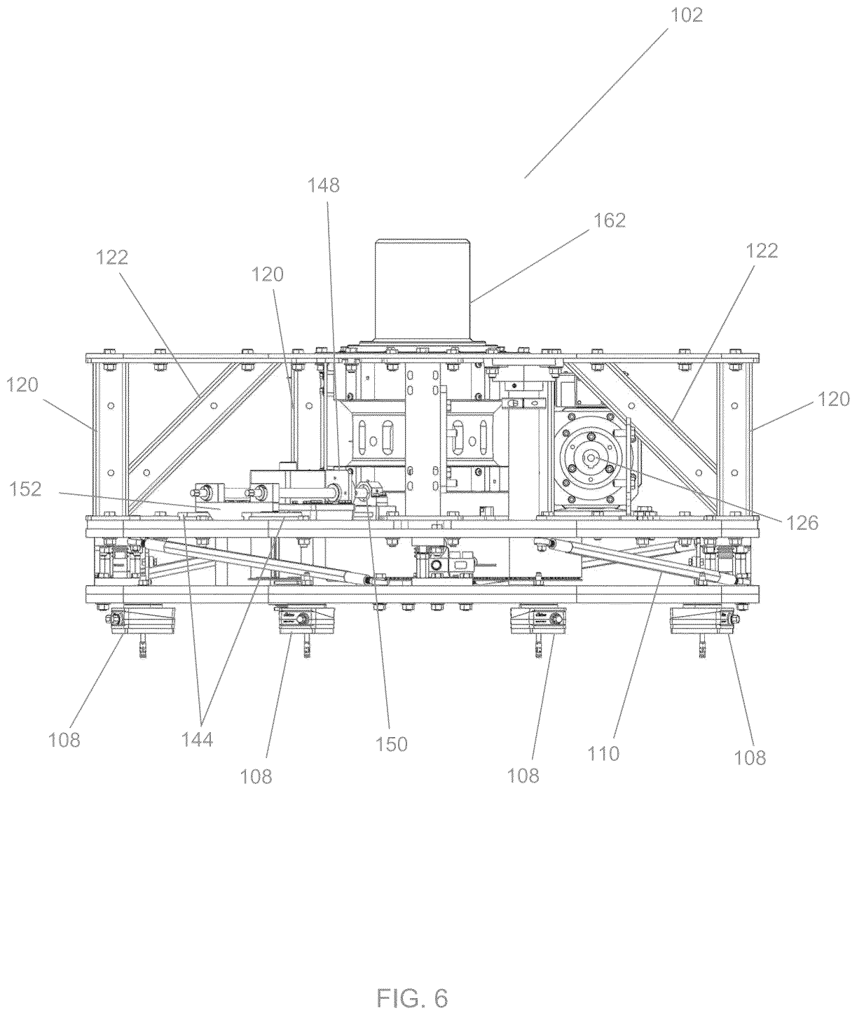

The pedestal assembly (102) can be secured to the ground or other static surface via one or more fasteners (not shown). In the preferred embodiment shown in FIG. 6, a plurality of vibrational mounts (114) can be secured to the first support (104) and a static surface, such as the ground or a secured platform (not shown) securing the pedestal assembly (102) in position while providing vibrational sensing/dampening while in operation.

The dual-axis centrifugal mixing assembly (100) includes a primary axis drive assembly (123) configured to rotate a primary spindle (162) about the primary axis (A) of rotation. The primary axis drive assembly (123) includes a primary axis motor (124) preferably secured to the pedestal assembly (102), and more preferably the top surface of the lower base plate (116). The primary axis motor (124) is responsive to a controller (801) and drives the rotation of primary drive shaft (126).

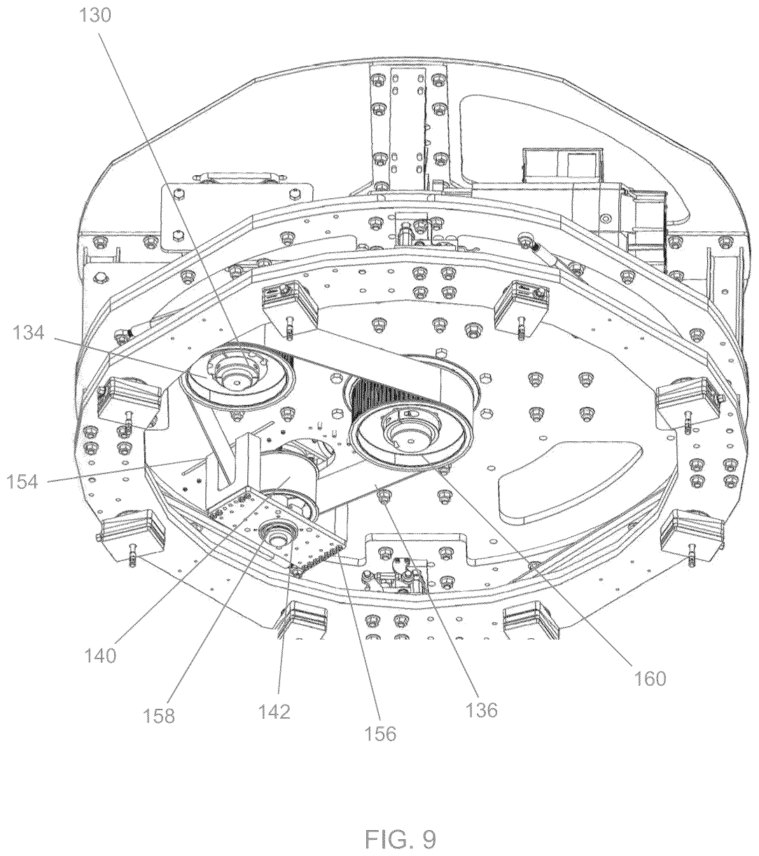

A primary gear box (128) is mechanically responsive to the primary drive shaft (126) and configured to transmit the rotational force of the primary drive shaft (126) to a secondary drive shaft (130). As shown in FIG. 9, the secondary drive shaft (130) is rotatably coupled with a drive mount (132) housing a bearing assembly (not shown) secured to the bottom surface of the upper base plate (118) so as to be positioned approximately parallel to the primary axis of rotation (A). The secondary drive shaft (130) extends through an aperture on the lower base plate (116) where it is coupled with a first drive pulley (134). A primary drive belt (136) is secured between a first drive pulley (134) and a second drive pulley (160) such that rotation of the first drive pulley (134) by the secondary drive shaft (130) is transmitted to the second drive pulley (160) causing it to rotate about the primary axis (A) of rotation.

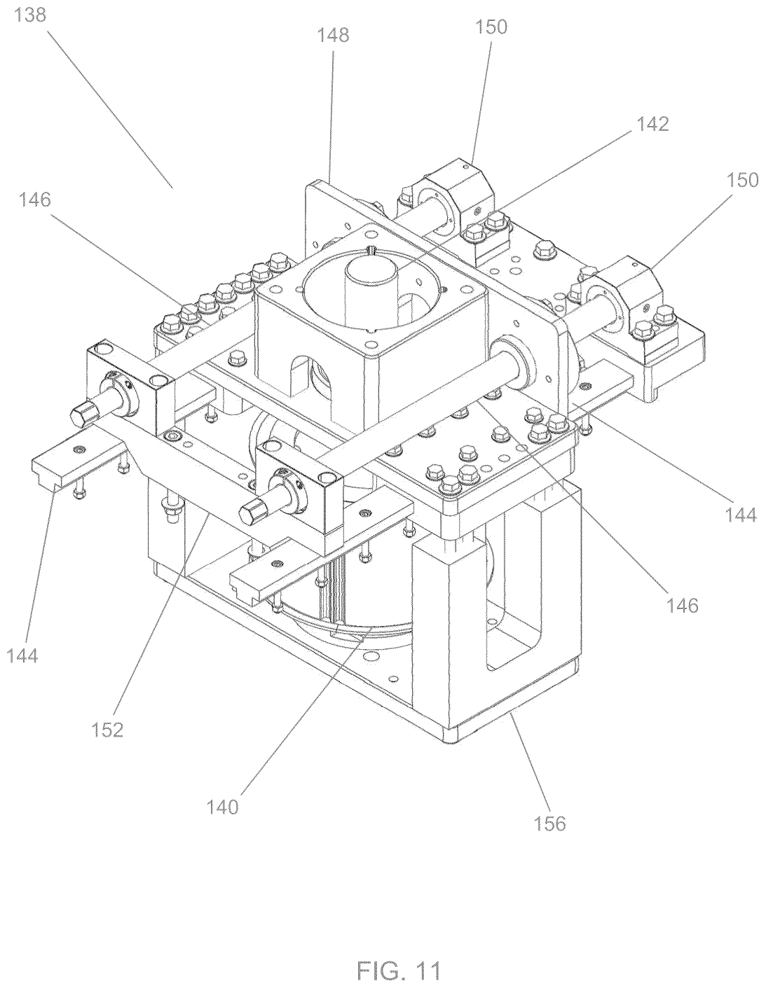

The primary drive belt (136) is responsive to a primary belt tensioner assembly (138). In the preferred embodiment shown in FIG. 11, a primary belt tensioner assembly (138) includes a tensioner drive shaft (142) securing a tensioner pulley (140) responsive to the primary drive belt (136). A first end of the tensioner drive shaft (142) is rotatably secured to an adjustable mount (148) housing a bearing mount (150), the other end being rotatably secured to a support mount (156), also housing a tensioner bearing support (158) so as to allow the tensioner drive shaft (142) to rotate in response to the movement of the primary drive belt (136).

The position of the tensioner pulley (140) can be adjusted to maintain tension on the primary drive belt (136). As shown in FIG. 11, the adjustable mount (148) is secured to the top surface of the lower base plate (116) which includes an aperture to accommodate the tensioner drive shaft (142). The adjustable mount (148) is further secured to a slide track (144). One or more tensioner rods (146) are secured by a locking mount (152) and the adjustable mount (148) such that the primary belt tensioner assembly (138) can slide laterally outward causing the tensioner pulley (140) to increase tension on the primary drive belt (136). Conversely, the adjustable mount (148) can be adjusted such that primary belt tensioner assembly (138) can slide laterally inward causing the tensioner pulley (140) to decrease tension on the primary drive belt (136). Once positioned, the adjustable mount (148) can be locked by securing one or more fasteners within a locking aperture (154) positioned parallel to the slide track (144).

In certain embodiments, movement of the primary belt tensioner assembly (138) can be accomplished manually, while in alternative embodiments the adjustment can be accomplished automatically. For example, in this embodiment a motor, such as a servo motor, or a pneumatic or hydraulic actuator (not shown), or other similar drive mechanism can be responsive to a sensor (not shown) that detects the tension on the primary drive belt (136). The sensor can transmit a signal to a controller (801) indicating too much, or too little tension on the primary drive belt (136) which can adjust of the position of the primary belt tensioner assembly (138) to achieve the desired level of tension on the belt.

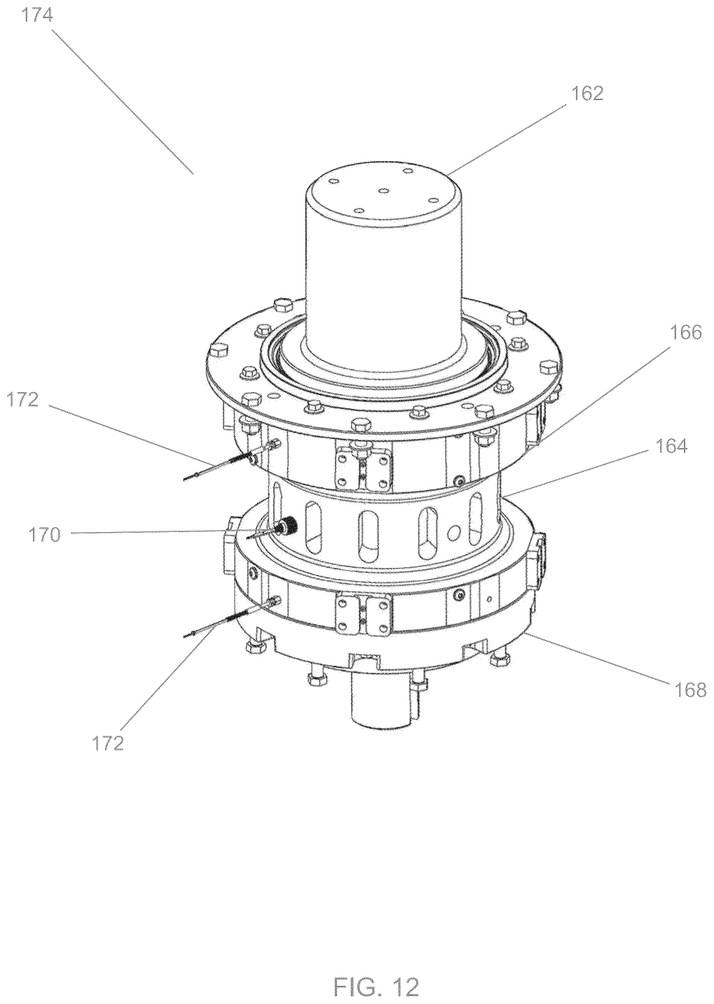

The dual-axis centrifugal mixing assembly (100) includes a primary bearing assembly (174). In a preferred embodiment, a primary bearing assembly (174) includes primary spindle (162) supported by a bearing body (164) which is further positioned within a central aperture of the pedestal assembly (102). As shown in FIG. 12, the bearing body (164) preferably includes an upper spindle bearing (166), and lower spindle bearing (168) configured to facilitate the rotation of the primary spindle (162) about the primary axis (A) within the bearing body (164). As noted above, the action of the primary drive belt (136) causes rotation of the second drive pulley (160) which is coupled to the primary spindle (162) causing it to also rotate about the primary axis (A) of rotation.

One or more rotational sensors (170) can be positioned adjacent to the primary spindle (162) and can detect and transmit a signal to a controller (801) to identify the rotational speed of the primary spindle (162) and integrity of the primary drive belt (136). In certain embodiments, the rotational sensor(s) (170) can be configured to generate a warning indication (not shown), such as an audible or visual signal when the rotational speed of the primary spindle (162) and/or integrity of the primary drive belt (136) deviates from a predetermined parameter. A controller (801) can transmit a signal to the primary axis motor (124) to stop or decrease rotation of the primary spindle (162) in response to the controller (801) signal.

One or more temperature sensors (172) can be positioned adjacent to the upper spindle bearing (166) and lower spindle bearing (168) to monitor bearing integrity and transmit a signal to a controller (801) if the temperature of one or both pf the bearing assemblies (166, 168) exceed a pre-determined threshold. In certain embodiments, the temperature sensor(s) (172) can be configured to generate a warning indication (not shown), such as an audible or visual signal when the temperature of the upper spindle bearing (166) and/or lower spindle bearing (168) exceeds a pre-determined threshold. The controller (801) can further transmit a signal to the primary axis motor (124) to stop or decrease rotation of the primary spindle (162) in response to the controller (801) signal.

The dual-axis centrifugal mixing assembly (100) includes a rotatable gantry assembly (200). In a preferred embodiment, the gantry assembly (200) is operably coupled to the primary spindle (162) via a spindle coupler (202) positioned within a support block (204) positioned on the bottom surface of the gantry assembly (200) and aligned along the primary axis (A) of rotation. In this manner, rotation of the primary spindle (162) causes the synchronized rotation of the gantry assembly (200) about the primary axis (A).

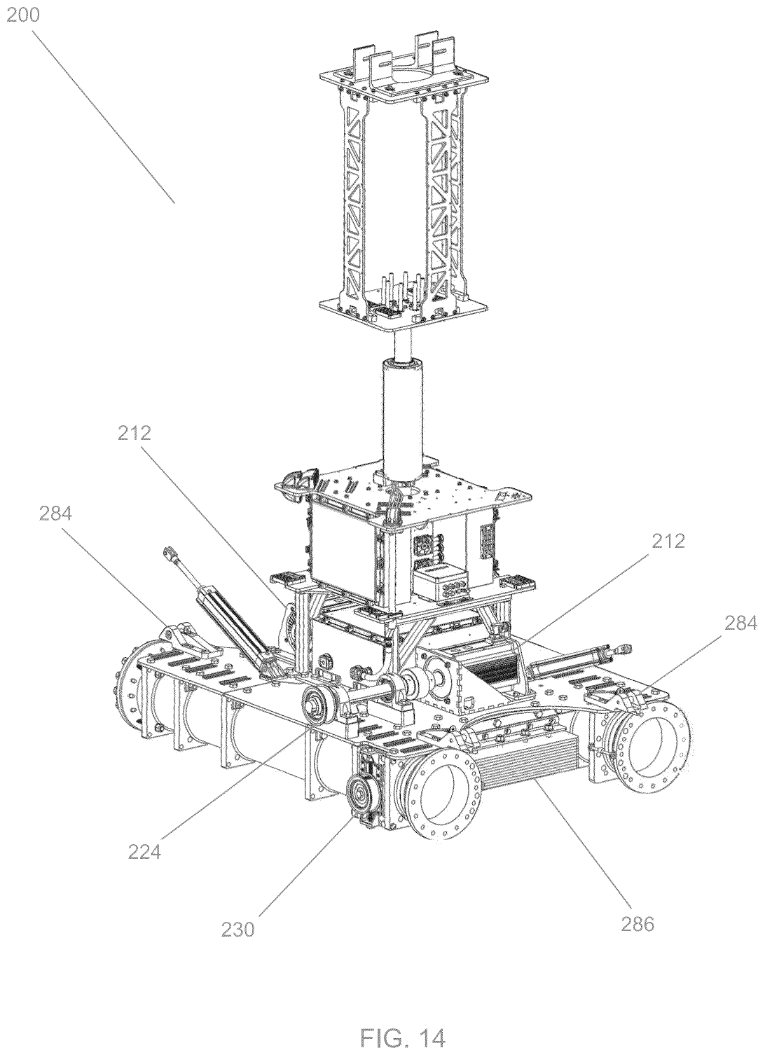

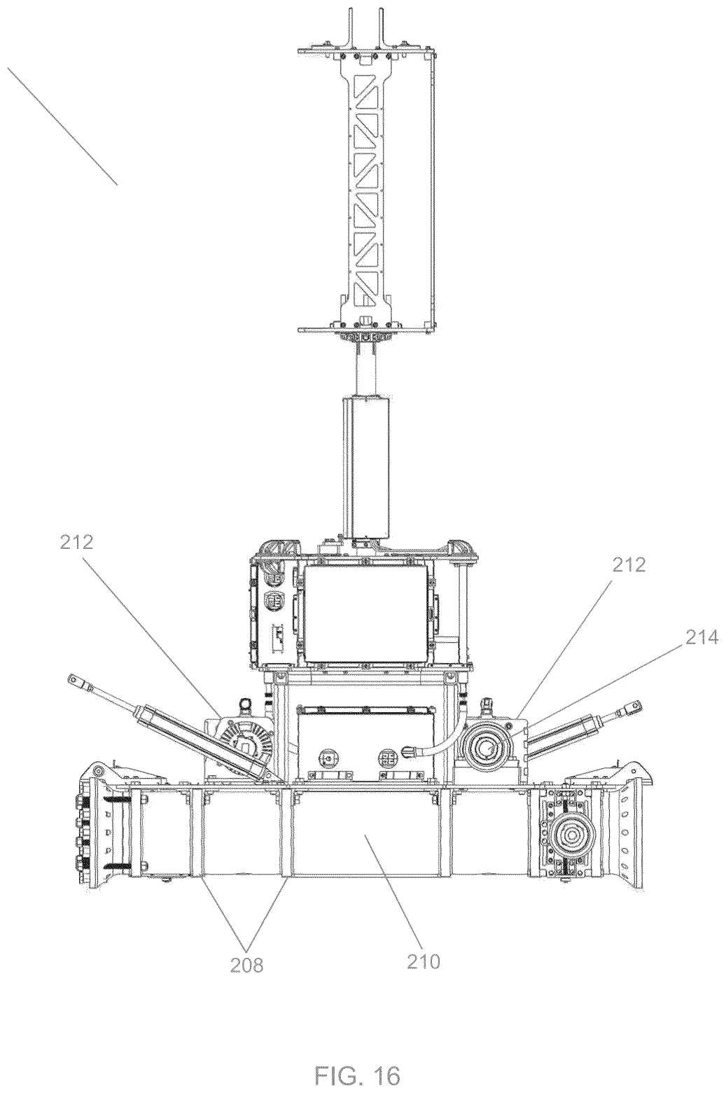

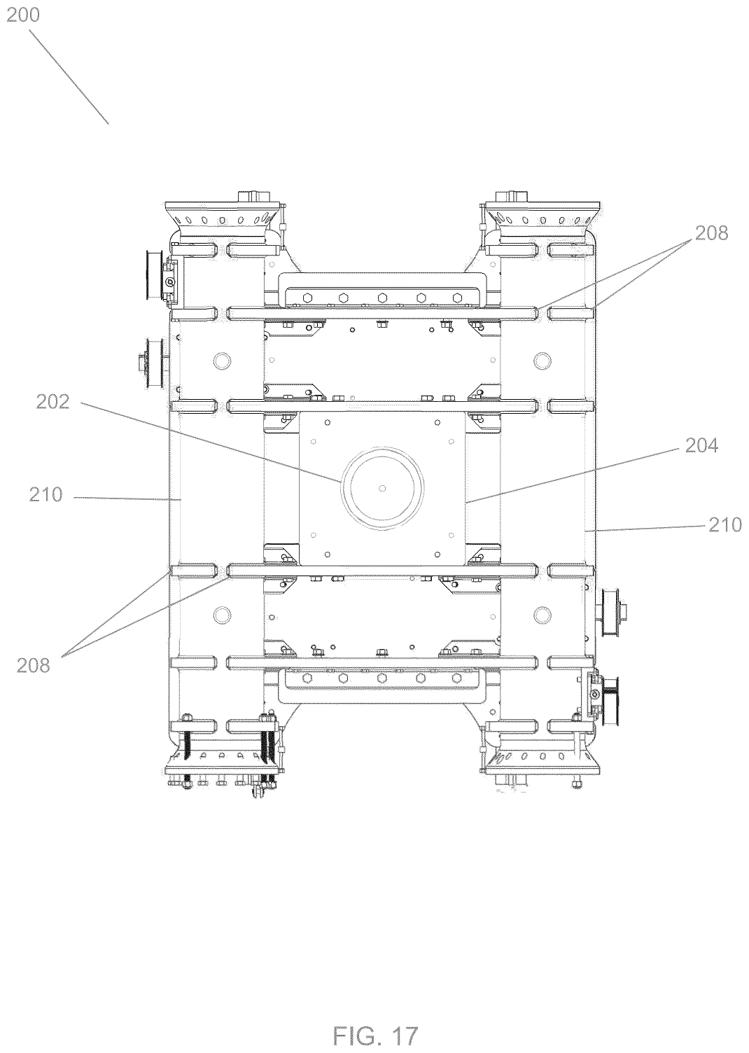

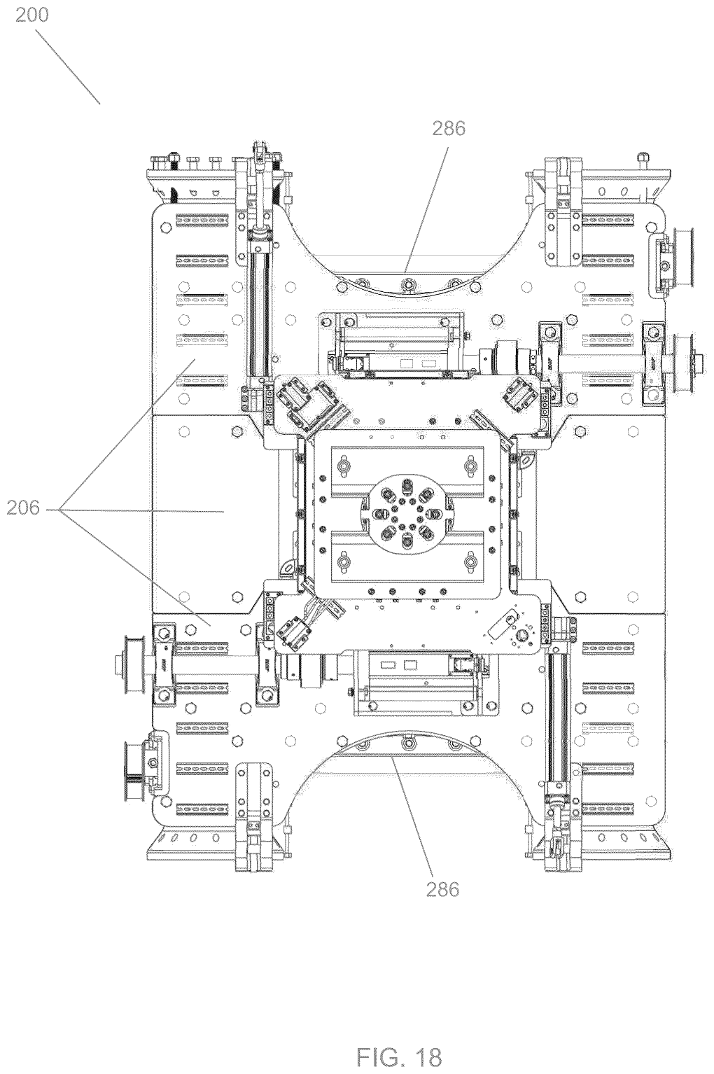

The body of the gantry assembly (200) includes a gantry surface (206) coupled with a frame body (210) and supported by a plurality of cross supports (208). As shown in FIG. 14 and 18, the gantry surface (206) includes a substantially flat surface formed from one or more plates configured to support a plurality of secondary axis motor(s) (212), as well as a control assembly (300) as described below. As further shown in FIGS. 16-17, the frame body (210) of the gantry assembly (200) in a preferred embodiment includes two extended cylinders forming the lateral edge of the frame body (210). A plurality of cross supports (208) are positioned on the bottom surface of the gantry assembly (200) and secure the frame body (210) and gantry surface (206) and form a rotatable reinforced unit.

The body of the gantry assembly (200) of the disclosure secures, in part, a secondary axis drive assembly (211) configured to rotate an operably linked basket (572) about a secondary axis (B) of rotation. Notably, as described below, in a preferred embodiment the dual-axis centrifugal mixing assembly (100) of the disclosure is preferably configured to mix two containers (902) positioned within separate chamber assemblies (500) positioned on opposing ends of the gantry assembly (200). A such, while in some instances the description may describe a single component or assembly, in certain instances the disclosure explicitly includes a second mirrored component that performs substantially the same operation.

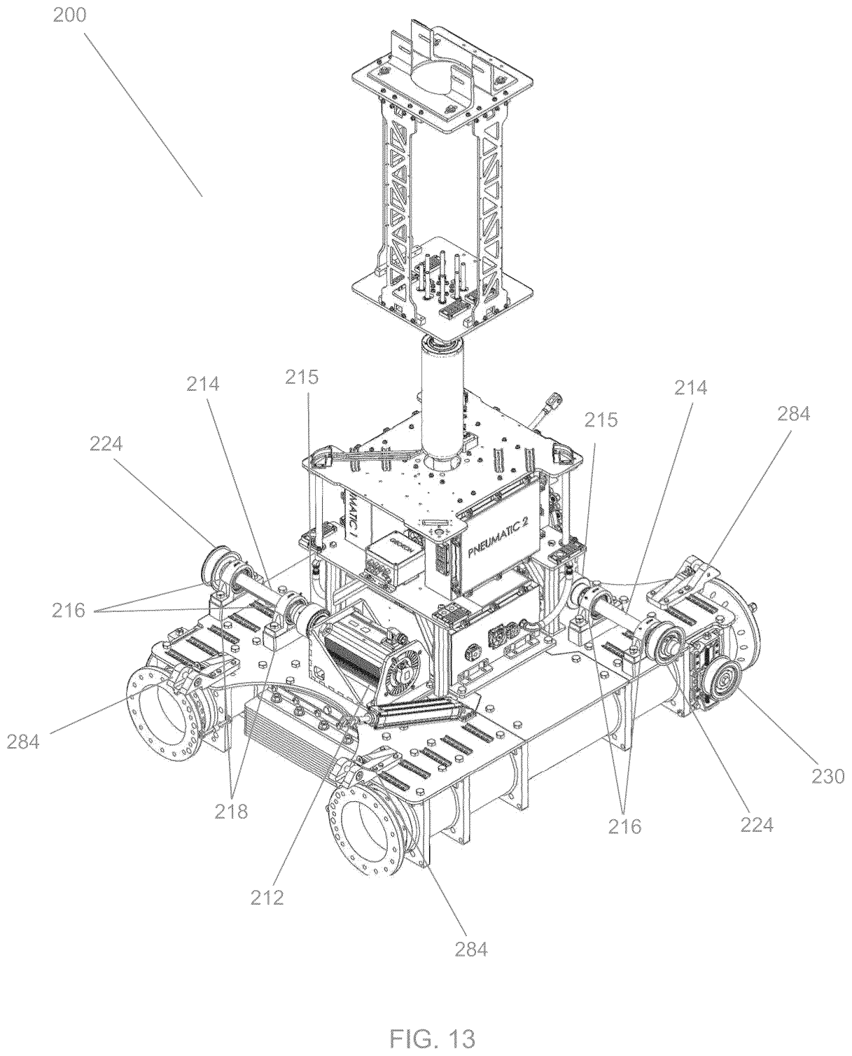

The gantry assembly (200) of the disclosure includes a pair of a secondary axis drive assemblies (211) positioned on opposing ends of the gantry surface (206). As shown in FIG. 13, each secondary axis drive assembly (211) includes secondary axis motor (212) mounted to the gantry surface (206) which drives a gantry drive shaft (214) extending perpendicularly towards the frame body (210). Each gantry drive shaft (214) can be separated into two portions that are coupled by a shaft coupler (215), which preferably includes a high-torque shaft coupler configured to transmit power and rotational motion and permit some degree of parallel, axial, or angular misalignment between the shaft segments during operation. The drive shaft (214) can further be supported by a bearing support (216) positioned within a bearing mount (218) positioned on the lateral edge of the frame body (210).

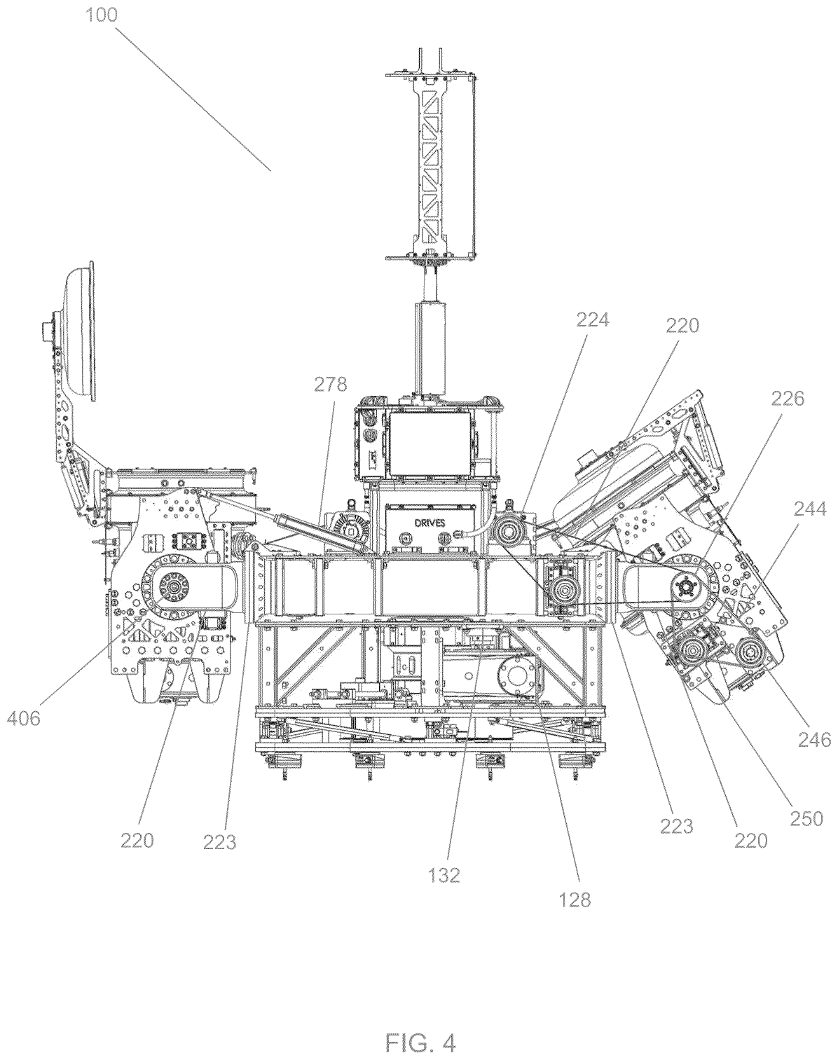

Operation of the secondary axis motor(s) (212) drives the operation of a first belt drive(s) (221). As shown in FIGS. 4 and 13, a first belt drive(s) (221) includes a first pulley (224) rotatably coupled with the terminal portion of the gantry drive shaft (214) allowing for either forward or reverse rotation. The first belt drive(s) (221) can further include a central pulley (226) positioned on a lateral side of a shaft housing (220) which is secured to the terminal ends of the frame body (210), shown in this preferred embodiment as a flange joint (223). A first belt drive(s) (221) further includes a first belt (222) operably linking the first pulley (224) and central pulley (226). In this configuration, rotation of a gantry drive shaft (214) by a secondary axis motor(s) (212) causes the first belt drive(s) (221) to travel forward or backward causing the corresponding rotation of the first pulley (224) and central pulley (226).

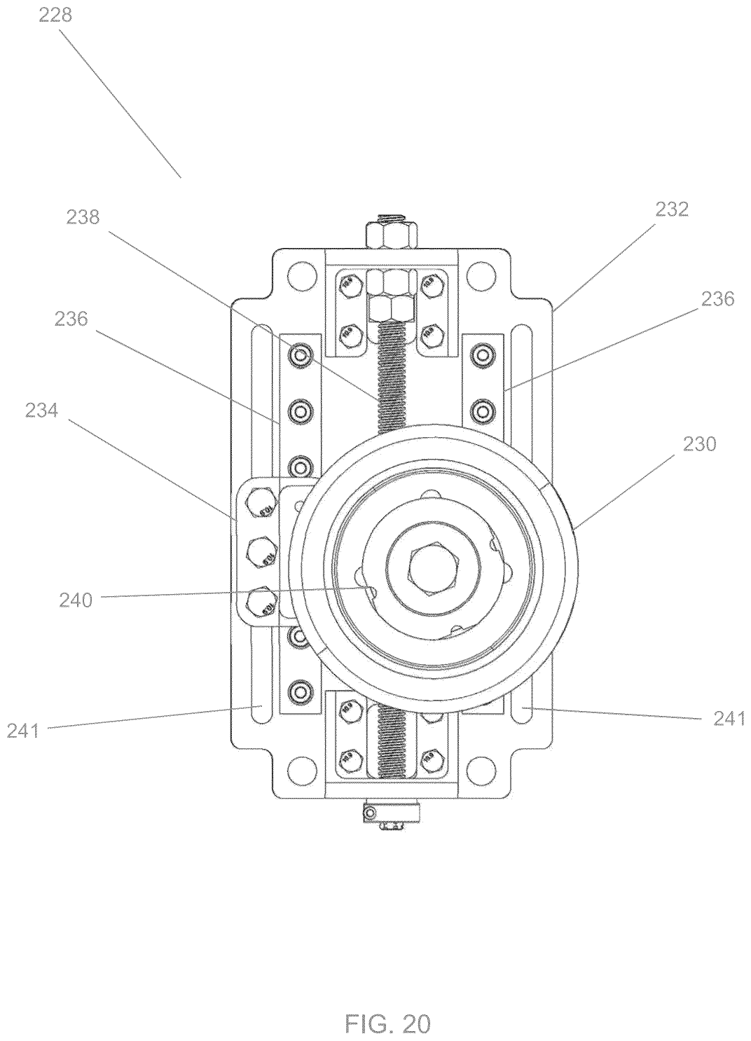

A first belt tensioner assembly (228) includes a first tensioner pulley (230) operably responsive to a first belt (222). As shown in FIGS. 213 and 20, a first belt tensioner assembly (228) includes a first tensioner pulley (230) secured to slide mount (234) and supported by a bearing (240) so as to be rotatable in response to the action of the first belt (222). The slide mount (234) is positioned over a pair of slide rails (236) secured to a frame mount (232). In a preferred embodiment, an adjustor (238) is secured to the slide mount (234) and configured to adjust the lateral position of the mount (234). In the preferred embodiment shown in FIG. 20, the adjustor (238) of the disclosure includes a threaded rod secured to the slide mount (234) via a threaded coupler (not shown) secured to the first tensioner pulley (230). In this configuration, rotation of the adjustor (238) causes the slide mount (234), positioned approximately perpendicular to the frame body (210), to move upward, thereby reducing tension on the first belt (222), or downward and thereby increasing tension on the first belt (222). The position of the slide mount (234) can be fixed by securing one or more fasteners within a locking aperture (241) positioned adjacent to the slide rails (236).

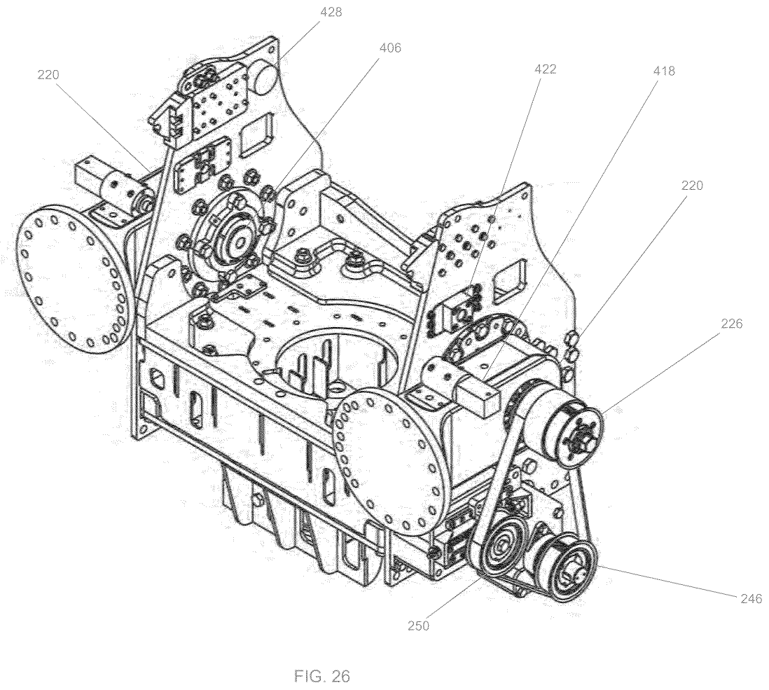

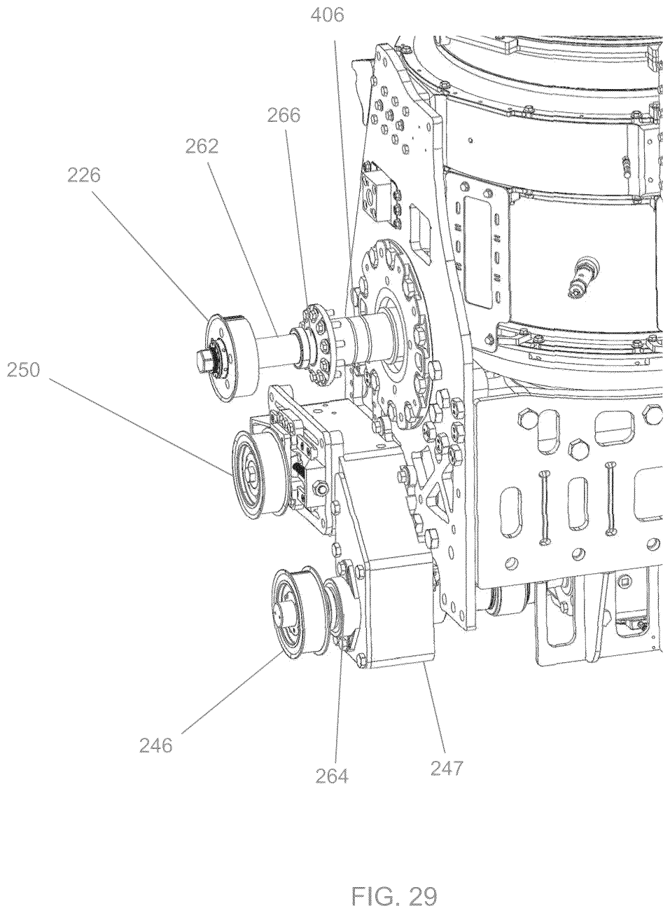

In a preferred embodiment, the second belt drive(s) (243) are operably linked to the first belt drive(s) (221) via the shared central pulley (226) positioned on the shaft housing (220). In this embodiment, the central pulley (226) includes a collar (242) separating the surface of the central pulley (226) into two separate belt tracks. As shown to FIGS. 26 and 29, a second belt (244) is secured to the internal belt track of the central pulley (226) and further responsive to a second pulley (246) positioned on the lateral of side of a tilt mount (247). In this configuration, the rotational energy from the secondary axis motor(s) (212) is transmitted through the first belt drive(s) (221) to the second belt drive(s) (243) via the central pulley (226). The central pulley (226) is rotatably coupled with a bearing support (262) which is secured to a pivot shaft (406) via a spacer plate (266). In this configuration, the free rotation of the second pulley (246) is supported by the bearing support (262) while the spacer plate (266) blocks this rotational energy from being transmitted to the pivot shaft (406).

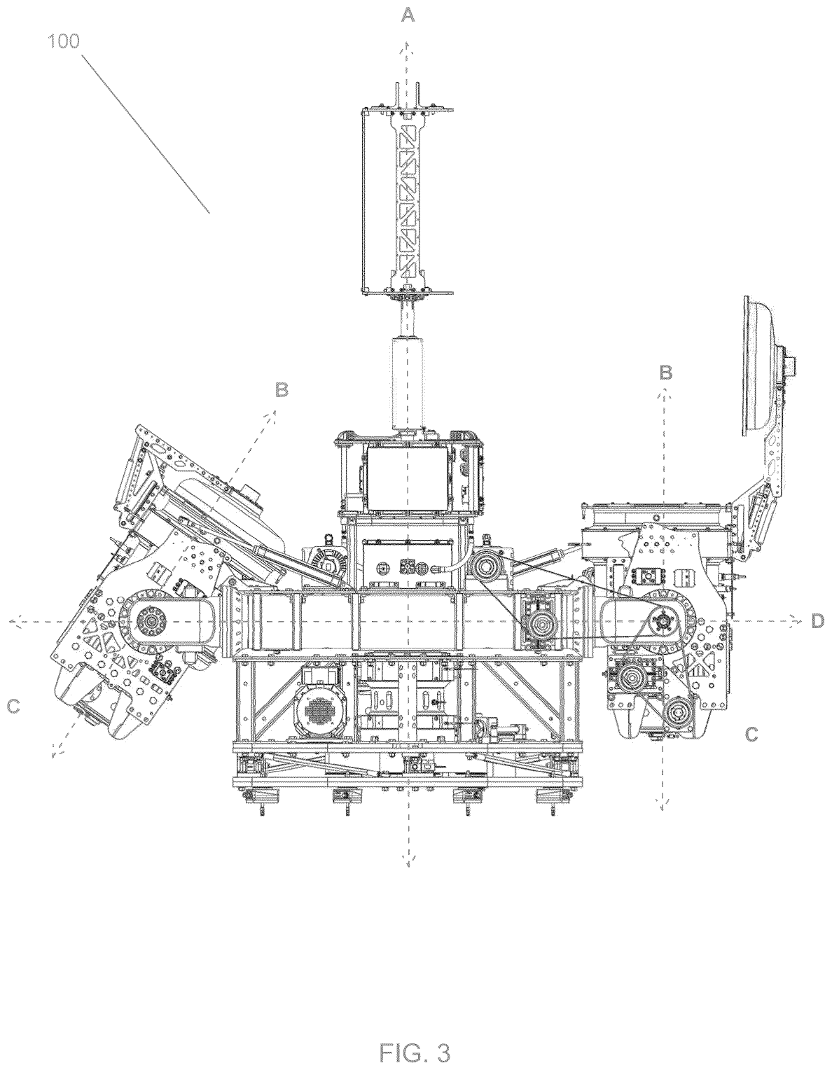

To accomplish dual axis mixing the container (902) containing the material to be mixed is tilted at an inward angle (C) towards the primary axis (A) of rotation and aligned with the secondary axis (b) of rotation as shown in FIG. 3. In a preferred embodiment, the ratio between the primary axis (A) of rotation and secondary axis of rotation, sometimes referred to as the axis of counter rotation is fixed. As detailed below, the tilting action of the sled (402) causes the tilt mount (247) to rotate outward and away from frame body (210). Using this duel belt drive configuration the first distance between the first pulley (224) and the central pulley (226), and the second distance between the central pulley (226) and the second pulley (246) are maintained during operation. Use of a single belt drive in this instance would cause the length between the first and second pulleys to change based on the degree of tilt of the gondola (400) introducing undesired slack into the transiting belt.

The second belt drive(s) (243) can include a second belt tensioner assembly (248) having a second tensioner pulley (250) which is operably responsive to a second belt (244). As shown in FIGS. 4 and 20, a second belt tensioner assembly (248) includes a second tensioner pulley (250) secured to slide mount (254) and supported by a bearing (260) so as to be rotatable in response to the action of the second belt (244). The slide mount (254) is positioned over a pair of slide rails (256) secured to a tilt mount (247). In a preferred embodiment, an adjustor (258) is secured to the slide mount (254) and configured to adjust the mount (254). In the preferred embodiment shown in FIG. 20, the adjustor (258) of the disclosure includes a threaded rod secured to the slide mount (254) via a threaded coupler (not shown). In this configuration, rotation of the adjustor (258) causes the slide mount (254), positioned approximately parallel to the frame body (210), to move inward, thereby increasing tension on the second belt (244), or outward thereby decreasing tension on the second belt (244). The position of the slide mount (254) can be fixed by securing one or more fasteners within a locking aperture (261) positioned adjacent to the slide rails (266).

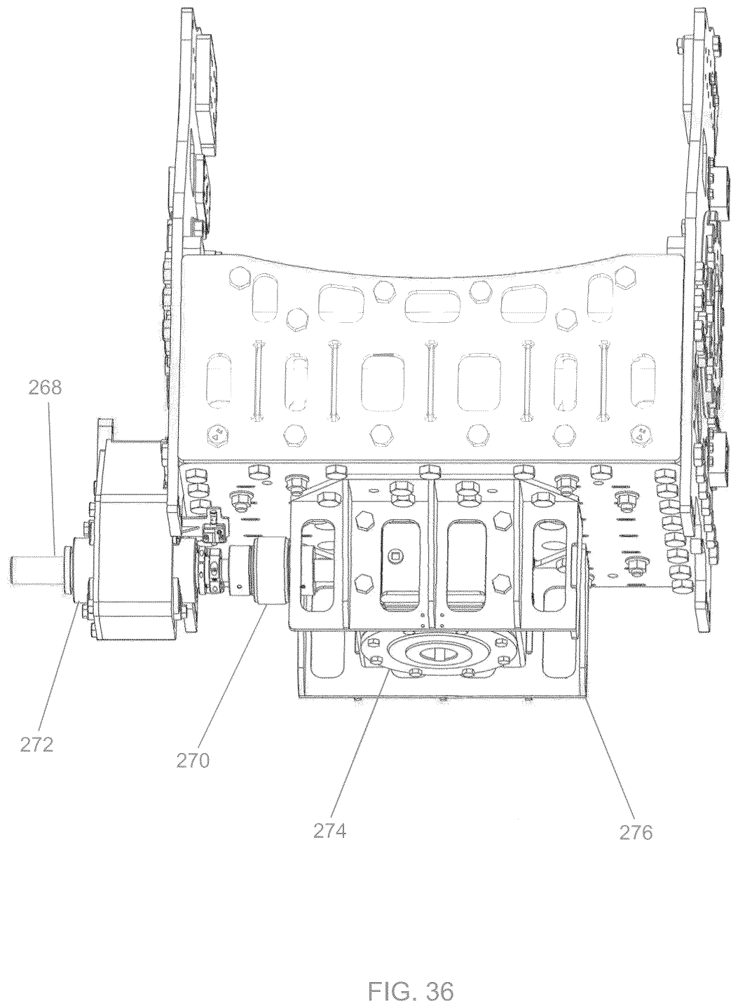

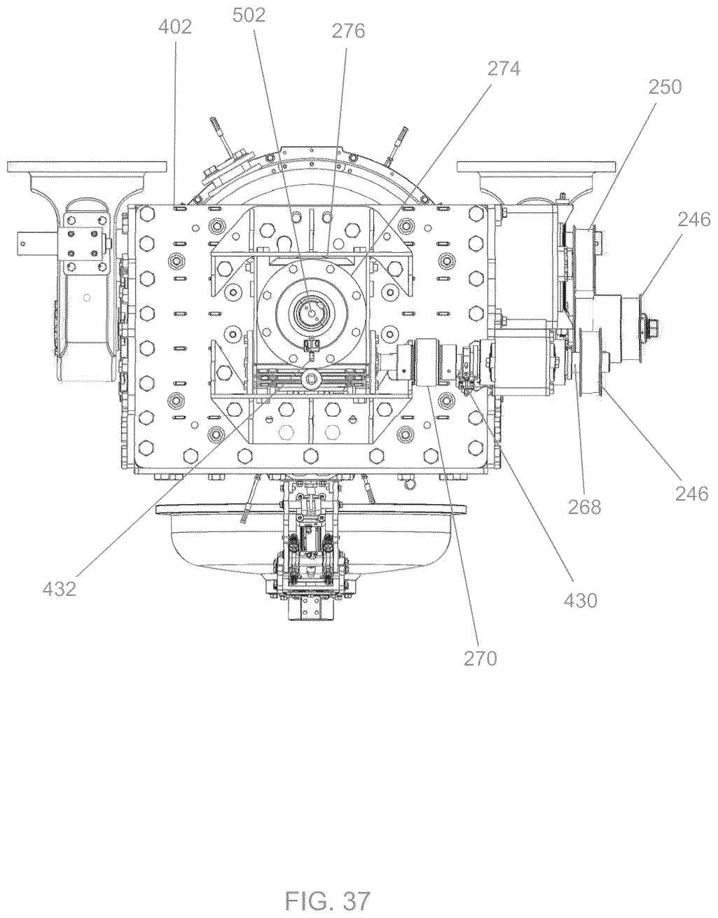

Referring to FIG. 4 and 36-37, the second pulley (246) is coupled with a gondola drive shaft (268), which is operably responsive to a gondola gearbox (274) rigidly coupled to the bottom surface of the sled (402) by a gearbox mount (276). In this configuration, the gearbox mount (276) converts the rotation force from the secondary axis motor(s) (212), which is a transmitted through the first and second belt drives (221, 243), to a secondary spindle (502) coupled with a rotatable basket (572) thereby rotating it about the secondary axis (B)or rotation. The gondola drive shaft (268) is further rotatable coupled with a bearing housing (264). In the preferred embodiment shown in the FIG. 37, the gondola drive shaft (268) can be divided into two separate shaft sections and further coupled with a shaft coupler (270), which in a preferred embodiment includes a high-torque shaft coupler configured to transmit power and rotational motion and permit some degree of parallel, axial, or angular misalignment between the shaft segments during operation.

As shown in FIG. 4, in one embodiment one or more modular weighted masses (286) can be secure to the body of the gantry assembly (200). For example, in certain embodiments it may be desirous to have a balanced load between both gondola assembly (400) secured to either end of the gantry assembly (200). If an unbalanced load is detected, one or more modular weighted masses (286) can be secured to the body of the gantry assembly (200) to compensate for any unbalanced loads. In one embodiment, a one or more modular weighted masses (286) can be secured to the body of the gantry assembly (200) to compensate for and create a balanced load about the primary axis (A) of rotation when using only a single gantry gondola assembly (400) during operation.

The dual-axis centrifugal mixing assembly (100) of the disclosure includes a control assembly (300). In a preferred embodiment, the control assembly (300) is coupled to the gantry assembly (200) preferably along the primary axis (A) of rotation and is configured to secure and facilitate the transmission of power and secondary systems outputs, such as a vacuum pump (not shown), pneumatic air pumps (not shown), hydraulic pumps (not shown), and the like from secured positions adjacent to the mixing assembly (100).

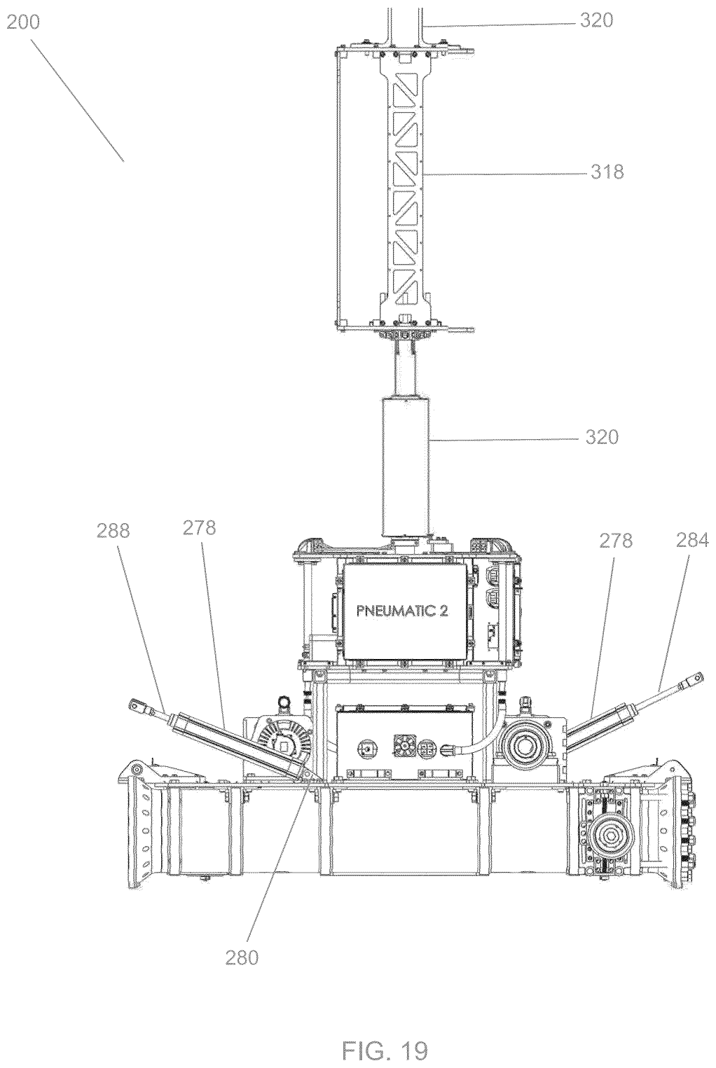

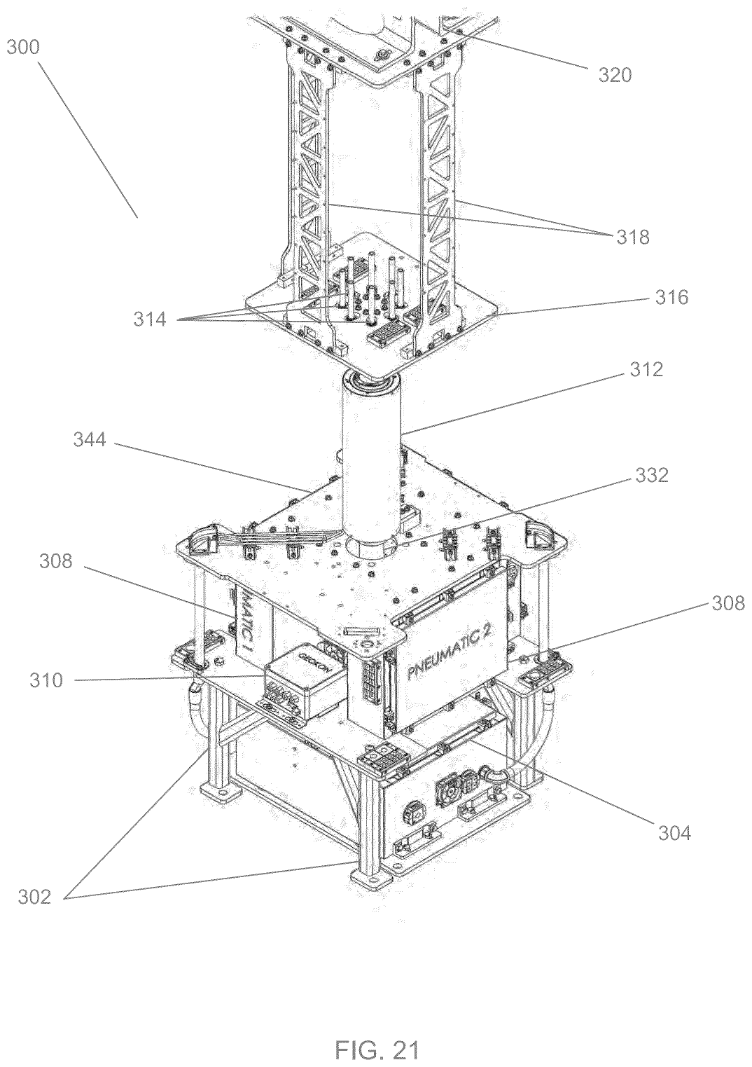

As can be seen in the figures, the transmission of power and secondary systems outputs from adjacent devices are required to be transferred to positions on the gantry assembly (200), among other sub-assemblies that are rotating during operation. To facilitate this transfer, the control assembly (300) of the disclosure includes a control scaffold (302). As shown in FIGS. 19 and 21, the control scaffold (302) includes a housing rigidly secured to the top portion of the gantry surface (206), preferably along the primary axis (A) of rotation.

The control scaffold (302) can include an upper and lower portion configured to house one or more operational modules. For example, in one embodiment a pair of secondary axis motor drive(s) (304) are secured in a lower portion of the control scaffold (302). Each secondary axis motor drive(s) (304) includes a power source, and a module having a processor configured to execute machine executable instructions that are programed to control the operation of their corresponding secondary axis motor(s) (212). In another embodiment, one or more pneumatic controllers (308) and/or power controller (310) can be secured to the control scaffold (302).

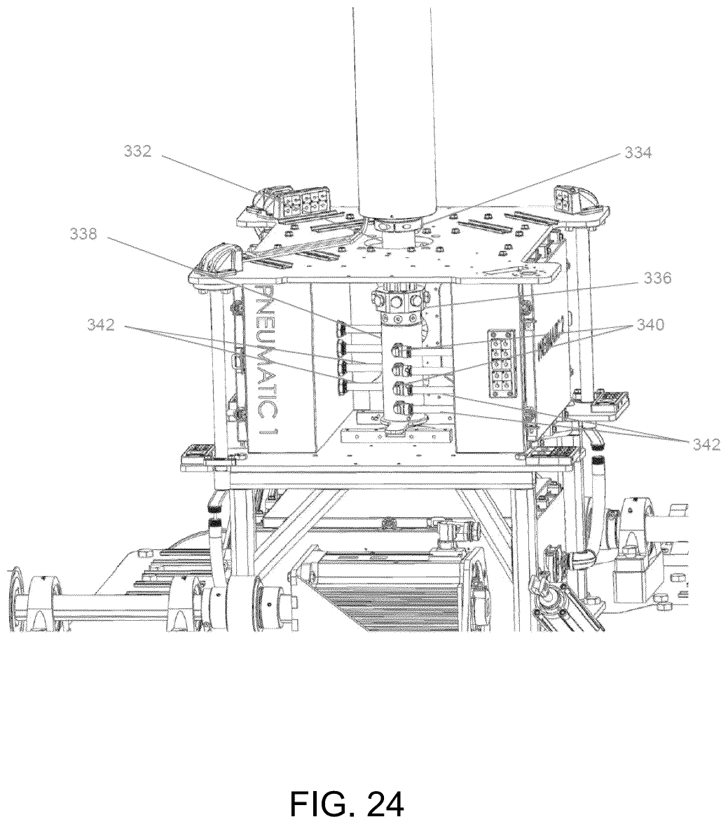

In the embodiment shown in FIGS. 21 and 24, a pneumatic controller (308) can include components necessary to receive and transmit compressed air to drive one or more pneumatically operable components of the mixing assembly (100). In certain embodiments, the pneumatic controller(s) (308) of the disclosure include a module having a processor configured to execute machine executable instructions that are programed to control the operation of one or more pneumatically operable components of the mixing assembly (100). In some embodiments, the pneumatic controller(s) (308) are responsive to a remotely positioned controller (801) via wireless or wired connection.

In the embodiment shown in FIG. 21, a power controller (310) can include components necessary to receive and transmit power to drive one or more electrically operable components of the mixing assembly (100). In certain embodiments, the power controller(s) (310) of the disclosure include a module having a processor configured to execute machine executable instructions that are programed to control the operation of one or more electrically operable components of the mixing assembly (100). In some embodiments, the power controller(s) (310) are responsive to a remotely positioned controller (801) via wireless or wired connection.

It should be noted that the position of the power and pneumatic controller(s) (310, 308) is exemplary only, as they can be secured to the control scaffold (302), or in alternative embodiments the gantry assembly (200), while in further embodiments the power and pneumatic controller(s) (310, 308) are positioned remotely from the device and operate the electrical and pneumatic operations through the slip ring assembly (312) as described below.

The controller assembly (300) can be secured to a rigid support or other structure, such as a safety enclosure (800), scaffolding, or other secured surface via a rigid mount (320) positioned at the top portion of the controller assembly (300). As shown in FIG. 21, an input mount (316) can be positioned below the rigid mount (320) and secured in position by one or more variable length spacer arms (318). The input mount (316) of the disclosure can secure a variety of input positions (314) configured to receive and transmit one or more inputs, such as electrical, pneumatic, vacuum, or hydraulic inputs generated from their corresponding devices. These inputs can originate from devices that are positioned adjacent from the mixing assembly (100) and transmitted via one or more conduits or tubes that can be coupled to one or more input positions (314). In a preferred embodiment, one or more inputs can be transmitted through the input positions (314) through an input assembly (324) which is configured to direct the inputs through a manifold (322) that is in communication with a slip ring assembly (312).

As noted above, the upper portion of the controller assembly (300) can be secured to a static surface so as to remain stationary and facilitate the connection and transmission of various inputs through cables or tubes that cannot be rotated, while the lower portion of the controller assembly (300) is secured to the gantry assembly (200) and rotates around the primary axis (A) during operation of the mixing assembly (100). To facilitate the rotation of the lower portion of the controller assembly (300), and the efficient transmission of the various inputs from the stationary upper portion to the rotating lower portion of the controller assembly (300), upper and lower portions of the controller assembly (300) are operably coupled by a rotatable slip ring assembly (312) configured to receive inputs from the manifold (322) and transmit the inputs through the rotating slip ring assembly (312).

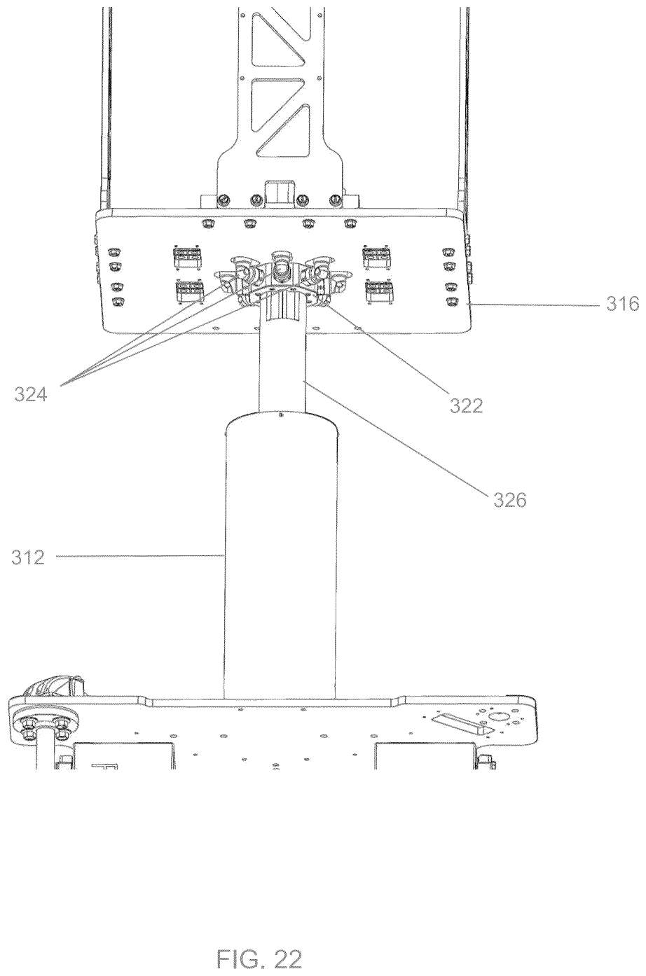

As shown in the preferred embodiment of FIGS. 21-23, the slip ring assembly (312) of the disclosure can include an external rotating assembly (328) positioned over an internal rotating assembly (330). An upper coupler shaft (326) is coupled with the manifold (322) and configured to convey the inputs to the top portion of the slip ring assembly (312). A lower coupler shaft (332) is coupled to the bottom portion of the slip ring assembly (312) and configured to convey the inputs, and preferably pneumatic or vacuum inputs from the slip ring assembly (312). In the preferred embodiment showing in FIG. 24, the lower coupler shaft (332) comprises a rotary union and is further coupled to a pneumatic manifold (338) via connector further secured to a flange (336) and supported by a collar (334).

As further shown in the figures, the pneumatic manifold (338) includes a plurality of pneumatic couplers (340) secured to tubes (342) to convey compressed air inputs to corresponding inlet valves (348) within a pneumatic control housing (346). The inlet valves (348) are in communication with a regulator (350) through a tube (not shown) connecting the inlet valves (348) with a corresponding fitting (not shown). A pressure sensor (354) can be responsive to the regulator (350) and can transmit a signal to a controller (801), or other control module, reporting the status and operation of each regulator (350) position.

In one embodiment, the pneumatic manifold (338) can include a pneumatic control module (355) having a processor configured to execute machine executable instructions that are programed to control the operation of one or more components of the pneumatic manifold (338). In alternative embodiments, the pneumatic control module (355) is responsive to a controller (801) having a processor configured to execute machine executable instructions that are programed to control the operation of one or more components of the pneumatic manifold (338) via the pneumatic control module (355).

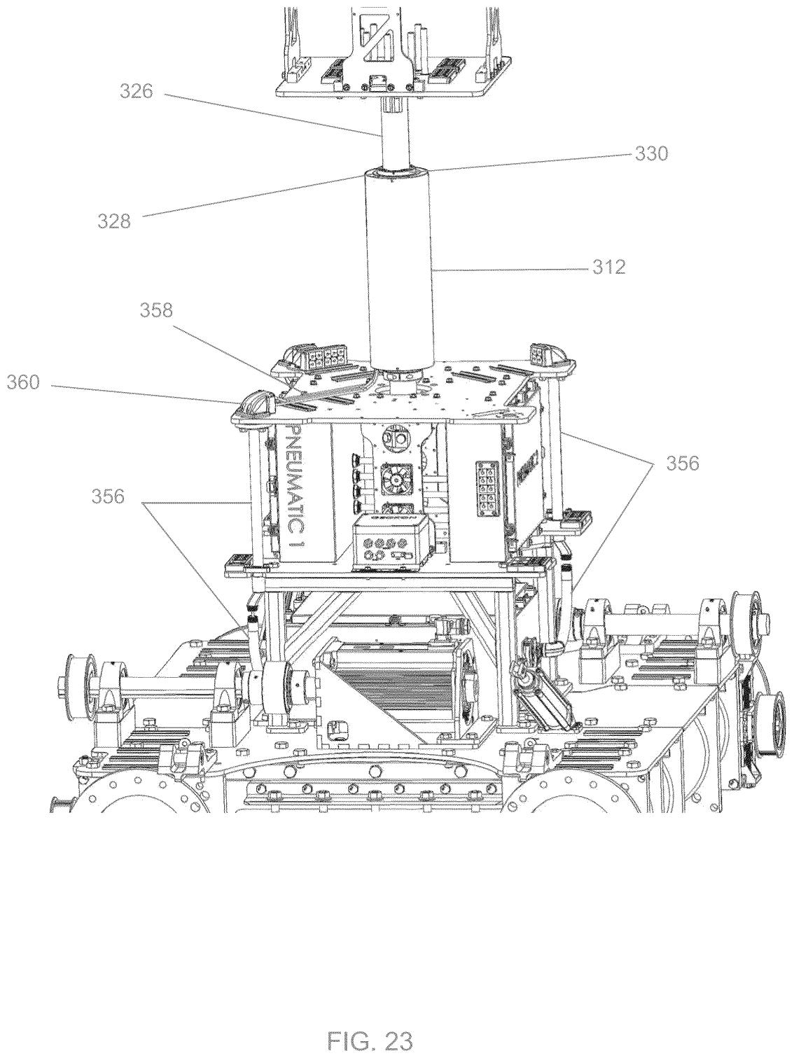

The slip ring assembly (312) of the disclosure can further be electrically coupled to one or more power cables (358) configured to receive power transmitted from an external power source (not shown) through the slip ring assembly (312). As shown in the preferred embodiment of FIG. 23, one or more power cables (358) can be secured to a cable mount (360) positioned on a base (344) positioned below the slip ring assembly (312), and further directed through one or more conduits (356) to a power controller (310), or directly to the electrically-responsive devices of the mixing assembly (100), such as the secondary axis motor drive(s) (304) and the like.

The dual-axis centrifugal mixing assembly (100) of the disclosure includes a gondola assembly (400), which in a preferred embodiment includes a sled (402) configured to hold a chamber assembly (500). In this preferred embodiment, the gondola assembly (400) can be tilted inward at angle (C), sometimes referred to as the title angle (C), to align the chamber assembly (500) with the desired secondary axis (B) of rotation during mixing or tilted outward (or inward) at the angle (C) to align the chamber assembly (500) in an approximately vertical position to facilitate the loading and unloading of a container (902) in between mixing cycles. As noted elsewhere, the secondary axis (B) of rotation is shown in FIG. 3 is not a fixed position having a single angle in relation to the primary axis (A) and centerline (D). More specifically, the secondary axis (B) of rotation can include a plurality of angled positions relative to the primary axis (A) and centerline (D). The secondary axis (B) of rotation can be determined by the position of the tilt angle (C) gondola assembly (400) in relation to the primary axis (A)/centerline(D) of the disclosure which can include a number of angled positions that are perpendicular to the centerline (D), as well as greater or less than 90° degrees in relation to the centerline (D).

In a preferred embodiment, the gondola assembly (400) includes a sled (402) adapted to secure a chamber assembly (500) and tilt the assembly, so a container (902) is positioned along the secondary axis (B) of rotation. As noted elsewhere, in the preferred embodiment shown in the Figures, the mixing assembly (100) of the disclosure includes two gondola assemblies (400) positioned on opposing ends of the gantry assembly (200). As such, reference to a component or action of the gondola assembly (400) can include both the individually referenced gondola assembly (400), as well as additional or a plurality of gondola assemblies (400) as shown and described herein. For example, in some embodiment the mixing assembly (100) of the disclosure can have between 1 and 12, or more gondola assemblies (400).

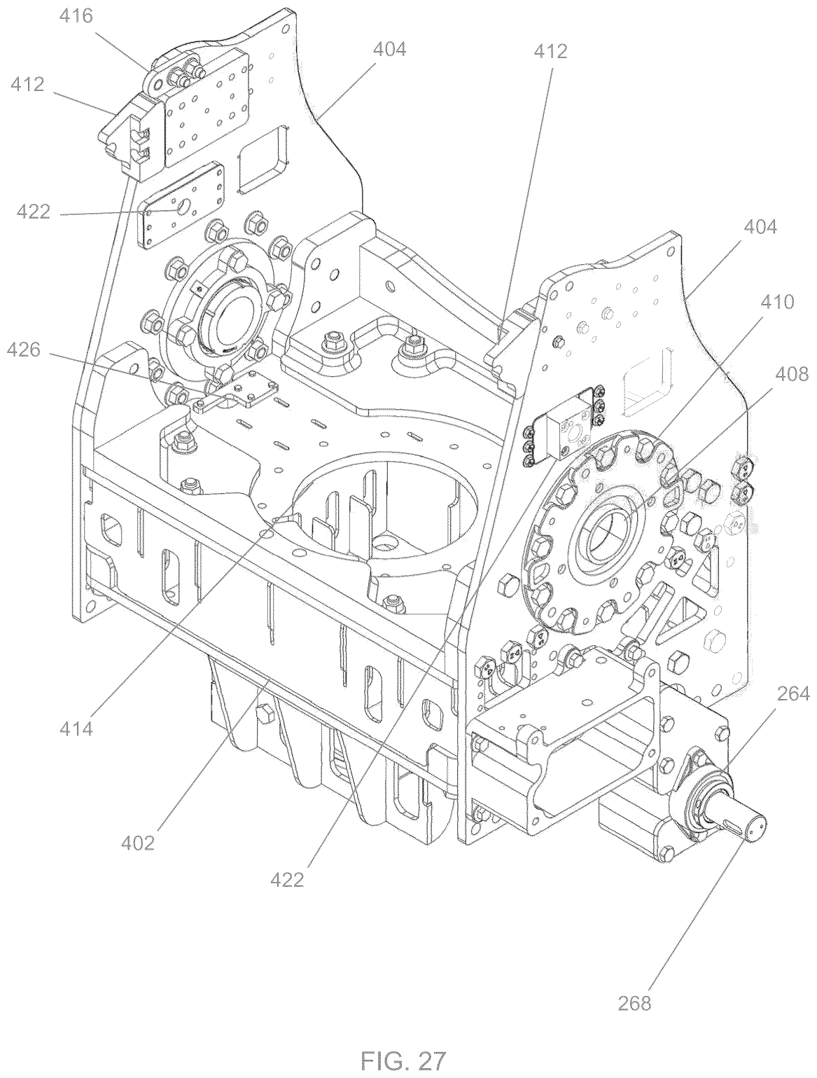

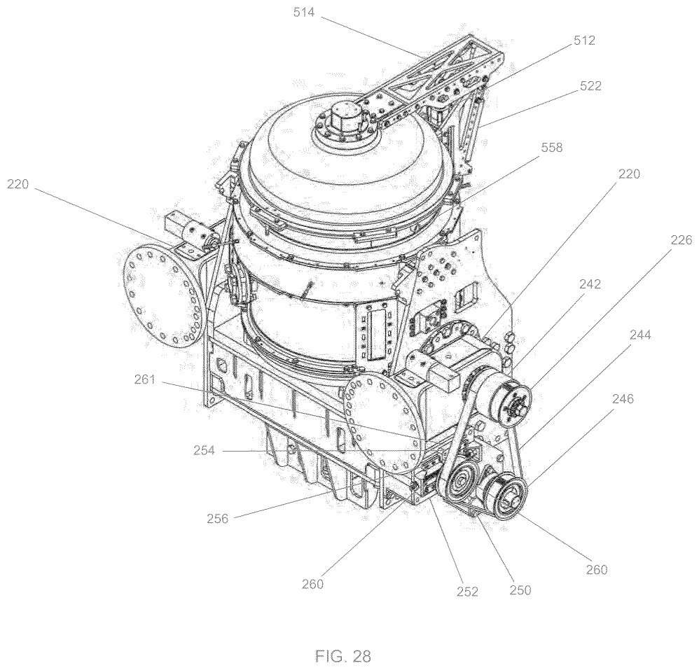

The sled (402) of the disclosure includes a body portion containing a sled aperture (414) adapted to accommodate the chamber assembly (500), and a pair of opposing side walls (404) each rotatably coupled with adjacently positioned shaft housings (220) via a pivot shaft (406). In the preferred embodiment shown in FIGS. 27-29, each side wall (404) houses a pivot bearing (408) configured to accommodate a pivot shaft (406). A spacer (410) can be positioned adjacent to the pivot bearing (408) to create separation between the sled (402) and the adjacent shaft housings (220) to facilitate the tilting action of the sled.

The sled (402) of the disclosure is operably linked to one or more actuators (278) secured to the gantry assembly (200) via actuator mounts (280). In the preferred embodiment shown in FIGS. 4 and 27, the piston (288) of the actuator (278) is secured to the top portion of the side wall (404) via a piston bracket (416) forming a levered connection. The one or more actuators (278) are responsive to a pneumatic, hydraulic, or electrical input directed through the slip ring assembly (312) as described above.

In one embodiment, the operation of the actuator (278) causes the piston to retract causing the sled (402) to rotate outward about angle (C) until it is approximately vertical, also sometimes referred to as the first position. As noted below, while the sled (402) is in this approximately vertical position a container (902) can more easily be positioned within the chamber assembly (300) during a load/unload phase of operation. Operation of the actuator (278) in the opposite direction causes the piston (288) of the actuator (278) to retract causing the sled (402) to rotate inward about angle (C) until the sled (402) is positioned such that the chamber assembly (500) aligns with the secondary axis (B) of rotation, also sometimes referred to as the second position. A tilt stop bracket (412) can be secured to the sled (402) to ensure alignment of the chamber assembly (300) along the secondary axis (B) of rotation. In the preferred embodiment shown in FIG. 27, a tilt stop bracket (412) is positioned on the top portion of the side wall (404) of the sled (404). The sled (402) is tilted inward at the angle (C) until the tilt stop bracket (412) contacts a corresponding tilt stop (284) positioned on the gantry surface (206) stopping further movement of the sled (402). The position and shape of the tilt stop bracket (412) and/or tilt stop (284) is such that at the point of contact, the sled (402) is positioned so that the chamber assembly (500) aligns with the secondary axis (B) of rotation.

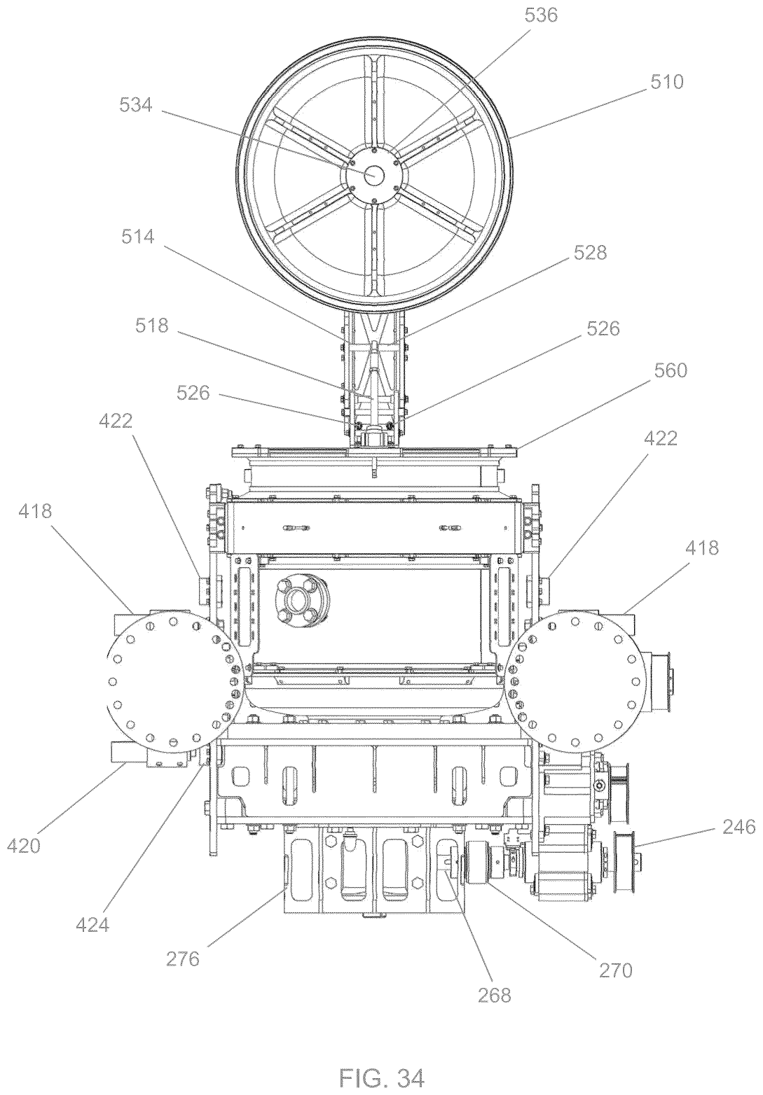

The gondola assembly (400) can be secured in both the first and second positions during operation. In one embodiment, one or more locks can secure the sled in the first of second position. In this embodiment, when the sled assembly (402) is in the first position, one or more vertical lock out pins (420) can be secured to a corresponding vertical lock out bracket (424) thereby locking the assembly in an approximately vertical position to facilitate loading and unloading of the container (902) into the mixing chamber (501). As shown in the embodiment of FIG. 34, a vertical lock out pin (420) is rigidly secured to the shaft housing (220). When the action of the actuator (278) positions the sled (402) into the first position, the pin of the vertical lock out pin (420) is positioned adjacent to a vertical lock out bracket (424) on the side wall (404) of the sled (402). The pin of the vertical lock out pin (420) is inserted into the vertical lock out bracket (424) securing the sled (402) in the first position.

When the sled assembly (402) is in the second position, one or more tilt lock out pins (418) can be secured to a corresponding tilt lock out bracket (422) thereby locking the assembly in alignment with the secondary axis (B) of rotation prior to initiating rotational mixing about the axis. As shown in the embodiment of FIGS. 26-27, a pair of tilt lock out pins (418) are rigidly secured to the top and bottom portions of the shaft housing (220). When the action of the actuator (278) positions the sled (402) into the second position, the pins of each of the tilt lock out pins (418) is positioned adjacent to a corresponding tilt lock out bracket (422) on the side wall (404) of the sled (402). The pins of the tilt lock out pin (418) are inserted into their corresponding tilt lock out bracket (422) securing the sled (402) in the second position.

In one embodiment, the lock out pins (418, 420) of the disclosure are responsive to a controller, such that insertion of the pin into its corresponding bracket (422, 424) is in response to a signal from a position or proximity sensor or other similar detection device, such as a tilt position sensor (428) configured to detect and transmit, preferably to a controller (801) the position of the gondola assembly (400) along angle (C). In alternative embodiments, insertion of the pin into its corresponding bracket (422, 424) can be accomplished manually, or as part of a machine executable program initiated by the controller (801). Naturally, the type, placement and number of lock out pins (418, 420), or other locking devices are exemplary only, and provided only as preferred embodiments.

The gondola assembly (400) of the disclosure includes one or more sensors. Generally referring to the preferred embodiment FIGS. 27 and 37, one or more vibration sensor (426) can be positioned on the sled (402) and configured to detect vibration of the assembly (400) or a portion thereof. In a preferred embodiment, the vibration sensor (426) can transmit a signal, such as a stop or speed reduction signal, to a controller (801) if the vibration of the sled (402), or other responsively coupled component exceeds a pre-determined threshold.

An output shaft speed sensor (430) can be positioned adjacent to the secondary spindle (502) and configured to measure the speed of the spindle during operation. Similarly, an input shaft speed sensor (432) can be positioned adjacent to the gondola drive shaft (268) and configured to measure the speed of the shaft during operation. One of both sensors can further be configured to transmit a signal, such as a stop, or speed change signal, to a controller (801) if the speed of the rotation of the corresponding secondary spindle (502) or gondola drive shaft (268) exceeds or falls below a pre-determined threshold.

The gondola assembly (400) of the disclosure includes a chamber assembly (500) having a static mixing chamber (501) housing a rotatable basket (572) configured to receive and secure a container (902). The mixing chamber (501) of the disclosure can be rigidly secured to the body of the sled assembly (402) by one or more mounting brackets (552) and further positioned over the sled aperture (414) to allow transit of the secondary spindle (502) through the body shell (402) which can be operably secured to the basket (572). As noted elsewhere, in the preferred embodiment shown in the Figures, the gondola assembly (400) of the disclosure includes two chamber assemblies (500) positioned on opposing ends of the gantry assembly (200). As such, reference to a component or action of the chamber assembly (500) can include both the individually referenced chamber assembly (500), as well as an additional or plurality of chamber assemblies (500) as shown and described herein. For example, in some embodiments the mixing assembly (100) of the disclosure can have between 1 and 12, or more chamber assemblies (500).

The top portion of the mixing chamber (501) includes a chamber lid (510) which can be configured to enclose the rotating basket (572) and container (902), as well as forming a seal allowing the internal chamber to be pressurized so as to allow the formation of a low-pressure vacuum environment during operation. The chamber lid (510) can be operated via one or more actuators configured to open or close the lid manually, or automatically in response to a signal from a controller (801). In a preferred embodiment, the one or more actuators include pneumatic or hydraulic actuators which are responsive to pressurized air/hydraulic inputs passing through the slip ring assembly (312) as described herein.

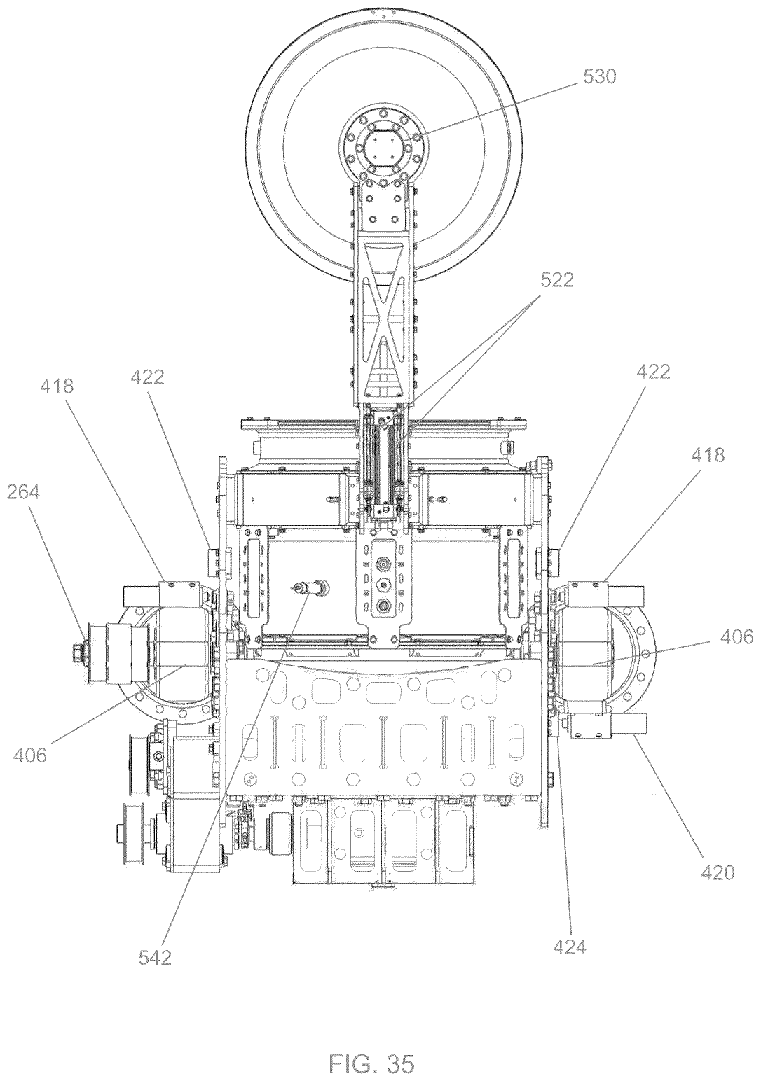

Generally referring to the preferred embodiment of FIGS. 34-35, the chamber lid (510) is coupled with a pivot arm (514) which is coupled with an arm mount (516) positioned on the side of the mixing chamber (501) via a pivot joint (520). A first lid actuator (512) is secured to lower portion of the arm mount (516) and further includes a lid piston (518) coupled with a crossbar positioned distal from the pivot joint (520). In this configuration, the first lid actuator (512) forms a cantilevered connection with the pivot arm (514) such that retraction of the lid piston (518) causes the pivot arm (514) to lift the chamber lid (510) away from the mixing chamber (501). Conversely, extension of the lid piston (518) causes the pivot arm (514) to retract the chamber lid (510) towards the mixing chamber (501). One or more additional lid actuators (522) can be secured to the arm mount (516) and include a piston (524) secured to the terminal portion of the pivot arm (514) via an extension bracket (526). In this embodiment, the additional lid actuators (522) can act as dampeners to regulate the open/close action of the chamber lid (510) in response to the first lid actuator (512).

In its closed positions the chamber lid (510) can form an airtight seal. In one embodiment, the chamber lid (510) is positioned against a seal ring (560) having one or more O-rings (562) forming a sealed environment within the mixing chamber (501). A lid sensor (550) can be positioned to the top portion of the mixing chamber (501). In this preferred embodiment, the lid sensor (550) includes a proximity sensor that can detect and transmit a signal to a controller (801) indicating if the chamber lid (510) is in an open or closed position. In certain embodiments, the controller (801) can include a programable machine executable instructions that can prevent initiating of one or more operations of the mixing assembly (100) until the chamber lid (510) is confirmed to be in a closed or open position. The controller (801) can further include a programable machine executable instructions that can stop the operation of the mixing assembly (100) in the event the lid sensor (550) detects that the chamber lid (510) moves to the open position during operation of the mixing assembly (100).

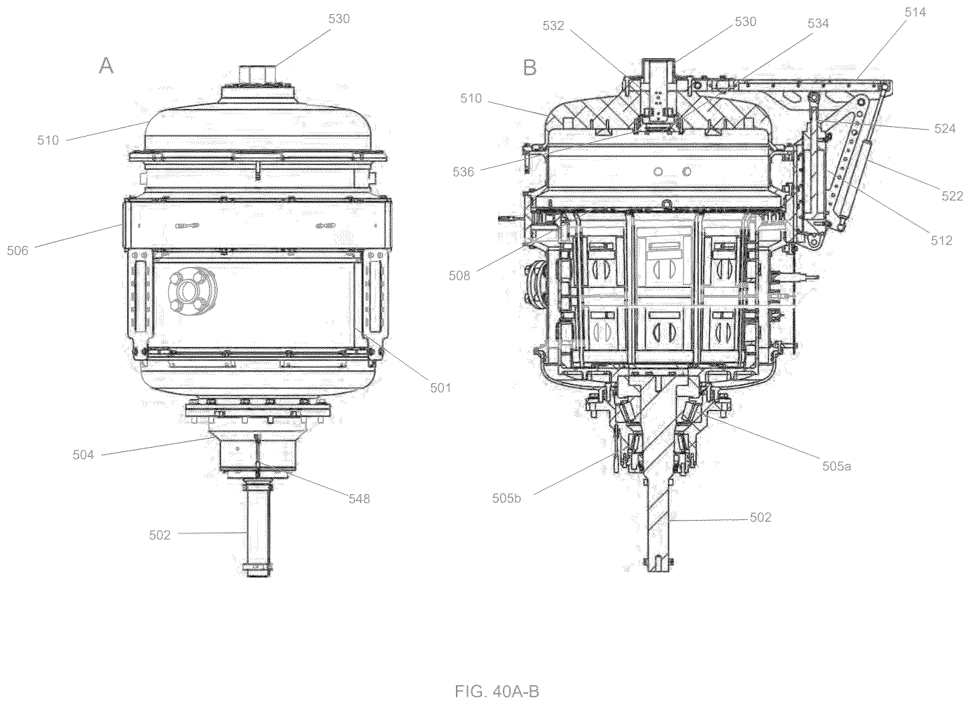

The chamber lid (510) includes an imager housing (530) adapted to secure one or more imaging devices adapted to take real-time measurements and direct observation of the material in the container (902). In the preferred embodiment of FIG. 40, a thermal imager (532) is secured within the housing (530) such that the viewing field of the imager (532) is positioned over a thermal lens (534) secured within a lens bracket (536) on the bottom of the chamber lid (510). When the chamber lid (510) is in the closed position, the thermal lens (534) is positioned in line with a lens, such as an infrared (IR) transparent lens (914) positioned within a lens housing (916) of the container (902) as detailed below. The thermal imager (532) can be responsive to a controller (801) and capture and transmit real-time images and thermal measurements of the material inside the container (902) during operation of the mixing assembly (100). In certain embodiments, the controller (801) can include a programable machine executable instructions that modulate, begin, or stop the operation of the mixing assembly (100) when images or thermal measurements from the thermal imager (532) meet one or more pre-determined qualitative or quantitative thresholds. As used herein, the term “modulate” means to change a parameter of operation, for example, such as an increase or decrease in the speed of rotation around the first or second axis (A, B) of rotation, or the increase or decrease in the pressure of the chamber assembly (500) as describe below.

The chamber assembly (500) includes one or more additional sensors configured to capture real-time measurements of the operation of the mixing assembly (100). In one embodiment, a chamber temperature sensor (540) can be externally secured to the mixing chamber (501) and be thermally responsive to the internally positioned basket (572) and/or container (902). In additional embodiments, one or more bearing sensors (548) can be externally secured to the mixing chamber (501) and be thermally and/or mechanically responsive to one or more bearings of the chamber assembly (500). In this embodiment, the sensors (540, 548) can transmit a signal, preferably to a controller (801) which can include programable machine executable instructions that can modulate or stop the operation of the mixing assembly (100) if the temperature or vibration detected by one of the sensors (540, 548) exceeds a pre-determined threshold.

The connection between the chamber lid (510) and the mixing chamber (501) can form an airtight seal allowing the internal pressure of the mixing chamber (501) to be increased or decreased. In a preferred embodiment, the mixing chamber (501) can be in fluid communication with a vacuum pump (not shown) via a pressure valve (556). The pump can be mounted to the mixing assembly (100) or positioned remotely and configured to be responsive to the slip ring assembly (312) as described above to increase or reduce the pressure of the mixing chamber (501). The vacuum pump can be operated manually or be responsive to a vacuum transducer (544) configured to measure the negative pressure within the mixing chamber (501). In a preferred embodiment, the vacuum transducer (544) can transmit a signal to a controller (801) which can include a programable machine executable instructions to increase or decrease the internal pressure of the mixing chamber (501) based on a pre-determined mixing profile, which can take into account, for example the type of material to be mixed, the amount of material to be mixed, and the operational parameters such as time, speed, and pressure, needed to mix the material.

In some embodiment, the mixing assembly can be used to mix volatile components, such as solid rocket propellent. To remove excess vapors generated by any volatile or other materials, the chamber assembly (500) can further include a purge valve (558) configured to purge the internal compartment of the mixing chamber (501). In a preferred embodiment, the purge valve (558) be configured such that any gases can be purged from the mixing chamber (501) and passed through the slip ring assembly (312) for storage, release, or further processing. Notably, this purge function can be operated simultaneously with the modulation of pressure within the mixing container, such that the operation of the mixing assembly does not need to be paused, nor does the mixing chamber (501) require re-pressurization in order to purge volatile gasses and the like.

The chamber assembly (500) further includes an overpressure relief valve (542) in communication with the internal compartment of the mixing chamber (501). This relief valve (542) can be triggered in the event the pressure inside the mixing chamber (501) exceeds a pre-determined threshold. Moreover, the chamber assembly (500) can further include a burst disc (546) in communication with the internal compartment of the mixing chamber (501). This burst disc (546) allows for the rapid venting of the internal compartment of the mixing chamber (501). Such rapid venting may be desirable in the event volatile gases within the mixing chamber (501) exceeds a pre-determined threshold or ignite requiring rapid venting.

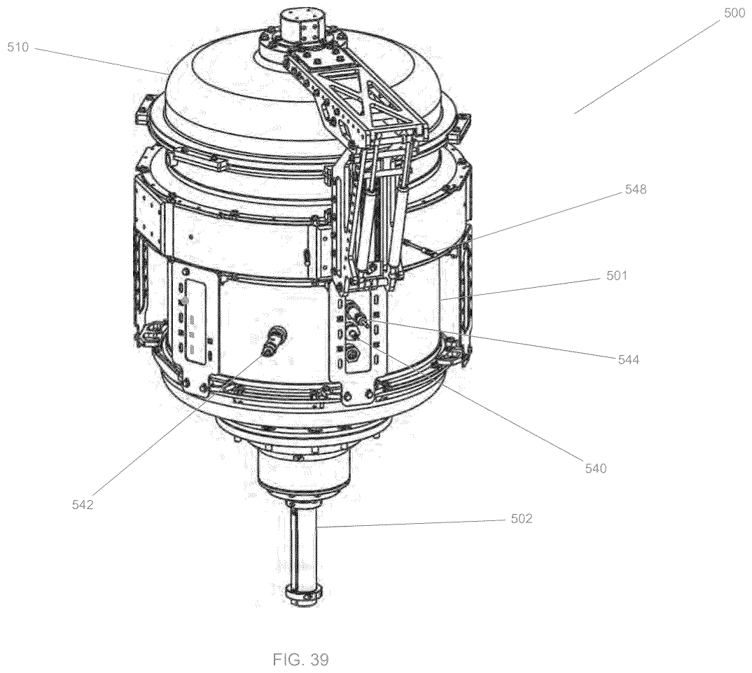

The chamber assembly (500) includes a secondary spindle (502) configured to secure and rotate a basket (572) about the secondary axis (B) of rotation. As shown in FIGS. 37-40, a secondary spindle (502) includes a rotatable shaft having a lower potion responsive to the first and second belt drives (221, 243) through the gondola gearbox (274). The rotation of the secondary spindle (502) is supported by a spindle bearing stack (504) having an upper spindle bearing (505a) and a lower spindle bearing (505b). The secondary spindle (502) is coupled to the bottom portion of the basket (572) through a spindle cap (570) configured to transmit the rotational energy of the secondary spindle (502) to the basket (572).

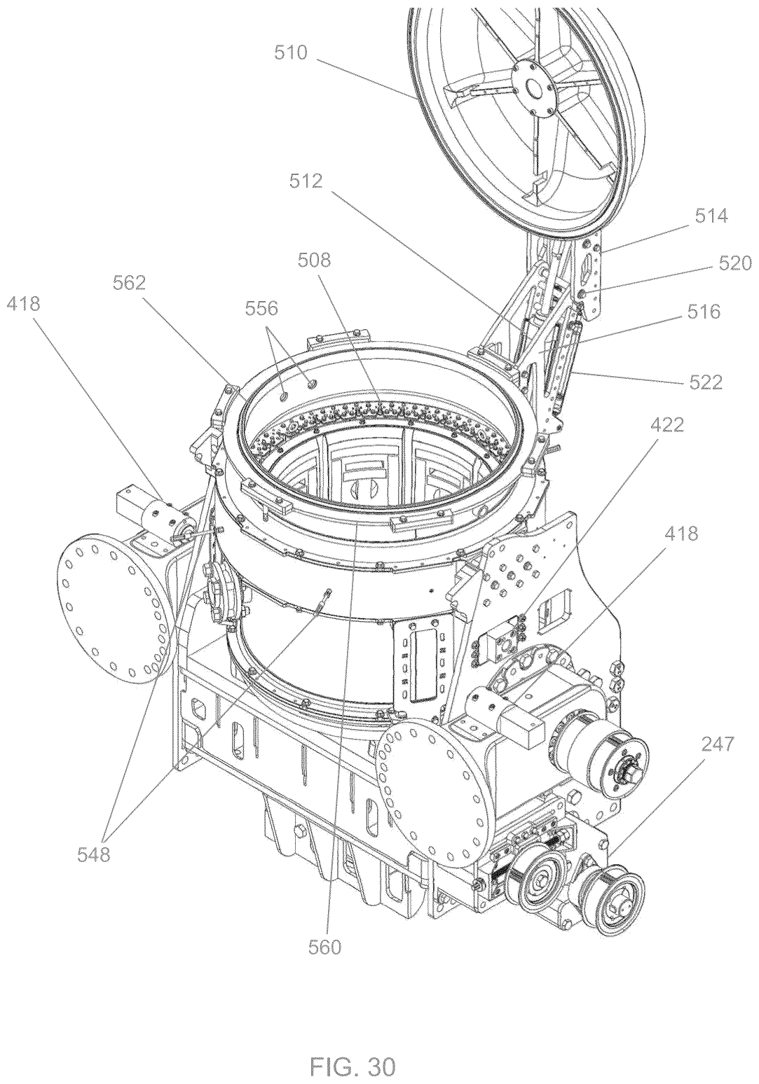

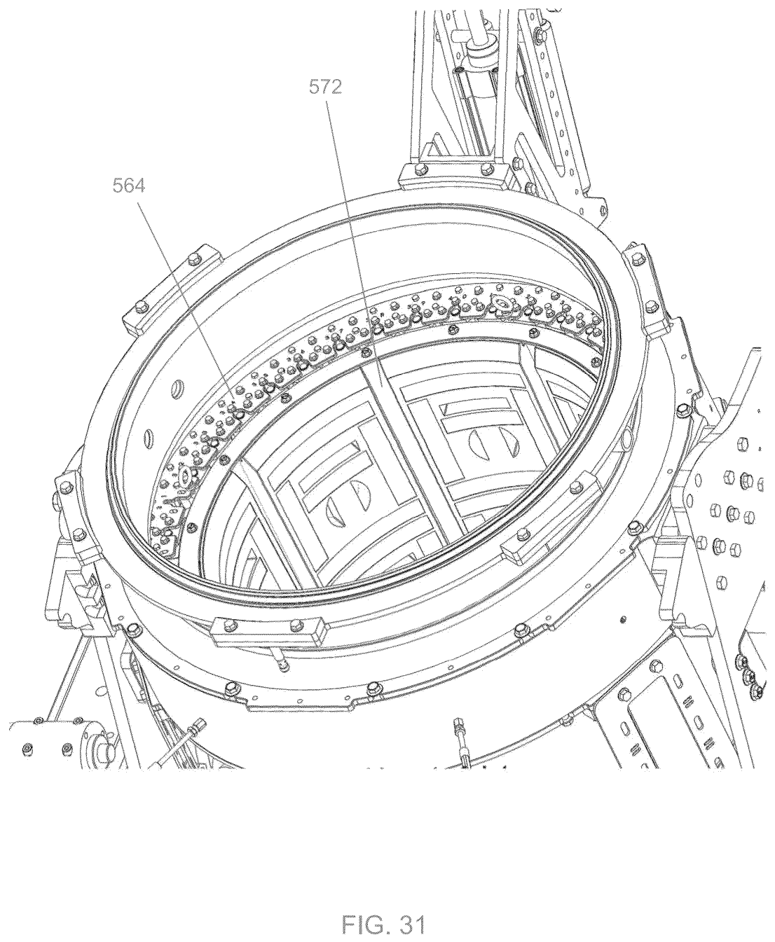

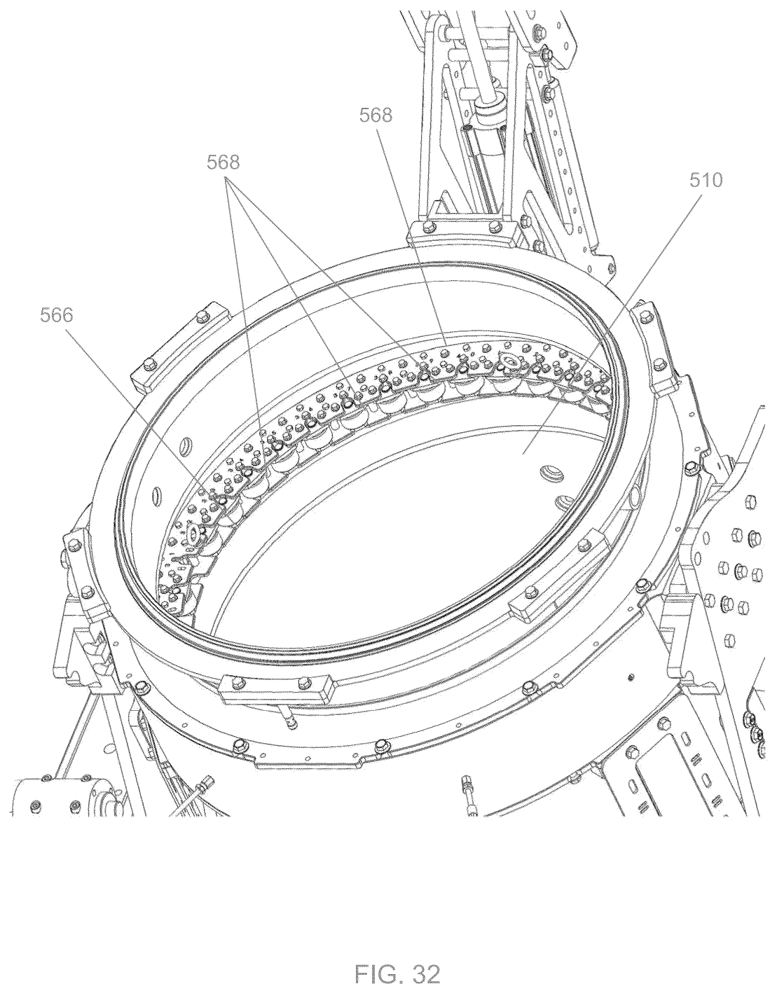

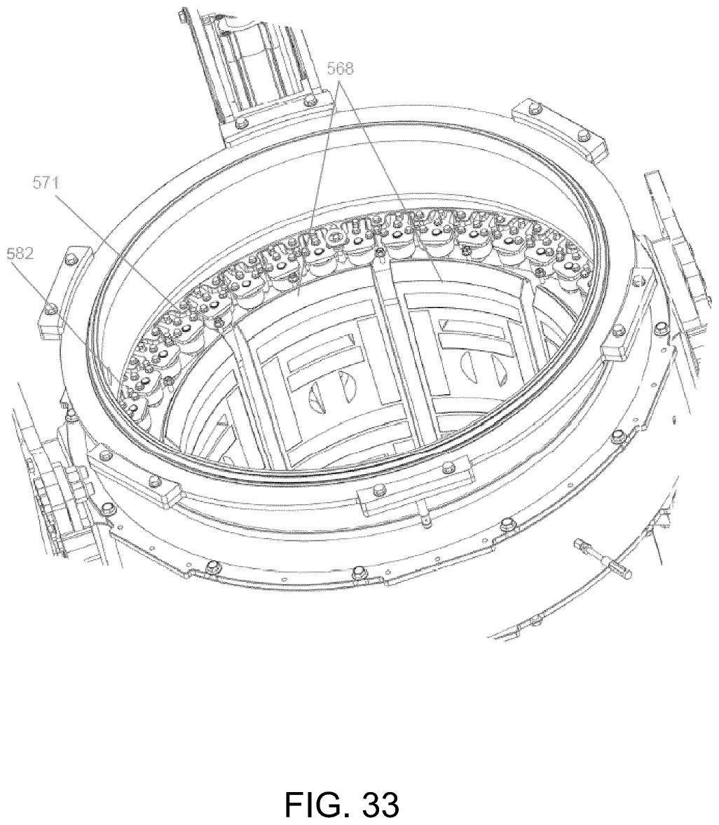

The chamber assembly (500) of the disclosure includes a stabilizing support to stabilize the basket and material mass positioned within the container (902) during operation. As shown in FIGS. 30-33, at least one ring bearing assembly (508) is positioned around the internal portion of the mixing chamber (501). The ring bearing assembly (508) includes a ring support (571) rigidly secured to the internal circumference of the mixing chamber (501) and further securing an upper chamber bearing support (564) and lower chamber bearing support (566) which are in turn secured to the ring support (571). A series of roller bearings (568) are secured between the chamber bearing supports (564, 566) and positioned to be rotatably responsive to the external surface of the bucket (572). In this configuration, the rotation of the container (902) secured to the bucket (572) is supported and stabilized by the ring bearing assembly (508). Notably, while the preferred embodiment in the Figures shows a single ring bearing assembly (508), alternative embodiments can include a plurality of ring bearing assemblies (508) secured to the internal circumference of the mixing chamber (501). In one embodiment, each roller bearing (568) can further be supported within the ring support (571) by one or more roller brackets (782).

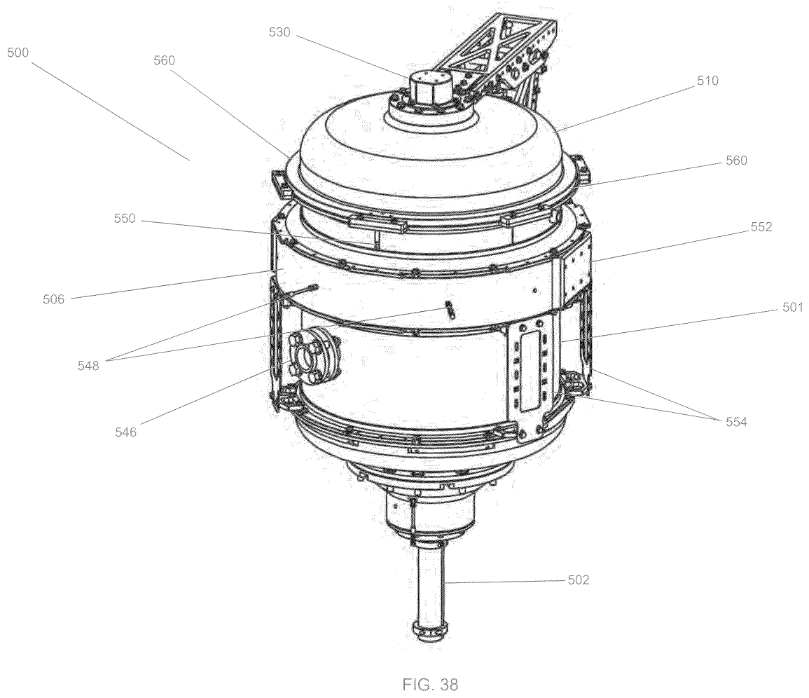

One or more bearing sensors (548) can be positioned adjacent to the ring bearing assembly (508). As shown in FIG. 38, a chamber bearing housing (506), securing a plurality of bearing sensor (548) is secured to the external surface of the mixing chamber (501) such that the sensors (548) can measure the temperature or mechanical vibration of the ring bearing assembly (508). In this embodiment, each bearing sensor (548) can transmit a signal, preferably to a controller (801) which can include programable machine executable instructions that can modulate or stop the operation of the mixing assembly (100) if the temperature or vibration detected by one of the sensors (548) exceeds a pre-determined threshold for operation of the ring bearing assembly (508). The dual-axis centrifugal mixing assembly (100) includes a container assembly, also referred to herein as a container (902) configured to hold the material to be mixed and be positioned within the mixing chamber (501). In a preferred embodiment, a liner (904) is configured to be secured within the internal portion of the container (902) and provide a barrier between the material and the container surface. In this configuration, a quantity of a material to be mixed can be loaded into the liner (904) and further secured within the container (902). After being mixed, the liner containing the mixed material can be removed from container (902) for storage, use, or further processing while a new liner can be immediately reloaded into the container (902).

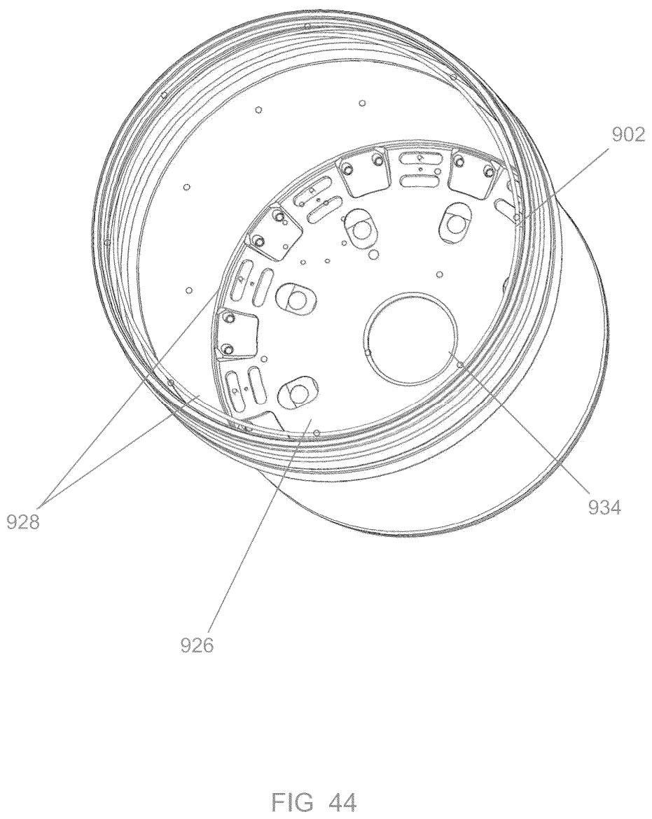

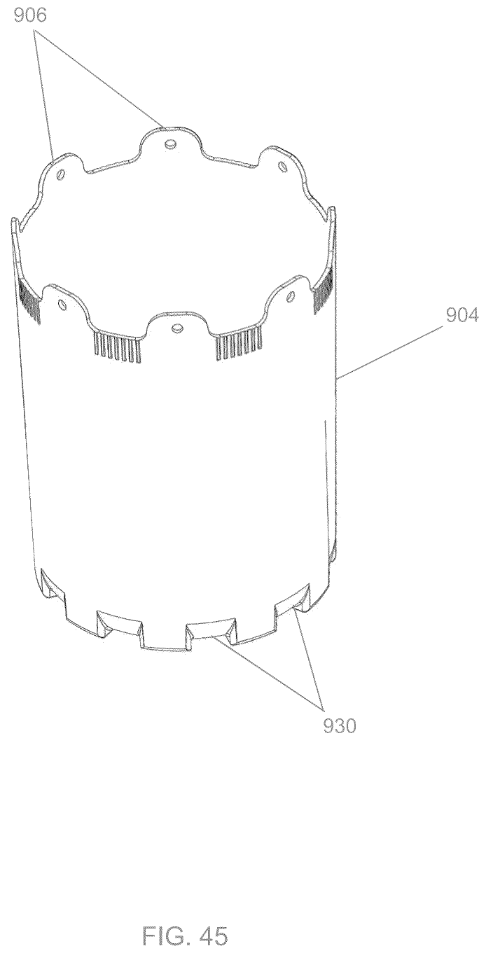

The end portion of the liner (904) can be secured to the internal surface of the container (902) so that it does not rotate independently of the container (902) during operation of the mixer assembly (100) of the disclosure. In the preferred embodiment shown in FIGS. 44-45, the liner (904) includes a series of channel (930) positions on its end portion. A corresponding series of extensions (928) are positioned on a base plate (926) which is further secured to the bottom the internal cavity of the container (902). In this configuration, when the liner is inserted into the container (902) the channel (930) positions on the liner (904) are mated with their corresponding extensions (928) thereby providing a coupling between the liner (904) and container (902).

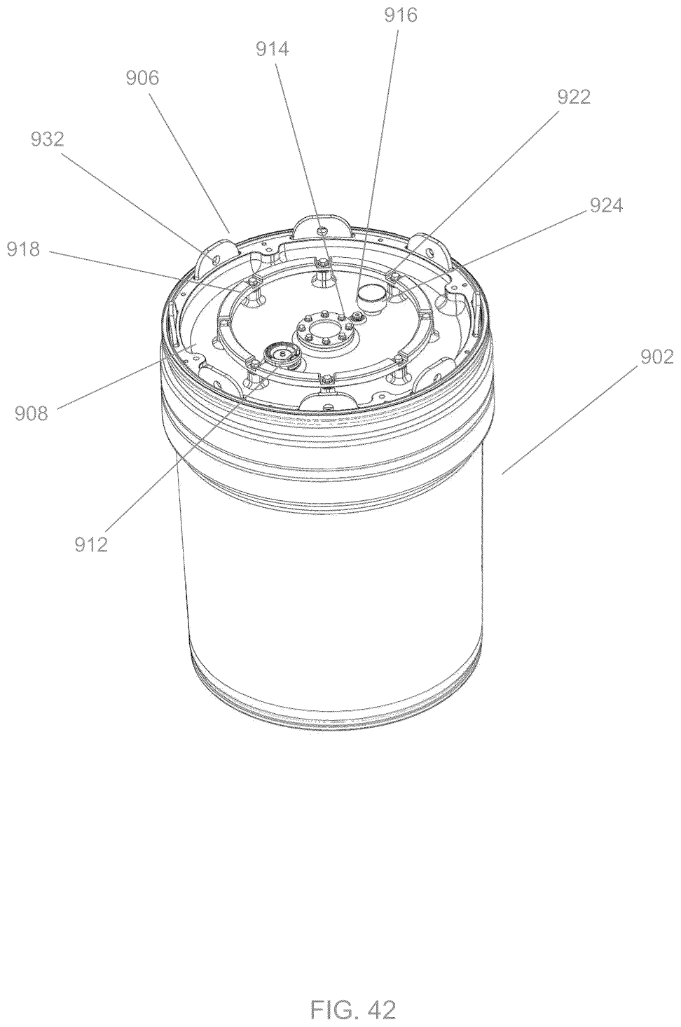

A lid (908) is securable to the top portion of the container (902). As shown in FIG. 42, the lid (908) includes a series of slots (932) located along its outer perimeter configured to receive a corresponding tab (906) positioned on the top surface of the liner (904). In this configuration, the tabs (906) also form a coupling with the container to prevent independent rotation of the liner (904) within the container (902), as well as providing grip positions to assist in the insertion and removal of the liner (904) from the internal portion of the container (902). The lid (908) further includes a handle (918) secured to the top external surface to aid in the insertion and removal of the lid during operation. A seal (934), such as an O-ring can further be positioned between the lid (908) and container (902).

In the preferred embodiment shown in FIG. 42, the lid (908) houses an equalization valve (912) in communication with the internal portion of the container (902) and mixing chamber (501) to allow pressure equalization between the same. The lid (908) of the disclosure further includes a lens, and preferably IR transparent lens (914) positioned within a lens housing (916). As noted above, when the gondola lid (510) is moved to the closed position, a thermal imager (532) positioned within the thermal imager housing (530) of the gondola lid (510) is positioned over the IR transparent lens (914) allowing for a real-time temperature measurement and visualization of the material being mixed within the container (902). The lid (908) further secures a vacuum gauge (922) to measure pressure within the container, as well as an accessory plug (924).

The container (902) can be configured to be secured to the basket (572) positioned within the static mixing chamber (501) such that container (902) does not rotate independently from the basket (572). In one preferred embodiment, the bottom portion of the container (902) includes a catch assembly (910) configured to be mated with a locking clutch (776) positioned on the basket (572). In certain embodiments, a skid plate (920) is positioned over the catch assembly (910) securing it to the container (902).

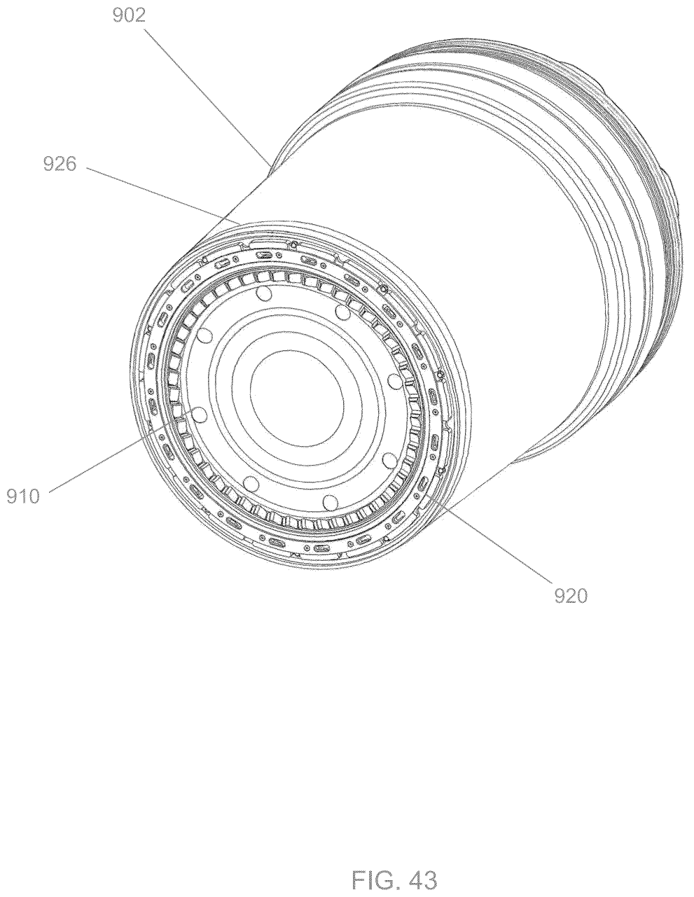

As shown in the preferred embodiment of FIG. 43, the catch assembly (910) includes a series of extended teeth configured to be secured with corresponding cross pins (780) of the locking clutch (776) on the basket (572). In this configuration, rotational movement of the basket (572) causes the catch assembly (910) of the container (902) to be laterally coupled with the cross pin (780) of the locking clutch (776) such that such that their respective rotational movements are synchronized. Once rotation of the basket (572) stops, the coupling between the catch assembly (910) and locking clutch (776) generated by the rotational force of the basket (572) is disengaged and the container (902) can be removed from the basket (572).

In alternative embodiments, a catch assembly (910) and locking clutch (776) can be positioned on the sides of the container (902) and basket (572) respectively. In still further embodiments, a clutch cover (778) can be positioned over the locking clutch (776). In still further embodiments, one or more locks or coupler can be used to automatically or manually secure the container (902) and basket (572) such that their rotation is synchronized in this locked configuration.

One or more inserts (574) can be positioned between the inner surface of the basket (574) and the container (902) preventing unwanted movement of the container (902) within the basket (572), and to help guide insertion of the container (902) such that the locking clutch (776) and catch assembly (910) of the container (902) are aligned during the loading phase.

The dual-axis centrifugal mixing assembly (100) of the disclosure is configured to mix materials well beyond the rage of known centrifugal-based mixing devices. For example, traditional dual-axis centrifugal-based mixing devices cannot mix more than 20 kg of material, and only when the material is split into two separate 10 kg mixing containers. However, the current dual-axis centrifugal mixing assembly (100), in some embodiments, can be configured to mix up to at least 175 kg or more of material per container (902), or approximately 350 kg or more per operation. In another example, each container (902) of the assembly can mix approximately at least 125 liters or more of flowable liquid material per container, which would equate to approximately between 250 liters or more of flowable liquid material per operational run.

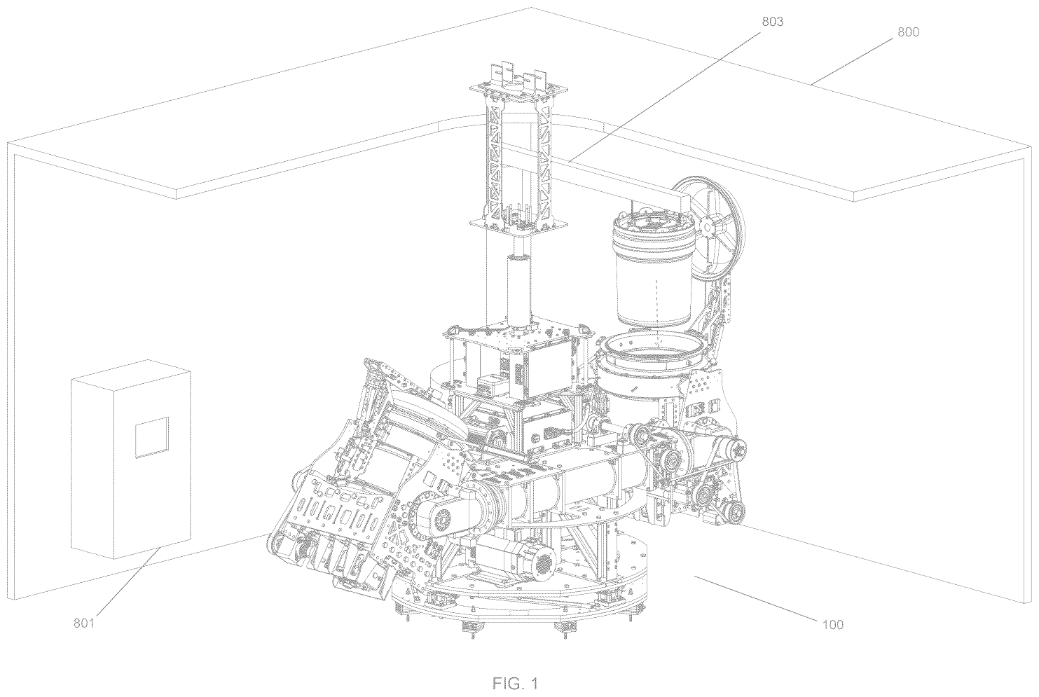

As noted above, the dual-axis centrifugal mixing assembly (100) can be secured to one or more static surfaces. For example, the pedestal assembly (102) can be secured to the floor or other secured platform, while the rigid mount (320) of the control scaffold (302) can be secured to a rigid support, such as a crossbeam, or ceiling support, or preferably a reinforced enclosure (800). As shown in FIG. 1, one or more dual-axis centrifugal mixing assemblies (100) can be positioned inside an enclosure (800) that can protect users while the assembly is operating at high speeds, while also allowing for the remote placement of a system controller (801) inside or outside the enclosure allowing an operator to safely monitor the control operation of the assembly in real-time.

In additional embodiments, the enclosure (800) can include loading and unloading scaffolding (803), such as winches and pullies, as well as automated robotic lifting devices which can be configured to automatically or manually mechanically lift and transport containers (902) containing a material to be mixed, and to further load and unload those containers (902) into and out of the mixing chamber (501).

For each of the user interface screens or displays disclosed herein, data or values may appear in one or more of the fields of each display. The data or values should be understood to be exemplary data or values only and should not be interpreted as limiting the invention with respect to any numerical values, ranges, magnitudes or other values that might be shown with the fields of the displays. Further, some of the fields may be described however these fields may not have corresponding exemplary data or values shown in the corresponding figure. The presence or absence of exemplary data or values in such fields again should not be interpreted as limiting the invention for any sample data or values that may or may not appear in these fields.

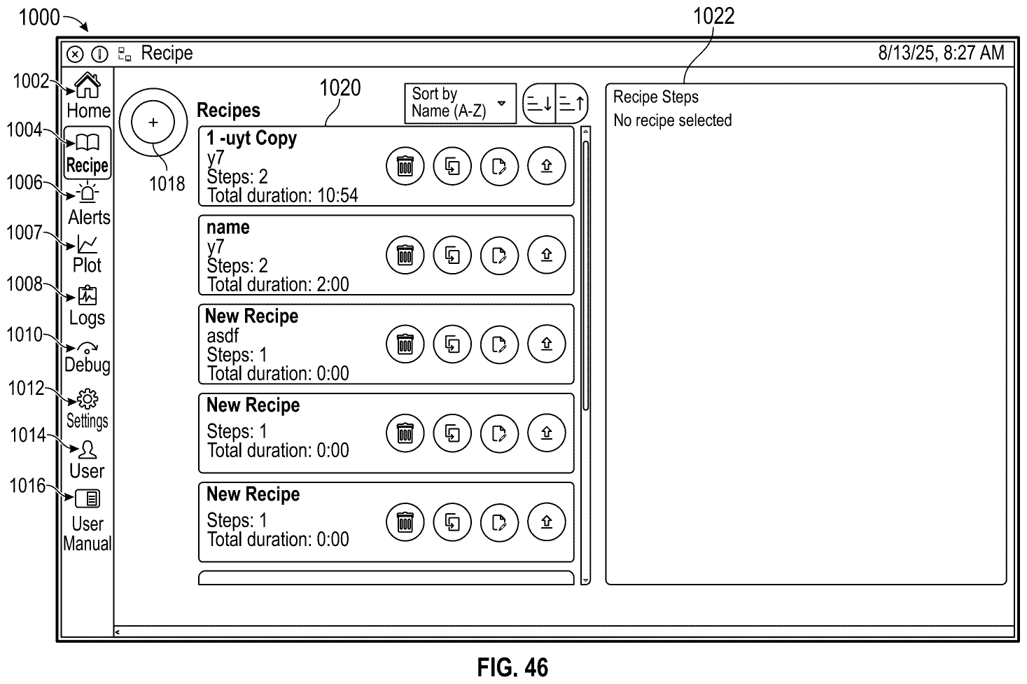

FIG. 46 shows a user interface screen or display that allows an operator to modify and control the dual-axis centrifugal mixing assembly and methods of the invention. More specifically, this figure shows that a number of recipes may be executed, new recipes can be created, and recipes can be modified as desired. The user interface screen or display is generally identified as display 1000. On the left edge or side of the display are a number of functional features of the software of the invention. These features include a home button or icon 1002, a recipe button or icon 1004, an alerts button or icon 106, a plot button or icon 1007, a debug button or icon 1010, a settings button or icon 1012, a user button or icon 1014, and a user manual button or icon 1016. Some of these buttons or icons are described in further detail below with respect to the corresponding additional user displays and explanations thereof. This figure further illustrates a number of recipes 1020, such as when the user has selected the recipe button 1004. Each recipe is illustrated with its own field display with features in each field display to view, edit, delete or upload the recipe to a database of stored recipes. The term “recipe” as used herein means a programmed group of instructions that are used to execute a specific mixing method as it is imported, created and/or modified and subsequently saved by a user. These instructions include how each of the components of the system operate during a mixing cycle to achieve a desired final mix.

The home button 1002 allows the user to return to the main page or starting screen of the software. The alerts button 1006 allows the user to view any system alerts that may be present, such as any component malfunctions or out of range conditions. The alerts button may also be used to display any other conditions in a mixing cycle that may cause an improper mixing sequence to occur or an improper mixing sequence that may have been conducted as compared to pre-existing standards with respect to what the mixing cycle should have achieved. The plot button 1007 allows a user to view plotted data as it corresponds to an executed mixing cycle or a mixing cycle that is in progress. The debug button 1010 allows a user to view a user screen which enables the user to debug or correct a detected error with respect to a mixing cycle or the malfunction of one or more of the components of the system. The settings button 1012 allows the user to view a user interface that allows the user to customize preferences, options, and/or configurations for the software application or system being controlled by the software application. The user button 1014 allows the user to access a user interface enabling the user to set preferences with respect to how the user interfaces may be displayed and the respective authorization levels for individuals who have access to the software application for executing mixing cycles. A new recipe button or icon 1018 if selected, allows the user to create a new recipe. The recipe display field 1022 allows the user to view details of a selected recipe and further allows the user to modify the selected recipe.

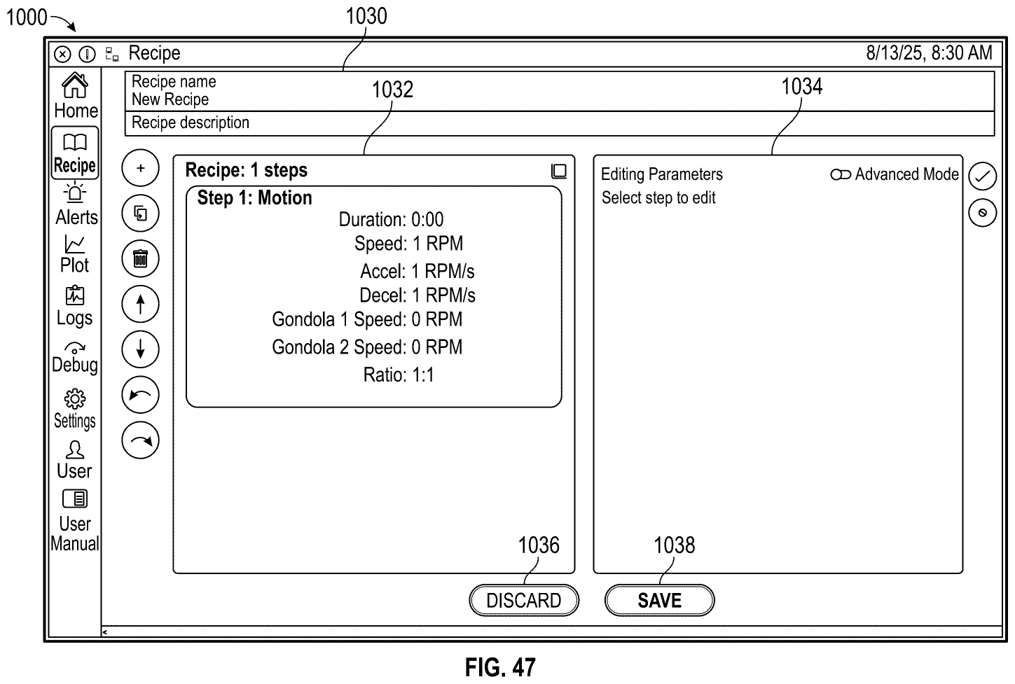

FIG. 47 shows another user interface screen or display that allows the operator to view and modify a selected recipe, as well as showing a step in a recipe that has been created. A recipe name or description of the recipe appears in field 1030 as selected by the user. A recipe field 1032 shows a particular step of the selected recipe as well as a description of the step with respect to duration, speed, acceleration, the acceleration, gondola speeds, and ratios. Field 1034 shows that a user can edit various parameters or aspects of the displayed step. For example, the user can edit the parameters/aspects of the recipe and then can choose to either discard the edits by selecting this discard button 1036, or the user can save the edits by selecting save button 1038. Alternatively, the user may discard or delete the entire step and enter and save a new step for the selected recipe.

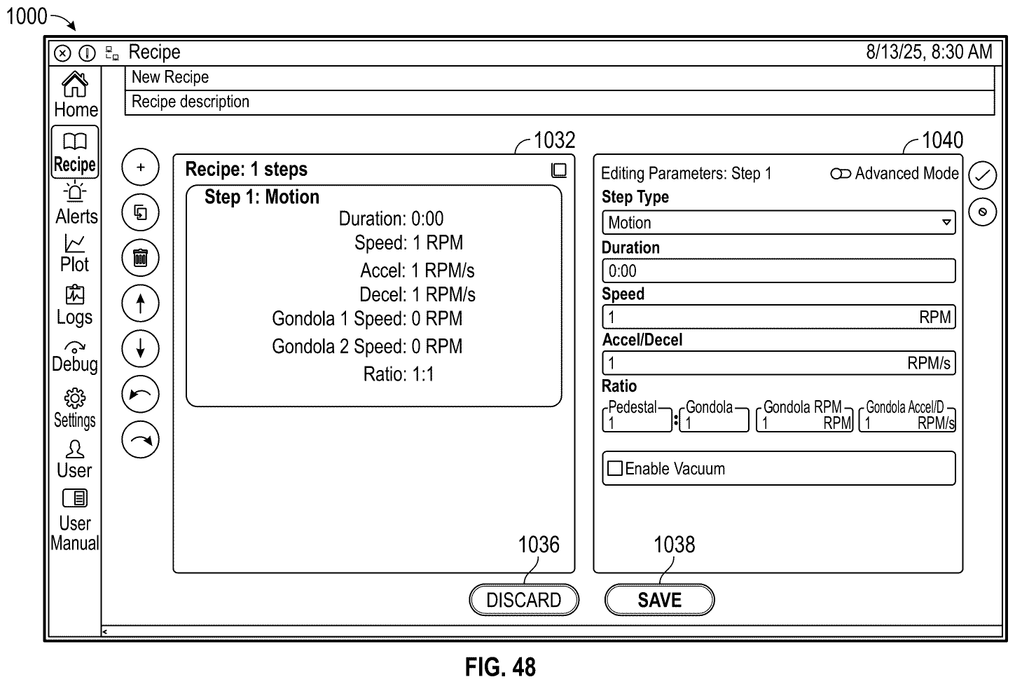

FIG. 48 provides another user interface screen or display that shows basic parameters of a recipe that can be modified, noting that this user interface is not exhaustive of all parameters that can be modified. In this display, an editing parameters option 1040 has been selected that allows the user to modify the listed parameters, shown in this example as the step type, duration, speed, acceleration/deacceleration, and rotational ratios of the listed system components.

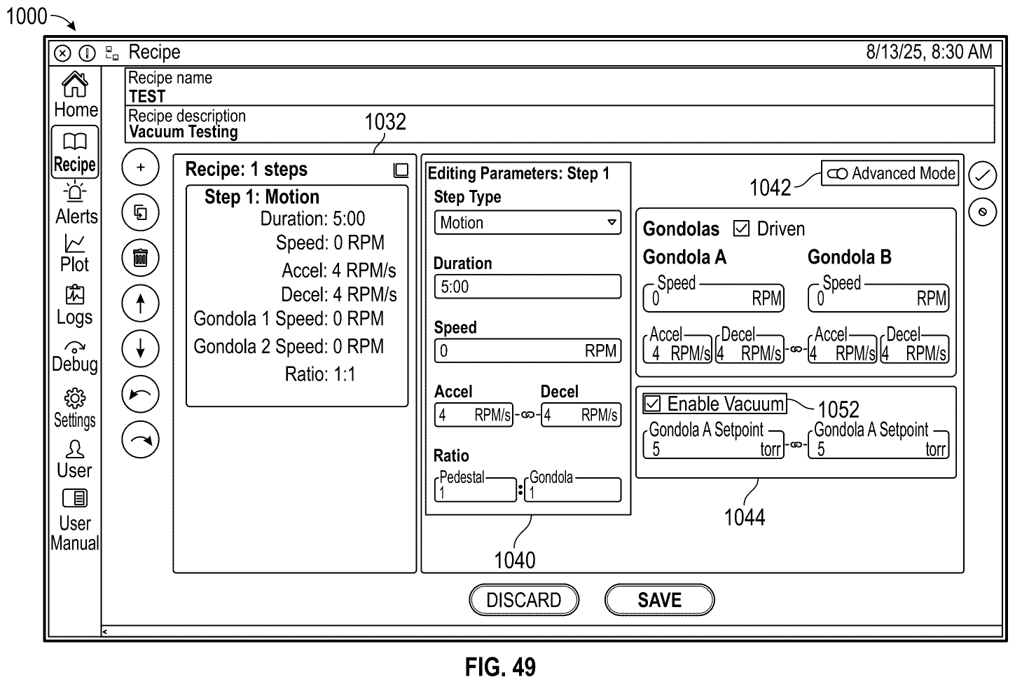

FIG. 49 shows another user interface screen or display with parameters that can be modified along with further advanced settings that can be modified to provide yet further control of an executed recipe. In the example shown, the advanced mode button 1042 is selected that allows the user to view editable parameters with respect to the gondolas A and B. More specifically, the user is able to edit the rotational speed of the gondolas as well as acceleration and deacceleration parameters of the gondolas. This figure also shows a vacuum function 1044 that the user can adjust. To execute a mix cycle wherein the containers are placed under a vacuum, the vacuum checkbox 1052 must be selected, and a pressure must be specified. Vacuum pressure is commanded and measured in absolute vacuum. More specifically, the user can enable or disable the vacuum function and can set vacuum levels (in Torr units of measure) for the containers.

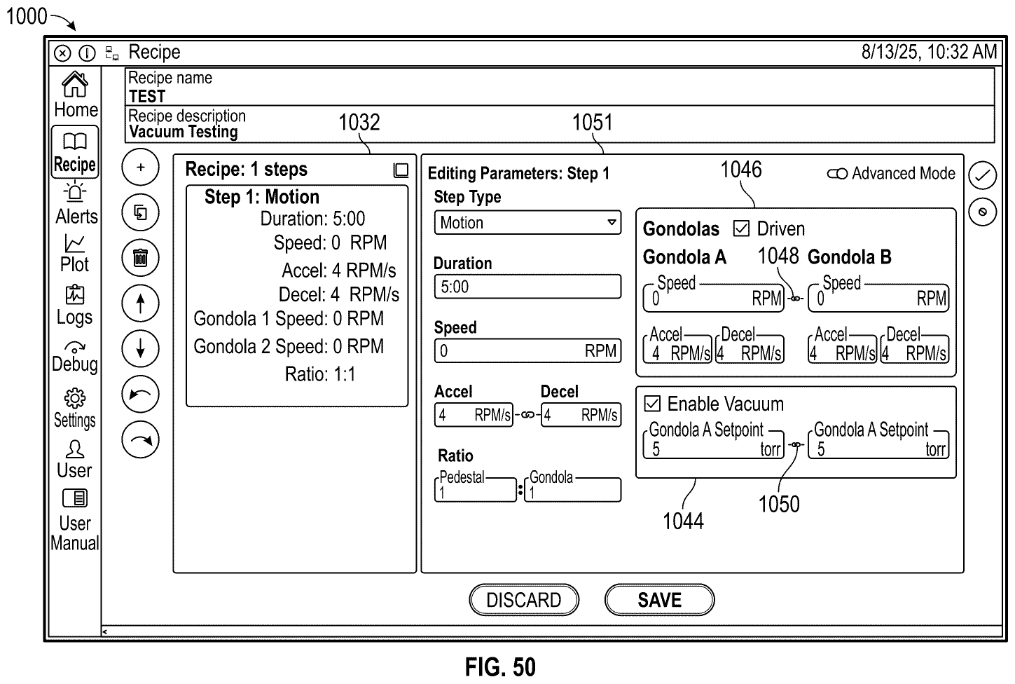

FIG. 50 shows another user interface screen or display, specifically pointing out the controllable links, namely, the pedestal to gondola link 1046, the gondola speed link 1048, and the gondola vacuum link 1050. For independent control of each motor that drives the gondolas, the user must first click the gondola link button 1046 to “unlink” the gondolas. A checkmark appearing in the driven link box indicates the gondolas are linked and therefore will have the same speeds, accelerations and deaccelerations. When linked, the gondolas will have their speed and acceleration values linked to those of the pedestal corresponding to the ratio prescribed in the corresponding recipe. The other link buttons are used to enable independent gondola control. More specifically, for independent speed and acceleration control of the gondolas, the user must click on the gondola speed link 1048 button to deactivate the link - for example, a highlighted state for this button could indicate an active link while a lighter shaded button could indicate a deactivated link.

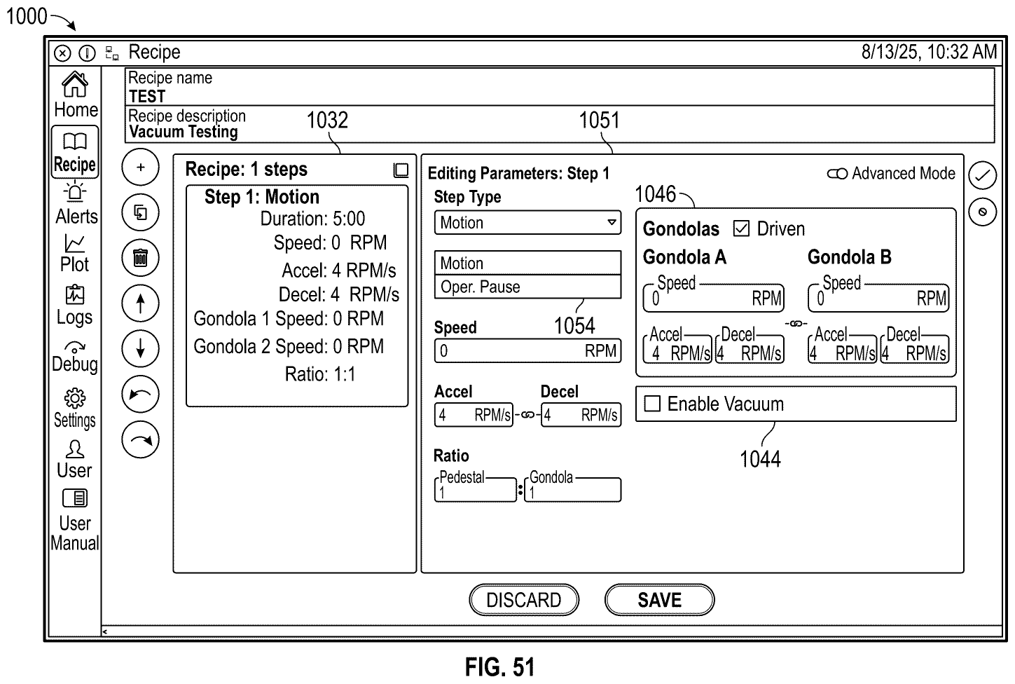

FIG. 51 shows another user interface screen or display, specifically pointing out a pause function 1054 that allows a user to set a pause for a mixing cycle. Within the “step type” area of the field 1051, the user can click on the displayed motion option resulting in a drop-down display of an operation pause. The selection of the pause function 1054 allows the addition of a pause in the cycle in which the mixing assembly will slow and stop to a home position.

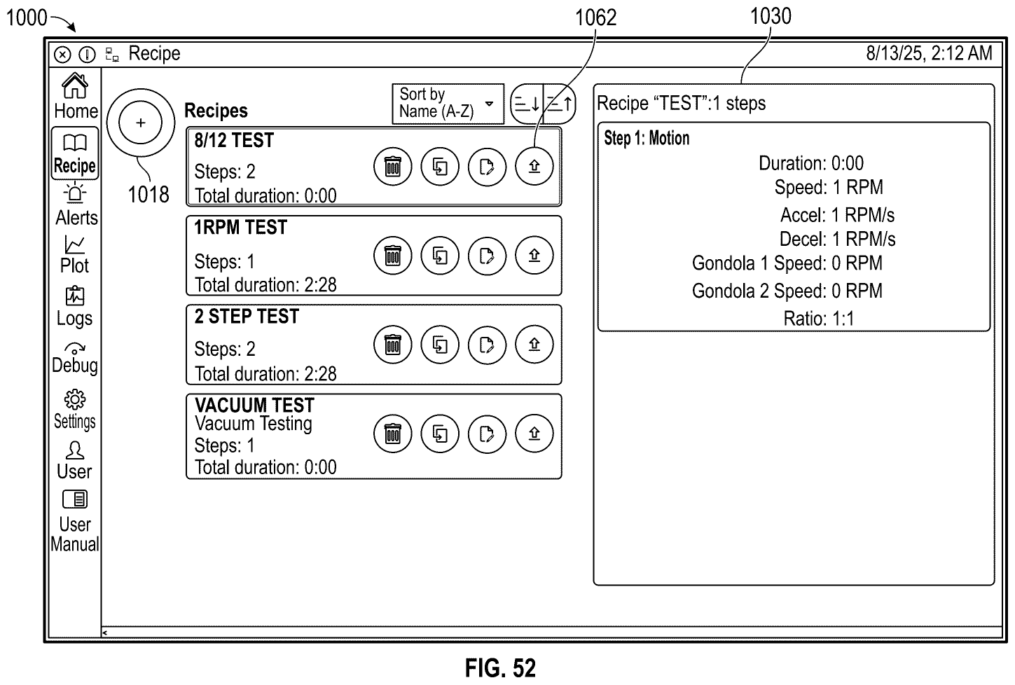

FIG. 52 shows another user interface screen or display for a selected recipe to be executed and specifically pointing out an upload button 1062. To start execution of a recipe, the upload button 1062 on the main recipe page must be clicked.

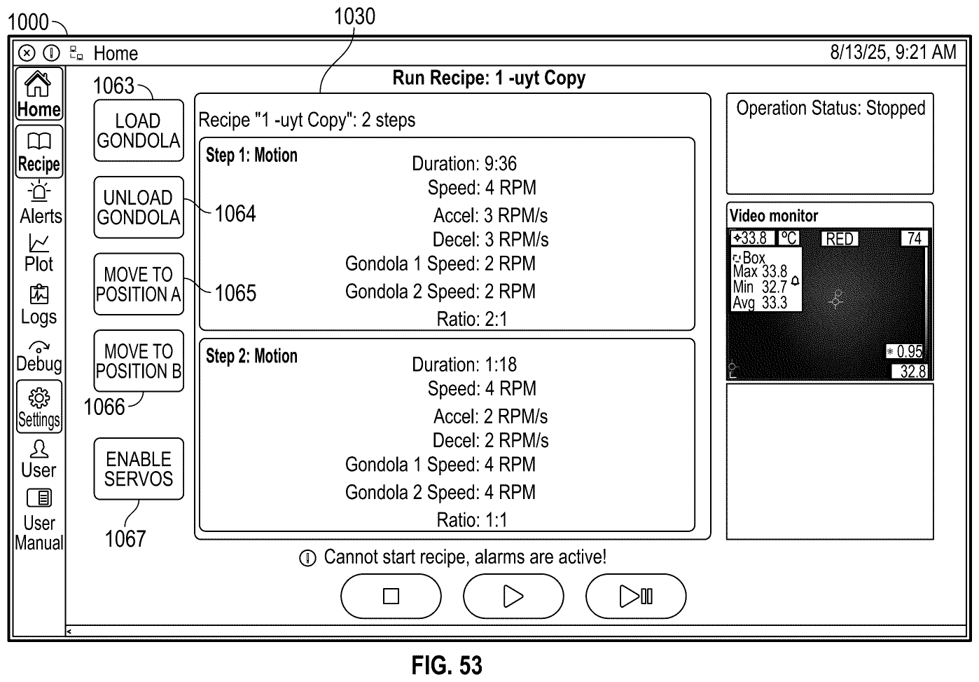

FIG. 53 shows another user interface screen or display enabling a user to view the selected recipe to be executed and to start a recipe mixing cycle. This display shows the main screen for a recipe to be executed and provides the user information to verify the recipe that is ready to run. In order to start a recipe both gondolas must be fully loaded, and all errors/alerts must be cleared. Before the mixing assembly will operate, the servos must be enabled by clicking on the enable servos button 1067. Other features are shown in this display to include the load gondola button 1063, the unload gondola button 1064, the “move to position A” button 1065, and the “move to position B” button 1066. The button 1063, when selected, causes the lid to close on a selected container and causes the corresponding gondola to tilt to a desired angle once material is loaded in the container; therefore, placing the container in a condition for operational rotation/spinning. Conversely, the button 1064, when selected, causes a gondola to return to a vertical position and the lid of the container to open therefore allowing material to be removed from the container after a mix cycle is completed. The buttons 1065 and 1066 are homing buttons. If selected, these buttons cause components in the system to move or return to two different prescribed positions, such as enabling loading or unloading of containers. FIG. 53 also shows a message near the bottom of the user display near the navigation buttons. The message is an example of an alarm or alert: “Cannot start recipe, alarms are active!”. This message therefore prompts the user to conduct troubleshooting of the system to clear any active alarms. This can be done by accessing the alerts function as explained with respect to FIG. 46.

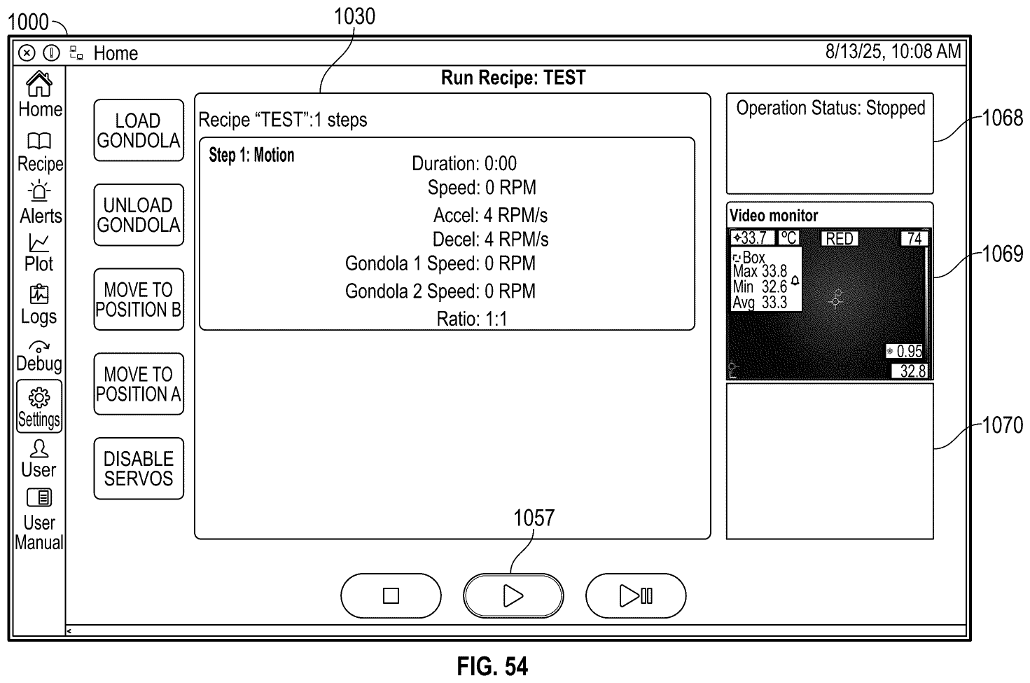

FIG. 54 shows another user interface screen or display in which a recipe is uploaded, no errors are noted in the system, and the user can select the start button 1057 to run the selected recipe. Also shown in this screen is a field for the status of the operation 1068 which can display whether the recipe is being executed at that time and what step or phase of the recipe is being executed. A video monitor field 169 is shown which provides live video of the operation of the system or selected system components. The video monitor can provide visual or infrared images. Infrared images may be used to monitor heat signatures of the system to provide early detection of an overheated system component. An error field 1070 is also displayed which will display any current system errors that are detected, and whether the error(s) are causing the current mixing cycle from being conducted or completed.

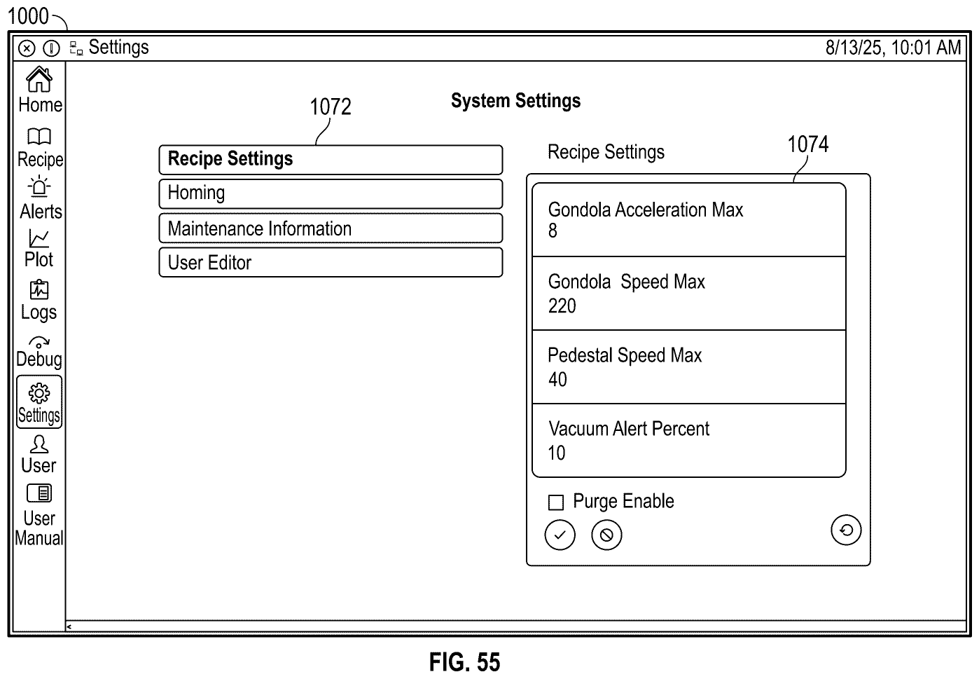

FIG. 55 shows another user interface screen or display in which recipe settings 1072 can be selected which includes ranges of setting selections, maximum values, and default values. For example, if a user is logged in as a supervisor, the displayed settings menu can be accessed at any point. This settings menu allows the user to adjust a few higher-level settings of the system. This figure also shows a recipe settings field 1074 being displayed. This particular field 1074 shows maximum values for a few system components, namely, gondola acceleration, gondola speed, pedestal speed, and vacuum percentage. This field 1074 also shows a button to enable a purge of the system which is a function that allows for air or an inert gas to flow into the gondolas during mixing while a vacuum is enabled to pull air/gas out of the chamber of a container. The main purpose of the purge function is to remove oxygen or other gasses that are outgassed from the chamber during a mixing cycle.

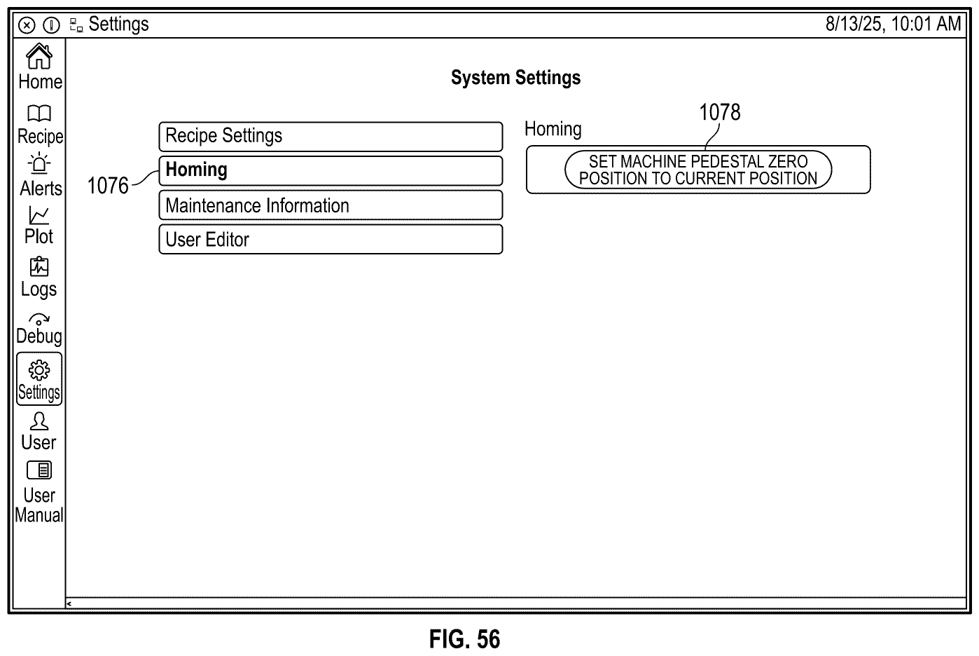

FIG. 56 shows another user interface screen or display illustrating a homing function button 1076. If the button 1076 is selected, a homing field 1078 is populated. The homing function can be used for “zeroing” the system meaning system settings are returned to preselected home positions that are used as references for all other positions. The homing field 1078 provides a description of what constitutes the selected homing positions. The specific example illustrated in the display calls for setting the “machine pedestal zero position to current position.” The homing function can be used to create initial settings for components of the system to be controlled in a new recipe, such as initial settings for the operation of the pedestal or gondolas.

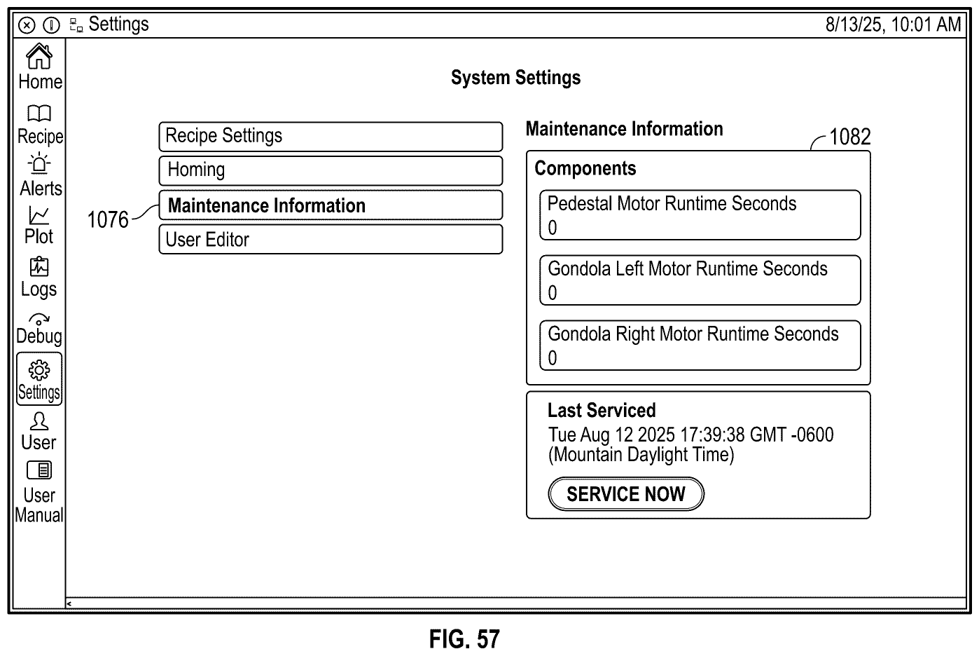

FIG. 57 shows another user interface screen or display relating to system settings, and more particularly, to maintenance information on system components. The maintenance information button 1076, if selected, populates a maintenance information field 1082. The example data in this figure shows runtimes for system components and information regarding when a component or the system as a whole underwent a previous service. Runtimes for components can be used to set maintenance intervals, much in the same way as miles are used to set maintenance intervals for vehicles.

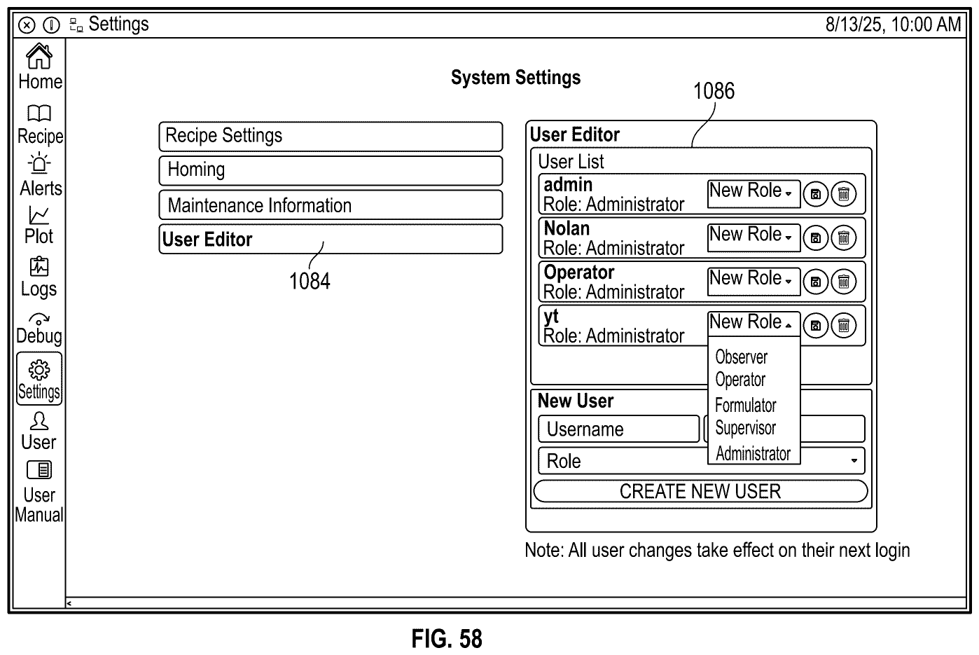

FIG. 58 shows another user interface screen or display relating to different types of users that may be selected to run the system, along with their respective authorities to modify recipes and conduct other functions on the system. More specifically, this figure shows a user editor button 1084 that if selected, populates a user editor field 1086. Typically, a user that has supervisor or administrator credentials is able to access the editor field 1086 while other types of users are restricted from changing user levels or authorizations. The field 1086 provides examples of the types of users that may be associated with the system along with functionality for adding new users, changing current role classifications of users and deleting users.

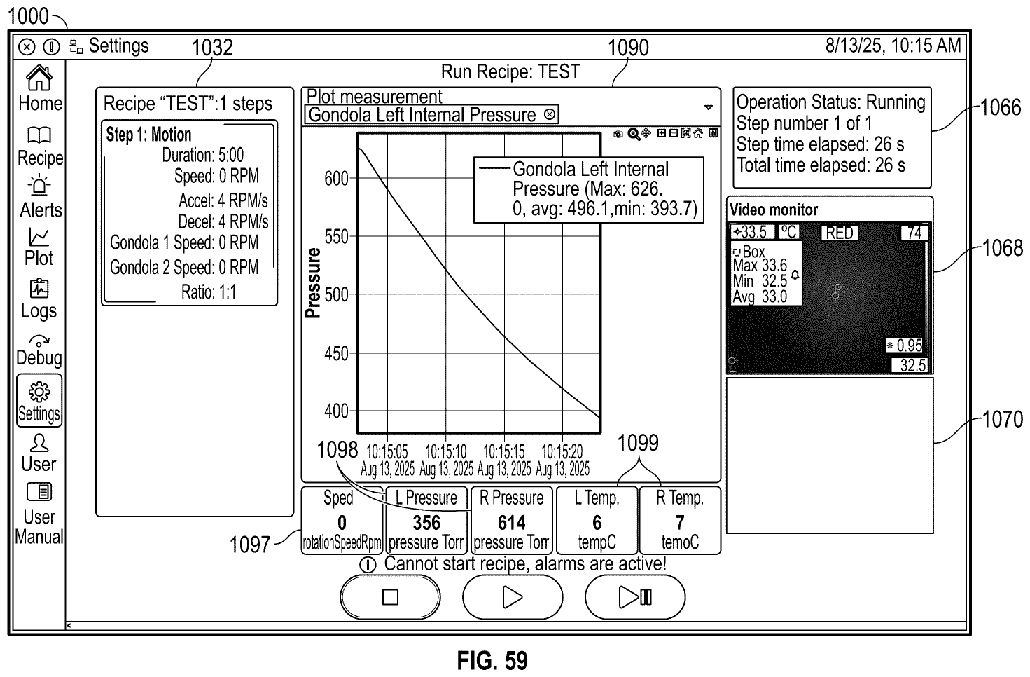

FIG. 59 shows another user interface screen or display that enables a user to monitor an active program or mixing cycle. The system includes various sensors installed on the system components and these sensors provides real-time data that is used for monitoring. This display also shows the currently executed mixing step/recipe and thermal camera statuses. The currently running recipe is shown in the recipe field 1032. The executed mixing step/recipe is shown in a real-time graphical format in which selected operational parameters can be viewed within field 1090. As shown in the example of this figure, these parameters may include internal gondola pressures plotted against time. In addition to the field 1090, other real-time data may be displayed such as rotational speed 1097, gondola pressures 1098 and gondola temperatures 1099.

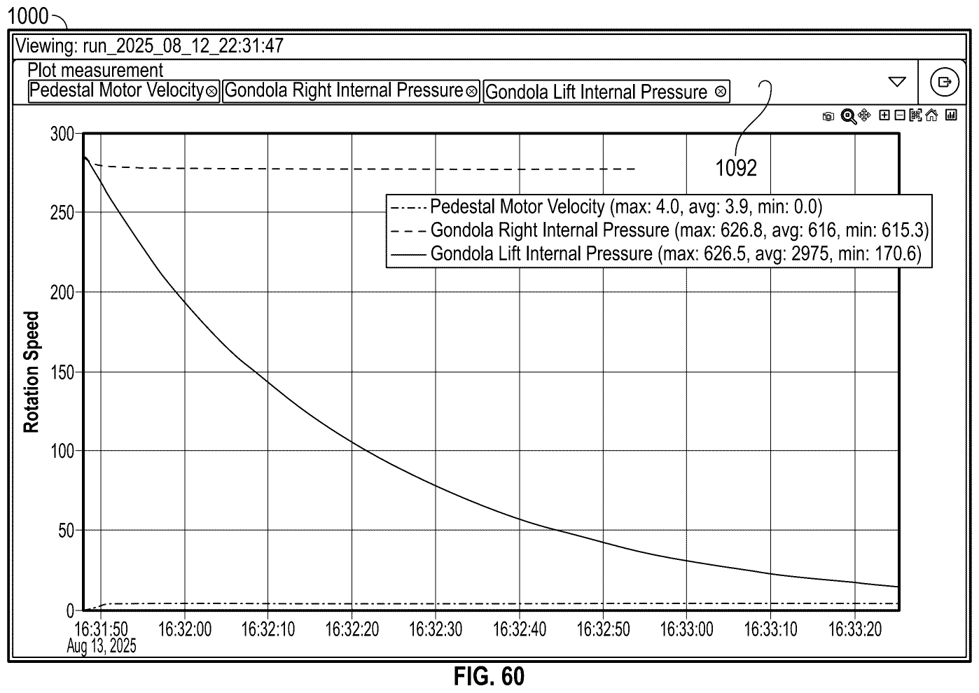

FIG. 60 shows another user interface screen or display in which the user has selected to change the scale of a graph. The display 1092 in this figure shows an example in which rotational speed is plotted against time. Additional data is shown as being inset within the graphical display, namely, pedestal motor velocity, gondola right internal pressure and gondola left internal pressure. One can appreciate that the enlarged size of the graphical data may assist a user in better visualizing the status of a mix cycle.

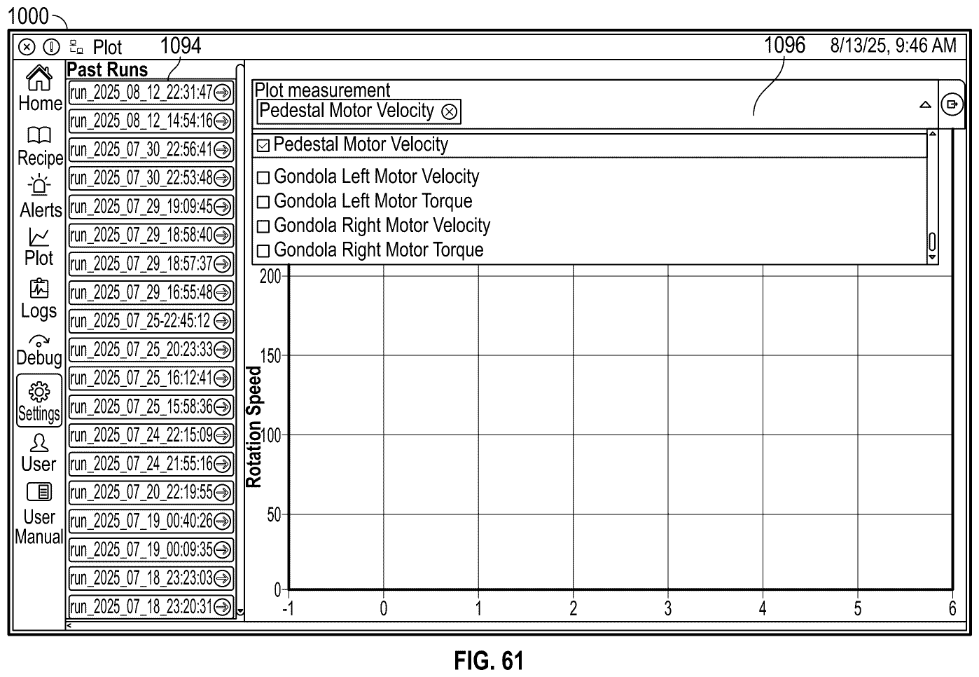

FIG. 61 shows another user interface screen or display in which field 1094 provides a user with a chronological listing of stored mixing recipes to include previously executed recipes. This user interface also shows that a user can additionally select and view recorded parameters from a recipe as recorded by system sensors. The system sensors to be viewed is shown in field 1096 and in the example of this figure, the sensors include those that monitor pedestal motor velocity, gondola left motor velocity and torque, and gondola right motor velocity and torque. Other sensors may be listed and selected by the users in the field 1096.

Considering the user interfaces or displays disclosed herein, it is apparent that a user may create and revise or edit recipes for mixing that have many variables or parameters to achieve a desired mixing cycle. The variables or parameters can be defined within the operational capacities or abilities of the system components. As disclosed, these operational variables include durations of operations, rotational speeds, accelerations and deaccelerations, vacuum levels, and allowable operating temperatures. Further, the user can choose to operate system components in tandem or separately from one another. For example, the gondolas may be separately operated in terms of differences between respective rotational speeds and accelerations. Accordingly, a user may independently and selectively choose mixing cycle recipes that each have unique characteristics in terms of any variable or parameter that is capable of being controlled. With respect to control of the system by, for example, a PLC, discrete and independent control of each component is possible with input and output signals incorporated within a PLC logic program. In addition to the enhanced mixing cycle control capabilities of the invention, user interfaces or displays are provided that enable a user to view the real time operation of the system via numerous monitored system component conditions that are displayed to the user. Additionally, monitored conditions can be provided in a graphical format as well as in the form of readings from each of the system components. These readings can include parameters such as rotational speeds, pressures, accelerations/deaccelerations, and temperatures.

Any of the computing related systems and components described herein, such as the controller (801), pneumatic controller (308), or motor drive(s) (304) and communication modules connecting the same, whether controlled by end users directly or by a remote entity controlling one or more components of said system of the invention, can be implemented as software components executing on one or more general purpose processors or specially designed processors such as programmable logic devices (e.g., Field Programmable Gate Arrays (FPGAs)) and/or Application Specific Integrated Circuits (ASICs) designed to perform certain functions or a combination thereof. In some embodiments, code executed during operation of the systems of the invention (computational elements) can be embodied by a form of software elements which can be stored in a nonvolatile storage medium (such as optical disk, flash storage device, mobile hard disk, cloud-based systems etc.), including a number of instructions for making a computer device (such as personal computers, servers, network equipment, etc.). Algorithms, machine learning models and/or other computational structures described herein may be implemented on a single device or distributed across multiple devices. The functions of the computational elements may be merged into one another or further split into multiple sub-modules. The user interfaces or screenshots as described herein can be generated by the software components, it being understood that the software components can reside in one or more software programs integrated with the invention described herein.

Any hardware devices of the invention can be any kind of device that can be programmed including, for example, any kind of computer including smart mobile devices (watches, phones, tablets, and the like), personal computers, powerful servers or supercomputers, or the like. The device includes one or more processors such as an ASIC or any combination processors, for example, one general purpose processor and two FPGAs. The device may be implemented as a combination of hardware and software, such as an ASIC and an FPGA, or at least one microprocessor and at least one memory with software modules located therein. In various embodiments, the system includes at least one hardware component and/or at least one software component. The embodiments described herein could be implemented in pure hardware or partly in hardware and partly in software. In some cases, the disclosed embodiments may be implemented on different hardware devices, for example using a plurality of CPUs equipped with GPUs capable of accelerating and/or coordinating computation. Each computational element may be implemented as an organized collection of computer data and instructions. System software typically interfaces with computer hardware, typically implemented as one or more processors (e.g., CPUs or ASICs as mentioned) and associated memory. In certain embodiments, the system software includes operating system software and/or firmware, as well as any middleware and drivers installed in the system. The system software provides basic non-task-specific functions of the computer. In contrast, the modules and other application software are used to accomplish specific tasks. Each native instruction for a module is stored in a memory device and is represented by a numeric value.

At one level a computational element is implemented as a set of commands prepared by the programmer/developer. However, the module software that can be executed by the computer hardware is executable code committed to memory using “machine codes” selected from the specific machine language instruction set, or “native instructions,” designed into the hardware processor. The machine language instruction set, or native instruction set, is known to, and essentially built into, the hardware processor(s). This is the “language” by which the system and application software communicates with the hardware processors. Each native instruction is a discrete code that is recognized by the processing architecture and that can specify particular registers for arithmetic, addressing, or control functions; particular memory locations or offsets; and particular addressing modes used to interpret operands. More complex operations are built up by combining these simple native instructions, which are executed sequentially, or as otherwise directed by control flow instructions.

The inter-relationship between the executable software instructions and the hardware processor may be structural. In other words, the instructions per se may include a series of symbols or numeric values. They do not intrinsically convey any information. It is the processor, which by design was preconfigured to interpret the symbols/numeric values, which imparts meaning to the instructions.

Any of the computing systems described herein, such as the controller (801), pneumatic controller (308), or motor drive(s) (304) and communication modules connecting the same, can include a “processor,” “processor system,” or “processing system” which includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, etc. Furthermore, the results may be stored “permanently,” “semi-permanently,” temporarily, or for some period of time. For example, the memory may be random access memory (RAM), and the results may not necessarily persist indefinitely in the memory.

Notably, there are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be affected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically oriented hardware, software, and/or firmware.

In some embodiment described herein, logic and similar implementations may include software or other control structures. Electronic circuitry, for example, may have one or more paths of electrical current constructed and arranged to implement various functions as described herein. In some implementations, one or more mediums may be configured to bear a device-detectable implementation when such media hold or transmit device-detectable instructions operable to perform as described herein, and preferrable transmitted to a mobile device as an audio signal, and even more preferably an inaudible audio signal. In some variants, for example, implementations may include an update or modification of existing software or firmware, or of gate arrays or programmable hardware, such as by performing a reception of or a transmission of one or more instructions in relation to one or more operations described herein. Alternatively, or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively, or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences.

In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High-Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission devices or computational elements, material supplies, actuators, or other structures in light of these teachings.

The foregoing detailed description has set forth various embodiments of the devices and/or processes via the use of block diagrams, flowcharts, and/or examples. In so far as block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc. ; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

According to one embodiment of the invention, the programmed instructions for a mixing cycle may be achieved on a programmable logic controller (PLC) wherein the instructions are executed by the connected field components through a continuous operational loop such as a scan cycle. The scan cycle involves reading input signals from the field components, executing a user program of the programmed logic instructions, and updating the output devices of the field components based on programmed logic. With respect to the PLC scan cycle, a central processing unit (CPU) of a controller records status data of all connected input devices, such as sensors and switches. The data for all inputs, both digital and analog, is stored in an internal memory table of the controller. The CPU executes the user's program, solving programmed logic using the input data stored in the memory table. The program determines necessary responses based on the input data received. For example, if the programming logic requires a servo motor to change speed or to be turned on or off based on input data received, the PLC will confirm the required state of the servo motor from input logic and will therefore determine whether the motor should change speed o be turned on or off. The result of the input logic is stored in an output memory element. Once the program is executed for a determined cycle, the PLC updates instructions for one or more output modules based on the input logic stored in the output memory element. The output module(s) then send the appropriate output signals to the output devices, such as actuators, or indicator lights, motors or actuators. Periodically, the programmed logic in the PLC may perform various diagnostic checks and communicates observed results with user interfaces or displays. The process of reading input signals and updating output signals is conducted continuously while the PLC is running a programmed set of instructions. Accordingly, the system controlled by the PLC is able to be continuously controlled in real time.

The embodiments described herein can be implemented by various types of electromechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs.

Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise. The various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those who have skill in the art will recognize that the subject matter described herein may be implemented in an analog or digital fashion or some combination thereof.

It should be noted that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e g., feedback for sensing position and/or velocity; control motors for moving and/or adjusting components and/or quantities). A data processing system may be implemented utilizing suitable commercially available components, such as those typically found in data computing/communication and/or network computing/communication systems.

Moreover, the herein described components (e g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “responsive” such that the desired functionality is achieved. Hence, any two components herein combined to achieve a particular functionality can be seen as “responsive with” each other such that the desired functionality is achieved, irrespective of architectures or intermedial components. Likewise, any two components so associated can also be viewed as being “coupled,” “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mating and/or physically interacting components, and/or wirelessly intractable, and/or wirelessly interacting components, and/or logically interacting, and/or logically intractable components.

In some instances, one or more components may be referred to herein as “configured to,” “configurable to,” “responsive to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below”, or “beneath” other elements or features would then be oriented “above” the other elements or features. Thus, the exemplary term “below” can encompass both an orientation of above and below. The device may be otherwise oriented (rotated 90° degrees or at other orientations) and the spatially relative descriptors used herein interpreted accordingly.

Moreover, the foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary”, “embodiment” or “preferred embodiment” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way. Furthermore, certain terminology may be used herein for the purpose of reference only and thus is not intended to be limiting. For example, the terms “first”, “second” and other such numerical terms do not imply a sequence or order unless clearly indicated by the context.

While particular aspects of the present subject matter described herein have been shown and described, it will be apparent to those skilled in the art that, based upon the teachings herein, changes and modifications may be made without departing from the subject matter described herein. It will be understood by those within the art that, in general, terms used herein are generally intended as “open” terms (e g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B”.

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past tense adjectives are generally not intended to exclude such variants, unless context dictates otherwise.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A dual-axis centrifugal mixing assembly configured to mix large quantities of material within a container, said centrifugal mixing assembly comprising:
a pedestal assembly configured to house a primary bearing assembly;
at least one load cell assembly secured to the pedestal assembly for measuring loads applied to the pedestal assembly;
a primary axis drive assembly operatively coupled to the pedestal assembly;
a primary spindle rotated by said primary axis drive assembly about a primary axis;
a primary axis motor for driving a primary drive shaft;
a primary gear box mechanically coupled to the primary drive shaft;
a secondary drive shaft mechanically coupled to the primary gear box;
a primary bearing assembly including a primary spindle positioned within a bearing body of the pedestal assembly;
a rotatable gantry assembly operably coupled with the primary spindle and the rotatable gantry assembly being aligned with the primary axis to enable the rotation of the primary spindle to synchronize rotation of the gantry assembly about the primary axis;
a secondary axis drive assembly configured to rotate an operably linked basket about a secondary axis;
a gondola assembly configured to hold a chamber assembly, the gondola assembly being operable for rotation such that it can be selectively tilted at an angle to align the chamber assembly with the secondary axis, wherein the secondary axis is variable in relation to the primary axis;
the chamber assembly having a static mixing chamber that houses the basket and wherein the container is placed with the basket; and
a control assembly, optionally coupled to the gantry assembly and wherein the control assembly is configured to facilitate the execution of the primary axis of the dual-axis centrifugal mixing and facilitate the execution of the secondary axis of the dual-axis centrifugal mixing by first signals sent by the controller to selected components of the centrifugal mixing assembly.

2. The dual-axis centrifugal mixing assembly of claim 1, wherein:
the control assembly is further configured to facilitate execution of secondary outputs by second signals sent by the controller to the selected components of the centrifugal mixing assembly.

3. The dual-axis centrifugal mixing assembly of claim 1, wherein the rotatable gantry assembly further includes:
a pair of secondary axis drive assemblies, each secondary axis drive assemblies having a secondary axis motor that drives a corresponding gantry drive shaft.

4. The dual-axis centrifugal mixing assembly of claim 3, wherein:
each gantry drive shaft is separated into two segments that are coupled with a shaft coupler configured to transmit power and rotational motion, and to permit parallel, axial, or angular misalignment between the shaft segments.

5. The dual-axis centrifugal mixing assembly of claim 3, wherein:
each secondary axis motor includes a programming module having a processor configured to execute machine executable instructions that are programed to control the operation of their corresponding secondary axis motor.

6. The dual-axis centrifugal mixing assembly of claim 1, further including:
at least one rotational sensor positioned adjacent to the primary spindle for detection and transmission of signals to the controller reflective of a rotational speed of the primary spindle.

7. The dual-axis centrifugal mixing assembly of claim 3, wherein:
each secondary axis motor drives a first belt drive, the first belt drive being operatively coupled to the gantry drive shaft enabling selective forward or reverse rotation;
the first belt drive further including a first pulley, a central pulley and a first belt operably linking the first pulley and central pulley, wherein rotation of the gantry drive shaft by a corresponding secondary axis motor causes the first belt drive to travel forward or backward causing the corresponding rotation of the first pulley and central pulley.

8. The dual-axis centrifugal mixing assembly of claim 1, wherein the control assembly further includes:
(a) a pneumatic controller having pneumatic components necessary to receive and transmit compressed air to drive one or more pneumatically operable components of the dual-axis centrifugal mixing assembly; and
(b) a power controller having power components necessary to receive and transmit power to drive one or more electrically operable components of the dual-axis centrifugal mixing assembly.

9. The dual-axis centrifugal mixing assembly of claim 1, wherein:
an upper portion of the controller assembly is secured to a static surface of the dual-axis centrifugal mixing assembly so the controller assembly remains stationary to facilitate the connection and transmission of electrical and pneumatic inputs through corresponding cables or tubes that cannot be rotated, while a lower portion of the controller assembly is secured to the gantry assembly and rotates around the primary axis during operation of the dual-axis centrifugal mixing assembly.

10. The dual-axis centrifugal mixing assembly of claim 9, further including:
a rotatable slip ring assembly operably coupling the upper and lower portions of the controller assembly.

11. The dual-axis centrifugal mixing assembly of claim 1, wherein:
the gondola assembly includes a sled adapted to secure the chamber assembly and to tilt the chamber assembly, so the container is positioned along the secondary axis of rotation or tilted outward at an outward angle to align the chamber assembly in an approximately vertical position to facilitate the loading and unloading of the container between mixing cycles.

12. The dual-axis centrifugal mixing assembly of claim 1 wherein the gondola assembly further includes at least one of:
(a) a vibration sensor positioned on the sled and configured to detect vibration of the gondola assembly and to subsequently transmit at least one of a stop or speed reduction signal to the controller if vibration of the sled or other responsively coupled components exceeds a pre-determined vibration threshold;
(b) an output shaft speed sensor positioned adjacent to a secondary spindle coupled to the rotatable basket and configured to measure the rotational speed of the secondary spindle during operation; and
(c) an input shaft speed sensor positioned adjacent to a drive shaft of the gondola assembly to measure the rotational speed of the shaft during operation.

13. The dual-axis centrifugal mixing assembly of claim 1 wherein the container includes:
a liner secured within the container to provide a barrier between the material and an interior surface of the container, the liner having a plurality of channel positions on an end portion of the liner.

14. The dual-axis centrifugal mixing assembly of claim 13 wherein:
the container has a plurality of extensions positioned on a base plate of the container so that when the liner is inserted into the container, the channel positions on the liner mate with corresponding extensions thereby providing a secure attachment between the liner and the container.

15. A dual-axis centrifugal mixing assembly configured to mix large quantities of material within a container, said centrifugal mixing assembly comprising:
a pedestal configured to house a primary bearing assembly;
a primary axis drive operatively coupled to the pedestal;
a primary spindle rotated by said primary axis drive about a primary axis;
a primary axis motor for driving a primary drive shaft;
a primary gear box mechanically coupled to the primary drive shaft;
a secondary drive shaft mechanically coupled to the primary gear box;
a rotatable gantry operably coupled with a primary spindle and the rotatable gantry being aligned with the primary axis to enable the rotation of the primary spindle to synchronize rotation of the gantry about the primary axis;
a secondary axis drive configured to rotate an operably linked basket about a secondary axis;
a gondola configured to hold a chamber, the gondola being operable for rotation such that it can be selectively tilted at an angle to align the chamber with the secondary axis;
the chamber having a static mixing chamber that houses the basket and wherein the container is placed with the basket; and
a controller coupled to the gantry wherein the controller is configured to facilitate the execution of the dual-axis centrifugal mixing by first signals sent by the controller to selected components of the centrifugal mixing assembly.

16. The dual-axis centrifugal mixing assembly of claim 15, further including;
at least one load cell assembly secured to the pedestal for measuring loads applied to the pedestal.

17. In sub-combination, components of a dual-axis centrifugal mixing assembly configured to mix large quantities of material within a container, said sub-combination comprising:
a pedestal configured to house a primary bearing assembly; at least one load cell assembly secured to the pedestal assembly for measuring loads applied to the pedestal assembly;
a primary axis drive operatively coupled to the pedestal;
a primary spindle rotated by said primary axis drive about a primary axis;
a rotatable gantry operably coupled with the primary spindle wherein the rotatable gantry is aligned with the primary axis to enable the rotation of the primary spindle to synchronize rotation of the gantry about the primary axis;
a secondary axis drive configured to rotate an operably linked basket housed within a chamber about a secondary axis;
a gondola configured to hold the chamber, the gondola being operable for rotation such that it can be selectively tilted at an angle to align the chamber with the secondary axis; and
a controller element coupled to the gantry wherein the controller element is configured to facilitate the execution of the dual-axis centrifugal mixing by first signals sent by the controller element to selected components of the dual-axis centrifugal mixing assembly.

18. The sub-combination of claim 17, further wherein the controller element further includes:
a pneumatic controller having pneumatic components necessary to receive and transmit compressed air to drive one or more pneumatically operable components of the dual-axis centrifugal mixing assembly; and
a power controller having power components necessary to receive and transmit power to drive one or more electrically operable components of the dual-axis centrifugal mixing assembly.

19. A method for conducting dual-axis centrifugal mixing by a mixing device especially adapted for mixing large quantities of material within a container, said method comprising:
providing a mixing device comprising: (a) a primary axis drive (b) a primary spindle rotated by said primary axis drive about a primary axis; (c) a rotatable gantry operably coupled with the primary spindle and the rotatable gantry being aligned with the primary axis to enable the rotation of the primary spindle to synchronize rotation of the gantry about the primary axis; (d) a secondary axis drive configured to rotate an operably linked container about a secondary axis; (e) a gondola configured to hold the container, the gondola being operable for rotation such that it can be selectively tilted at an angle to align the container with the secondary axis; (f) a controller coupled to the gantry and wherein the controller is configured to facilitate execution of the dual-axis centrifugal mixing by first signals sent by the controller to selected components of the centrifugal mixing assembly;
determining a first speed of rotation for mixing the container about the primary axis;
determining a second speed of rotation for mixing the container about the secondary axis of rotation
determining respective time durations of rotation for about the primary and secondary axes; and
conducting the dual-axis centrifugal mixing by energizing the mixing device to operate to rotate the container at the determined first and second speeds of rotation and to rotate the basket for the respective time durations.

20. The method, of claim 19, further including:
determining a tilt angle in relation to a horizontally positioned centerline and positioned perpendicular to the primary axis; and
conducting the dual-axis centrifugal mixing of the container at the determined tilt angle.

21. The method, of claim 19, further including:
providing at least one rotational sensor that is operatively coupled to the primary spindle to detect rotation of the primary spindle;
transmitting a first signal from the sensor to the controller reflective of the detected rotation; and
transmitting a second signal from the controller to the primary axis drive to modify the rotation of the primary spindle if the detected speed of rotation is not within an allowable range of speed of rotation.

22. The method, of claim 19, further including:
providing at least one temperature sensor operatively coupled to an upper spindle bearing and lower spindle bearing of the primary spindle to monitor respective temperatures of the upper and lower spindle bearings during operation of the mixing device; and
transmitting a temperature signal from the at least one temperature sensor to the controller if a sensed temperature of either bearing exceeds a pre-determined threshold temperature.

23. A non-transitory computer-readable medium containing computer executable instructions, wherein, when executed by a computer processor, the instructions cause the computer processor to execute a method to conduct dual-axis centrifugal mixing configured to mix material within a container, comprising:
instructions to operate a dual-axis centrifugal mixing device including instructions to rotate the container about a primary axis and a secondary axis; and
instructions to optimize mixing of the material within the container including instructions to rotate the container about the primary axis and a secondary axis for respective optimal rotational speeds and respective optimal rotational time durations.

24. A non-transitory computer-readable medium, of claim 23, further including:
instructions to generate user interfaces provided to a user on a user screen that enables the user to select predetermined parameters for the optimal rotational speeds and optimal rotational time durations.

25. A non-transitory computer-readable medium containing computer executable instructions, wherein, when executed by a computer processor, the instructions cause the computer processor to execute a method to conduct dual-axis centrifugal mixing configured to mix material within a container, comprising:
instructions to operate a dual-axis centrifugal mixing device including instructions to rotate the container about a primary axis and a secondary axis;
instructions to optimize mixing of the material within the container including instructions to rotate the container about the primary axis and a secondary axis for respective optimal rotational speeds and respective optimal rotational time durations; instructions to generate user interfaces provided to a user on a user screen that enables the user to select predetermined parameters for the optimal rotational speeds and optimal rotational time durations;
wherein said user interfaces include at least one user interface displaying at least one recipe for selection by the user and for subsequent execution of the method, the at least one user interface showing parameters of the at least one recipe include a duration, a gantry rotational speed, a gondola rotational speed, and at least one of an acceleration or deacceleration, and a pedestal to gondola ratio.

26. The non-transitory computer-readable medium of claim 25, wherein said user interfaces further include:
displaying a vacuum status associated with a gondola.

27. The non-transitory computer-readable medium of claim 25, wherein said user interfaces further include:
functions displayed including at least one of a load gondola function, an unload gondola function, a move to position A function, a move to position B function, and an enable servos function.

28. The non-transitory computer-readable medium of claim 25, wherein said user interfaces further include:
a real-time display of information reflecting the current status of the system in operation, the real-time display of information including at least one of: a display of a selected recipe, a display of monitored conditions of the system including at least one of pressure, temperature, elapsed time, and rotational speeds.

29. A dual-axis centrifugal mixing assembly configured to mix quantities of material within a container, said centrifugal mixing assembly comprising:
a pedestal assembly configured to house a primary bearing assembly;
at least one load cell assembly secured to the pedestal assembly for measuring loads applied to the pedestal assembly;
a primary axis drive assembly operatively coupled to the pedestal assembly;
a primary spindle rotated by said primary axis drive assembly about a primary axis;
a primary axis motor for driving a primary drive shaft;
a primary gear box mechanically coupled to the primary drive shaft;
a secondary drive shaft mechanically coupled to the primary gear box;
a primary bearing assembly including a primary spindle positioned within a bearing body of the pedestal assembly;
a rotatable gantry assembly operably coupled with the primary spindle and the rotatable gantry assembly being aligned with the primary axis to enable the rotation of the primary spindle to synchronize rotation of the gantry assembly about the primary axis;
a secondary axis drive assembly configured to rotate an operably linked basket about a secondary axis;
a gondola assembly configured to hold a chamber assembly, the gondola assembly being operable for rotation such that it can be selectively tilted at an angle to align the chamber assembly with the secondary axis, wherein the secondary axis is variable in relation to the primary axis;
the chamber assembly having a static mixing chamber that houses the basket and wherein the container is placed with the basket; and
a control assembly operatively coupled to the centrifugal mixing assembly wherein the control assembly is configured to facilitate the execution of a mixing recipe resulting in mixing along the primary axis and the secondary axis, the control assembly comprising a programmable logic controller (PLC) for controlling the dual-axis centrifugal mixing, wherein the PLC has programmed instructions to facilitate execution of a mixing recipe wherein the programmed instructions reside on a non-transitory computer-readable medium, said mixing recipe including:
instructions to optimize mixing of the material within the container including instructions to rotate the container about the primary axis and a secondary axis for respective optimal rotational speeds and respective optimal rotational time durations; instructions to generate user interfaces provided to a user on a user screen that enables the user to select predetermined parameters for the optimal rotational speeds and optimal rotational time durations;
wherein said user interfaces include at least one user interface displaying at least one recipe for selection by the user and for subsequent execution of the method, the at least one user interface showing parameters of the at least one recipe include a duration, a gantry rotational speed, a gondola rotational speed, and at least one of an acceleration or deacceleration, and a pedestal to gondola ratio.

30. The dual-axis centrifugal mixing assembly of claim 29, wherein said user interfaces further include:
a real-time display of information reflecting the current status of the system in operation, the real-time display of information including at least one of: a display of a selected recipe, a display of monitored conditions of the system including at least one of pressure, temperature, elapsed time, and rotational speeds.

31. A method for conducting dual-axis centrifugal mixing by a mixing device especially adapted for mixing large quantities of material within a container, said method comprising:
providing a mixing device comprising: (a) a primary axis drive (b) a primary spindle rotated by said primary axis drive about a primary axis; (c) a rotatable gantry operably coupled with the primary spindle and the rotatable gantry being aligned with the primary axis to enable the rotation of the primary spindle to synchronize rotation of the gantry about the primary axis; (d) a secondary axis drive configured to rotate an operably linked container about a secondary axis; (e) a gondola configured to hold the container, the gondola being operable for rotation such that it can be selectively tilted at an angle to align the container with the secondary axis; (f) a controller coupled to the gantry and wherein the controller is configured to facilitate execution of the dual-axis centrifugal mixing by signals sent by the controller to selected components of the centrifugal mixing assembly;
determining a first speed of rotation for mixing the container about the primary axis;
determining a second speed of rotation for mixing the container about the secondary axis of rotation
determining respective time durations of rotation for about the primary and secondary axes; and
conducting the dual-axis centrifugal mixing by energizing the mixing device to operate to rotate the container at the determined first and second speeds of rotation and to rotate the basket for the respective time durations.

32. The method for conducting dual-axis centrifugal mixing of claim 31, wherein:
the controller includes a non-transitory computer-readable medium that provides instructions to components of the mixing device to optimize mixing of the material within the container including instructions to rotate the container about the primary axis and a secondary axis for respective optimal rotational speeds and respective optimal rotational time durations; instructions to generate user interfaces provided to a user on a user screen that enables the user to select predetermined parameters for the optimal rotational speeds and optimal rotational time durations;
wherein said user interfaces include at least one user interface displaying at least one recipe for selection by the user and for subsequent execution of the method, the at least one user interface showing parameters of the at least one recipe include a duration, a gantry rotational speed, a gondola rotational speed, and at least one of an acceleration or deacceleration, and a pedestal to gondola ratio.

33. A dual-axis centrifugal mixing assembly configured to mix quantities of material within a container, said centrifugal mixing assembly comprising:
a pedestal assembly;
a primary axis drive assembly operatively coupled to the pedestal assembly;
a rotatable gantry assembly operably coupled with a primary spindle communicating with the primary axis drive assembly, wherein the rotatable gantry assembly is aligned with a primary axis to enable the rotation of the primary spindle to synchronize rotation of the gantry assembly about the primary axis;
a secondary axis drive assembly configured to rotate an operably linked chamber assembly about a secondary axis;
wherein the chamber assembly is selectively tilted at an angle to align the chamber assembly with a secondary axis, and wherein the secondary axis is variable in relation to the primary axis;
the chamber assembly having a mixing chamber that houses a container holding the material;
a control assembly operatively coupled to the centrifugal mixing assembly wherein the control assembly is configured to facilitate the execution of a mixing recipe resulting in mixing along the primary axis and the secondary axis, the control assembly comprising programmed instructions to facilitate execution of the mixing recipe, and wherein the programmed instructions reside on a non-transitory computer-readable medium, said mixing recipe including:
instructions to optimize mixing of the material within the container including instructions to rotate the container about the primary axis and a secondary axis for respective optimal rotational speeds and respective optimal rotational time durations;
instructions to generate user interfaces provided to a user on a user screen that enables the user to select predetermined parameters for the optimal rotational speeds and optimal rotational time durations.

34. The dual-axis centrifugal mixing assembly of claim 33, wherein:
said user interfaces include at least one user interface displaying at least one recipe for selection by the user and for subsequent execution of the mixing recipe, the at least one user interface showing parameters of the mixing recipe include a duration, a gantry rotational speed, a gondola rotational speed, and at least one of an acceleration or deacceleration, and a pedestal to gondola ratio.
